(19) United States
(12) Patent Application Publication
(10) Pub. No.: US 2008/0303769 A1
(43) Pub. Date: Dec. 11, 2008

(54) IMAGE DISPLAY DEVICE AND DRIVE CIRCUIT

(75) Inventor: Youichi Tobita, Tokyo (JP)

Correspondence Address: OBLON, SPIVAK, MCCLELLAND MAIER & NEUSTADT, P.C., 1940 DUKE STREET, ALEXANDRIA, VA, 22314, US

(73) Assignee: MITSUBISHI ELECTRIC CORPORATION, Chiyoda-ku (JP)

(21) Appl. No.: 12/133,734

(22) Filed: Jun. 5, 2008

(30) Foreign Application Priority Data
Jun. 7, 2007 (JP) 2007-151053
Dec. 3, 2007 (JP) 2007-312145

(51) Int. Cl. G09G 3/36

(52) U.S. Cl. 345/92

(57) ABSTRACT

The present invention aims to provide an image display device capable of reducing power consumption, and a drive circuit used in the same. The present invention relates to an image display device including signal lines, scanning lines, lines, transistors, capacitances, and a drive circuit. The drive circuit of the image display device has configuring active elements of a same conductivity type and has the active elements simultaneously formed on a same substrate as said transistor; and includes switching circuits for generating a first switching signal and a second switching signal for switching a voltage level of a drive signal based on a predetermined signal, and outputting the signals, an output level holding circuit for holding the voltage levels of the first switching signal and the second switching signal for a predetermined period based on a repeating signal, and an output circuit for generating the drive signal based on the first switching signal and the second switching signal, and outputting the drive signal to the line.

### BACKGROUND OF THE INVENTION

1. Field of the Invention

The present invention relates to an image display device and a drive circuit.

2. Description of the Background Art

In a liquid crystal display device, which is an image display device, a capacitance coupling drive technique disclosed in FIG. 1 or FIG. 8 of Japanese Laid-Open Patent Publication No. 2003-295157 is adopted as one drive technique for reducing power consumption. This drive technique adjusts the voltage level of a display signal written to a pixel to a necessary level by coupling a signal (hereinafter referred to as compensation signal) having a constant voltage amplitude to a pixel node through holding capacity. The capacitance coupling drive technique thereby can reduce the voltage amplitude of the display signal to be provided to a source line (hereinafter also referred to as data line), and can reduce the power consumed in the data line.

A storage capacitance line drive circuit for performing the capacitance coupling drive is disclosed in FIG. 4A of Japanese Laid-Open Patent Publication No. 2003-228345.

A line independent common driving manner is also adopted in a liquid crystal display device using an IPS (In Plane Switching) liquid crystal display panel as a driving manner similar to the capacitance coupling drive. The line independent common driving manner is known as a technique capable of reducing the power consumption of a gate line drive circuit by reducing the amplitude of a gate line drive signal and enhancing the reliability of a transistor used in the circuit. Specifically, Japanese Laid-Open Patent Publication No. 2006-276541 has disclosed that the line independent common driving manner is realized at low cost by using particularly a single conductivity type (N-type) MOS transistor in a common electrode drive circuit disclosed in FIG. 18. The line independent common driving manner is also disclosed in Japanese Laid-Open Patent Publication No. 10-31464 and Japanese Laid-Open Patent Publication No. 2001-350438.

However, in the storage capacitance line drive circuit disclosed in FIG. 4A of Japanese Laid-Open Patent Publication No. 2003-228345, when Q(n)=H, {QB(n)=L}, Q(n+1)=L, FR=L in a truth value shown in FIG. 4(b), a pass-through current flows between VDD and VSS, and power is consumed at the relevant portion. The output of the storage capacitance line drive circuit of Japanese Laid-Open Patent Publication No. 2003-228345 connects with a storage capacitance line only for about one horizontal scanning period before and after a period in which a scanning signal of the related gate line changes. Thus, the storage capacitance line is floating during the period other than the above, and the potential of the storage capacitance line changes through cross capacitance of a line when the signal voltage of the source line greatly changes, thereby influencing a display image.

Furthermore, in FIG. 18 of Japanese Laid-Open Patent Publication No. 2006-276541, levels complementary to each other are input to nodes ND1, ND2, respectively, transistors T3, T4 are accordingly complementary turned ON or OFF, and an output signal is output to an OUT node. When the node ND2 or the node ND1 becomes H level, one of either transistor T10 or T9 having a flip-flop configuration is turned ON, and the L level of the node ND1 or the node ND2 is set to a reference voltage VSS level at low impedance. The H level of the node ND2 or the node ND1 is maintained by a series capacitance including mainly capacitance elements Cbs1 and Cs1 or Cbs2 and Cs2 in a high impedance state.

The period in which the H level is maintained is relatively long of one frame period (about 16.7 ms), where the relevant level lowers when the leakage current between the drain and the source of the transistor T9 or the transistor T10 is large, and the transistor T3 or the transistor T4 cannot be sufficiently turned ON. Thus, the output impedance increases, and suppression of voltage noise generated at the output by capacitance coupling etc. becomes insufficient. When the lowering in level becomes larger, the H level of the output signal OUT lowers. As a result, there is a problem that the voltage applied to the liquid crystals differs from the normal value and the display thus becomes abnormal. A drive circuit in which power is barely consumed on the L level side is desired.

### SUMMARY OF THE INVENTION

The present invention aims to provide an image display device capable of reducing power consumption and a drive circuit used in the same.

An image display device according to one embodiment of the present invention includes a plurality of signal lines; a plurality of scanning lines orthogonal to said signal line; a plurality of lines arrayed along said scanning lines; a transistor arranged near an intersection of said signal line and said scanning line, and having one current electrode connected to said signal line and a control electrode connected to said scanning line; a capacitance connected to said line; and a drive circuit connected to said line, for providing a drive signal to said capacitance. The drive circuit has configuring active elements of a same conductivity type and has said active elements simultaneously formed on a same substrate as said transistor; and includes a switching circuit for generating a first switching signal and a second switching signal for switching a voltage level of said drive signal based on a predetermined signal, and outputting the signals; an output level holding circuit for holding the voltage levels of said first switching signal and said second switching signal for a predetermined period based on a repeating signal; and an output circuit for generating said drive signal based on said first switching signal and said second switching signal, and outputting said drive signal to said line.

In the image display device according to one embodiment of the present invention, the drive circuit includes the switching circuit, the output level holding circuit, and the output circuit, and thus the power consumed in the image display device and the drive circuit can be reduced.

An image display device according to another embodiment of the present invention includes a plurality of signal lines; a plurality of scanning lines orthogonal to said signal lines; a plurality of common electrode lines arrayed along said scanning lines; a transistor arranged near an intersection of said signal line and said scanning line, and having one current electrode connected to said signal line and a control electrode connected to said scanning line; a liquid crystal capacitance connected between the other current electrode of said transistor and said corresponding common electrode line; and a common electrode drive circuit connected to said common electrode line, for providing a common electrode drive signal to said liquid crystal capacitance. The common electrode drive circuit has configuring active elements of a same conductivity type and has said active elements simultaneously formed on a same substrate as said transistor; and includes a polarity switching circuit for generating a first switching signal and a second switching signal for switching a voltage level of said common electrode drive signal based on a predetermined signal, and outputting the signals; an output level holding circuit for holding the voltage levels of said first switching signal and said second switching signal for a predetermined period based on a repeating signal; and an output circuit for generating said common electrode drive signal based on said first switching signal and said second switching signal, and outputting said common electrode drive signal to said common electrode line.

In the image display device according to the another embodiment of the present invention, the gate voltage of the transistor in the common electrode drive circuit is supplied at low power consumption and at low impedance, and thus the instability of the voltage level of the common electrode drive circuit by the leakage current of the transistor can be prevented, and display abnormality can be prevented.

A drive circuit according to one embodiment of the present invention is a drive circuit connected to a line of an image display device including a plurality of signal lines, a plurality of scanning lines orthogonal to said signal line, a plurality of lines arrayed along said scanning lines, a transistor arranged near an intersection of said signal line and said scanning line, and having one current electrode connected to said signal line and a control electrode connected to said scanning line, a capacitance connected to said line; and providing a drive signal to said capacitance. Furthermore, the drive circuit according to the embodiment of the present invention has configuring active elements of a same conductivity type and has said active elements simultaneously formed on a same substrate as said transistor; and includes a switching circuit for generating a first switching signal and a second switching signal for switching a voltage level of said drive signal based on a predetermined signal, and outputting the signals; an output level holding circuit for holding the voltage levels of said first switching signal and said second switching signal for a predetermined period based on a repeating signal; and an output circuit for generating said drive signal based on said first switching signal and said second switching signal, and outputting said drive signal to said line.

In the drive circuit according to the embodiment of the present invention, the drive circuit includes the switching circuit, the output level holding circuit, and the output circuit, and thus the power consumed in the image display device and the drive circuit can be reduced.

These and other objects, features, aspects and advantages of the present invention will become more apparent from the following detailed description of the present invention when taken in conjunction with the accompanying drawings.

### BRIEF DESCRIPTION OF THE DRAWINGS

FIG. 1 is a block diagram of an image display device according to a first embodiment of the present invention;

FIG. 2 is a block diagram of another image display device according to the first embodiment of the present invention;

FIG. 3 is a block diagram of another image display device according to the first embodiment of the present invention;

FIG. 4 is a circuit diagram of a storage capacitance line drive circuit according to the first embodiment of the present invention;

FIG. 5 is an operation waveform chart of the storage capacitance line drive circuit according to the first embodiment of the present invention;

FIG. 6 is a circuit diagram of an even row of the storage capacitance line drive circuit according to the first embodiment of the present invention;

FIG. 7 is an operation waveform chart of the storage capacitance line drive circuit according to the first embodiment of the present invention;

FIGS. 8 to 13 are circuit diagrams of a storage capacitance line drive circuit according to a variant of the first embodiment of the present invention;

FIG. 14 is a circuit diagram of a storage capacitance line drive circuit according to a second embodiment of the present invention;

FIGS. 15 and 16 are circuit diagrams of a storage capacitance line drive circuit according to a variant of the second embodiment of the present invention;

FIG. 17 is a circuit diagram of a storage capacitance line drive circuit according to a third embodiment of the present invention;

FIGS. 18 and 19 are circuit diagrams of a scanning direction switching circuit according to a variant of the third embodiment of the present invention;

FIG. 20 is a circuit diagram of a storage capacitance line drive circuit according to a variant of the third embodiment of the present invention;

FIG. 21 is a circuit diagram of a scanning direction switching circuit according to a variant of the third embodiment of the present invention;

FIG. 22 is a block diagram showing a circuit configuration of a fourth embodiment of the present invention;

FIG. 23 is a circuit diagram of a shift register according to the fourth embodiment of the present invention;

FIG. 24 is a circuit diagram of a shift register according to a variant of the fourth embodiment of the present invention;

FIG. 25 is a circuit diagram of a shift register according to a fifth embodiment of the present invention;

FIG. 26 is a circuit diagram of a shift register according to a variant of the fifth embodiment of the present invention;

FIG. 27 is a circuit diagram of a storage capacitance line drive circuit according to a sixth embodiment of the present invention;

FIG. 28 is an operation waveform chart of the storage capacitance line drive circuit according to the sixth embodiment of the present invention;

FIGS. 29 and 30 are circuit diagrams of an even row of the storage capacitance line drive circuit according to the sixth embodiment of the present invention;

FIG. 31 is a circuit diagram of a storage capacitance line drive circuit according to a variant of the sixth embodiment of the present invention;

FIG. 32 is a circuit diagram of a storage capacitance line drive circuit according to a seventh embodiment of the present invention;

FIG. 33 is a circuit diagram of a storage capacitance line drive circuit according to a variant of the seventh embodiment of the present invention;

FIG. 34 is a circuit diagram of a storage capacitance line drive circuit according to an eighth embodiment of the present invention;

FIG. 35 is a circuit diagram of a storage capacitance line drive circuit according to a ninth embodiment of the present invention;

FIG. 36 is a circuit diagram of a charge pump circuit according to the ninth embodiment of the present invention;

FIG. 37 is a circuit diagram of a storage capacitance line drive circuit according to a variant of the ninth embodiment of the present invention;

FIG. 38 is a circuit diagram of a charge pump circuit according to a variant of the ninth embodiment of the present invention;

FIG. 39 is a block diagram of an image display device according to the ninth embodiment of the present invention;

FIG. 40 is a block diagram of an image display device according to a tenth embodiment of the present invention;

FIGS. 41 to 43 are block diagrams of another image display device according to the tenth embodiment of the present invention;

FIG. 44 is a circuit diagram of a common electrode drive circuit according to the tenth embodiment of the present invention;

FIG. 45 is an operation waveform chart of the common electrode drive circuit according to the tenth embodiment of the present invention;

FIGS. 46 and 47 are circuit diagrams of an even row of the common electrode drive circuit according to the tenth embodiment of the present invention;

FIG. 48 is an operation waveform chart of the common electrode drive circuit according to the tenth embodiment of the present invention;

FIG. 49 is a circuit diagram of a common electrode drive circuit according to a variant of the tenth embodiment of the present invention;

FIG. 50 is an operation waveform chart of a common electrode drive circuit according to a variant of the tenth embodiment of the present invention;

FIG. 51 is a circuit diagram of a common electrode drive circuit according to a variant of the tenth embodiment of the present invention;

FIG. 52 is a circuit diagram of a common electrode drive circuit according to an eleventh embodiment of the present invention;

FIG. 53 is a circuit diagram of a common electrode drive circuit according to a variant of the eleventh embodiment of the present invention;

FIG. 54 is a circuit diagram of a common electrode drive circuit according to a twelfth embodiment of the present invention;

FIGS. 55 and 56 are circuit diagrams of a scanning direction switching circuit according to a variant of the twelfth embodiment of the present invention;

FIG. 57 is a circuit diagram of a common electrode drive circuit according to a thirteenth embodiment of the present invention;

FIG. 58 is a circuit diagram of a charge pump circuit according to the thirteenth embodiment of the present invention;

FIG. 59 is a circuit diagram of a common electrode drive circuit according to a variant of the thirteenth embodiment of the present invention; and

FIG. 60 is a circuit diagram of a charge pump circuit according to a variant of the thirteenth embodiment of the present invention.

### DESCRIPTION OF THE PREFERRED EMBODIMENTS

### First Embodiment

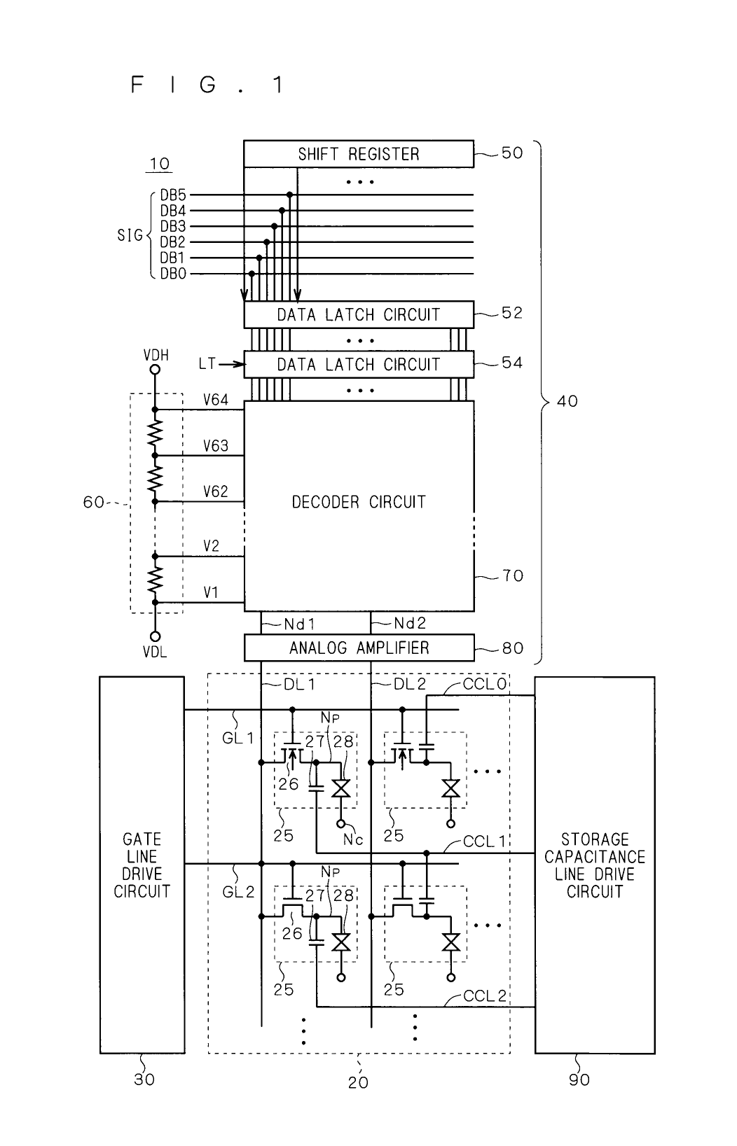

FIG. 1 shows a block diagram of an image display device according to a first embodiment. In the block diagram shown in FIG. 1, a configuration of a liquid crystal display device 10 is shown as a representative example of the image display device according to the present invention. The image display device according to the present invention is not limited to the liquid crystal display device 10 shown in FIG. 1.

First, the liquid crystal display device 10 shown in FIG. 1 includes a liquid crystal array section 20, a gate line drive circuit (scanning line drive circuit) 30, and a source driver 40. Furthermore, a capacitance line drive circuit 90, which is a compensation signal generation circuit to be hereinafter described, is arranged in the liquid crystal display device 10 shown in FIG. 1. In the liquid crystal display device 10 shown in FIG. 1, the storage capacitance line drive circuit 90 is arranged on the right side of the liquid crystal array section 20, but the present invention is not limited thereto, and the storage capacitance line drive circuit 90 may be arranged on the left side of the liquid crystal array section 20 if the gate line drive circuit 30 is formed on a substrate of the liquid crystal array section 20. The storage capacitance line drive circuit 90 may be integrated with the gate line drive circuit 30 by commonly using the power supply lines and the signal lines used in the gate line drive circuit 30.

The liquid crystal array section 20 includes a plurality of pixels 25 arranged in a matrix form. Gate lines GL1, GL2, . . . (also collectively referred to as gate lines GL) are arranged for every row of pixels (hereinafter also referred to as pixel line) in the liquid crystal array section 20. Furthermore, data lines DL1, DL2, . . . (also collectively referred to as data lines DL) are arranged for every column of pixels (hereinafter also referred to as pixel column) in the liquid crystal array section 20. In FIG. 1, the pixels 25 arranged on the first column and the second column of the first row and the second row, and the gate lines GL1, GL2, the data lines DL1, DL2, and the storage capacitance lines CCL0, CCL1, CCL2, . . . (also collectively referred to as storage capacitance lines CCL) arranged in correspondence to the pixels 25 are representatively illustrated.

Each pixel 25 includes a pixel switch element 26 between the corresponding data line DL and a pixel electrode Np, a storage capacitance element 27 between the pixel electrode Np and the storage capacitance line CCL, and a liquid crystal display element 28 between the pixel electrode Np and a common electrode node Nc. The liquid crystal display element 28 changes the orientation of the sandwiched liquid crystal and changes the display luminance depending on the potential difference created between the pixel electrode Np and the common electrode node Nc. The luminance of each pixel 25 thus can be controlled by a display voltage transmitted to the pixel electrode Np through the data lines DL and the pixel switch element 26. In other words, each pixel 25 can obtain an intermediate luminance by applying an intermediate voltage difference between a voltage difference corresponding to a maximum luminance and a voltage difference corresponding to a minimum luminance between the pixel electrode Np and the common electrode node Nc. Therefore, the liquid crystal display device 10 shown in FIG. 1 is able to display a tone luminance by setting the display voltage in a step wise manner.

The gate line drive circuit 30 selects and drives the gate lines GL in order based on a predetermined scanning period. Each gate line GL is connected to the gate of the corresponding pixel switch element 26. While the gate line drive circuit 30 is selecting a specific gate line GL, the pixel connected to the relevant gate line GL has the pixel switch element 26 in a conductive state, and the pixel electrode Np and the corresponding data line DL are connected. Thus, a display voltage corresponding to the display signal is supplied to the pixel electrode Np via the data lines DL.

In the pixel electrode Np, the level of the supplied display voltage is adjusted and held by the storage capacitance element 27. The pixel switch element 26 is generally configured by a TFT (Thin Film Transistor) formed on an insulative substrate (glass substrate, resin substrate, and the like) which is same as the liquid crystal display element 28.

The source driver 40 outputs the display voltage set in a step wise manner by a display signal SIG or a digital signal of N bits to the data lines DL. If the display signal SIG is a signal of six bits, for example, the display signal SIG is constituted by display signal bits DB0 to DB5. Each pixel 25 can perform tone display of 2⁶=64 levels based on the display signal SIG of six bits. Furthermore, if the pixel 25 configures one display unit with three colors of R (Red), G (Green), and B (Blue), a color display of about 260 thousand colors can be carried out.

The source driver 40 shown in FIG. 1 includes a shift register 50, data latch circuits 52, 54, a tone voltage generation circuit 60, a decoder circuit 70, and an analog amplifier 80. The display signal SIG is constituted by serially generating the display signal bits DB0 to DB5 corresponding to the display luminance of the respective pixels 25. In other words, the display signal bits DB0 to DB5 at each timing indicate the display luminance at one of the pixels 25 in the liquid crystal array section 20.

The shift register 50 instructs the data latch circuit 52 to retrieve the display signal bits DB0 to DB5 at a timing synchronized with the period of switching the setting of the display signal SIG. The data latch circuit 52 sequentially retrieves the display signal SIG constituted by the display signal bits DB0 to DB5 generated in series, and holds the display signal SIG for one pixel line.

A latch signal LT is input to the data latch circuit 54. The latch signal LT is activated at a timing that the display signal SIG for one pixel line is retrieved by the data latch circuit 52. That is, the data latch circuit 54 retrieves the display signal SIG for one pixel line held in the data latch circuit 52 in response to the timing that the latch signal LT is activated.

The tone voltage generation circuit 60 is configured by sixty-three voltage dividing resistors connected in series between high voltage VDH and low voltage VDL. The tone voltage generation circuit 60 generates tone voltages V1 to V64 of sixty-four levels by using the sixty-three voltage dividing resistors.

The decoder circuit 70 decodes the display signal SIG held in the data latch circuit 54. The decoder circuit 70 selects the voltages to be output to each decode output node Nd1, Nd2, . . . (collectively referred to as decode output nodes Nd) based on the decode result from the tone voltages V1 to V64 generated in the tone voltage generation circuit 60.

As a result, the display voltage (one of the voltages of tone voltages V1 to V64) corresponding to the display signal SIG for one pixel line held in the data latch circuit 54 is simultaneously (in parallel) output from the decode output node Nd. In FIG. 1, the decode output nodes Nd1, Nd2 corresponding to the data lines DL1, DL2 of the first column and the second column are typically illustrated.

The analog amplifier 80 then amplifies each display voltage output from the decoder circuit 70 to the decode output node Nd to the corresponding analog voltage, and outputs the same to the data lines DL.

As described above, in the liquid crystal display device 10 according to the present embodiment, the source driver 40 outputs the display voltages corresponding to a series of display signals SIG to the data lines DL by one pixel line based on a predetermined scanning period, and the gate line drive circuit 30 sequentially drives the gate lines GL in synchronization with the relevant scanning period, thereby causing the liquid crystal array section 20 to display an image based on the display signal SIG.

In the liquid crystal display device 10 shown in FIG. 1, the storage capacitance line drive circuit 90, the gate line drive circuit 30, and the source driver 40 are formed with the liquid crystal array section 20 integrated on the same insulator substrate. However, the present invention is not limited thereto, and the gate line drive circuit 30 and the source driver 40 may be arranged as external circuits of the liquid crystal array section 20.

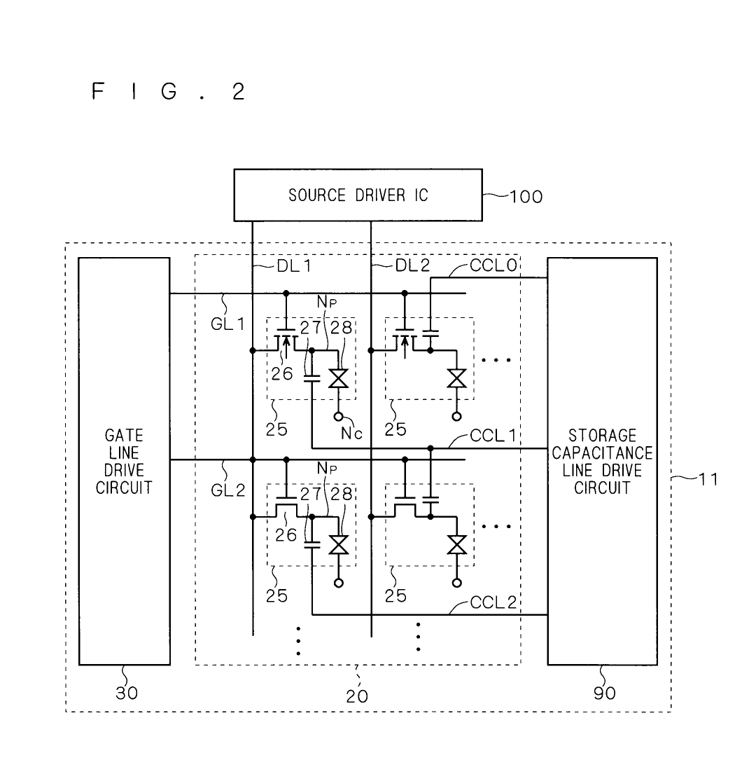

FIG. 2 shows a configuration of arranging a source driver IC 100 of a semiconductor integrated circuit formed on a single crystal silicon substrate as an external circuit in place of the source driver 40, and forming the gate line drive circuit 30, the storage capacitance line drive circuit 90, and the liquid crystal array section 20 on the same insulator substrate 11.

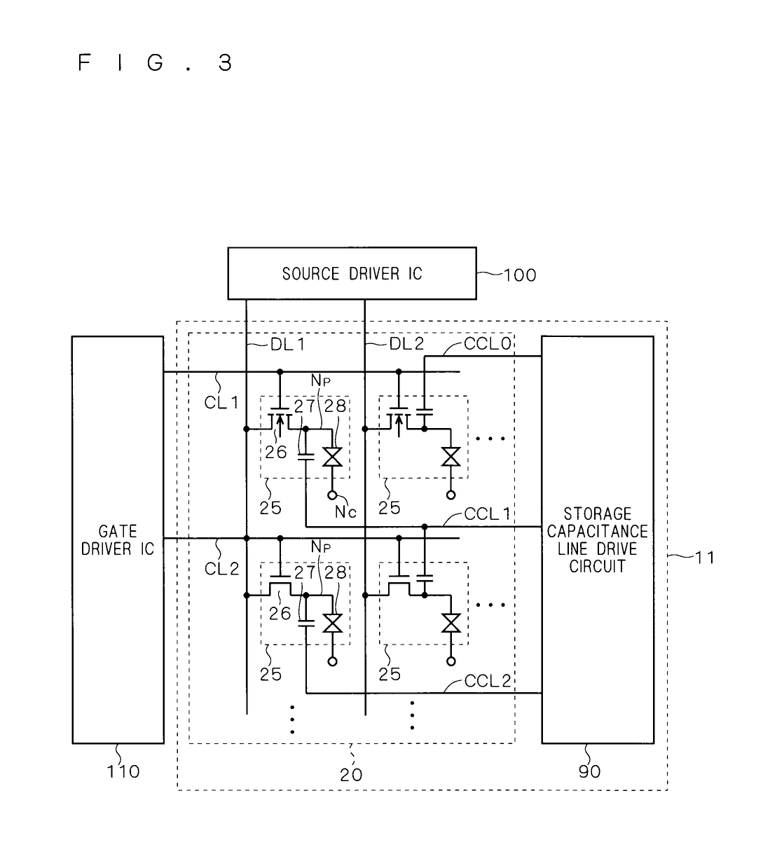

FIG. 3 shows a configuration of arranging the source driver IC 100 and a gate driver IC 110 of a semiconductor integrated circuit as external circuits in place of the source driver 40 and the gate line driver circuit 30, and forming the storage capacitance line drive circuit 90 and the liquid crystal array section 20 on the same insulator substrate 11.

The method of scanning the gate lines generally includes a method of scanning in one direction of either from the top to the bottom or from the bottom to the top in FIG. 1, and a method of scanning by switching the directions depending on usage conditions. Both methods of scanning the gate lines can be applied to the image display device according to the present invention, but a case of using the method of scanning in a single direction will be described first in the image display device according to the present embodiment described below.

The capacitance coupling drive includes a case where the compensation signal is input after one horizontal period (H) from the timing that the gate line selection signal changes from the selected state to the non-selected state as described in the first embodiment of Japanese Laid-Open Patent Publication No. 2003-295157, and a case where the compensation signal is input at a timing immediately after the gate line selection signal changes from the selected state to the non-selected state as described in the second embodiment of Japanese Laid-Open Patent Publication No. 2003-295157. The image display device according to the present invention can be applied to either capacitance coupling drive, but a case where the compensation signal is input after one horizontal period (H) from the timing that the gate line selection signal changes from the selected state to the non-selected state will be described in the image display device according to the present embodiment described below.

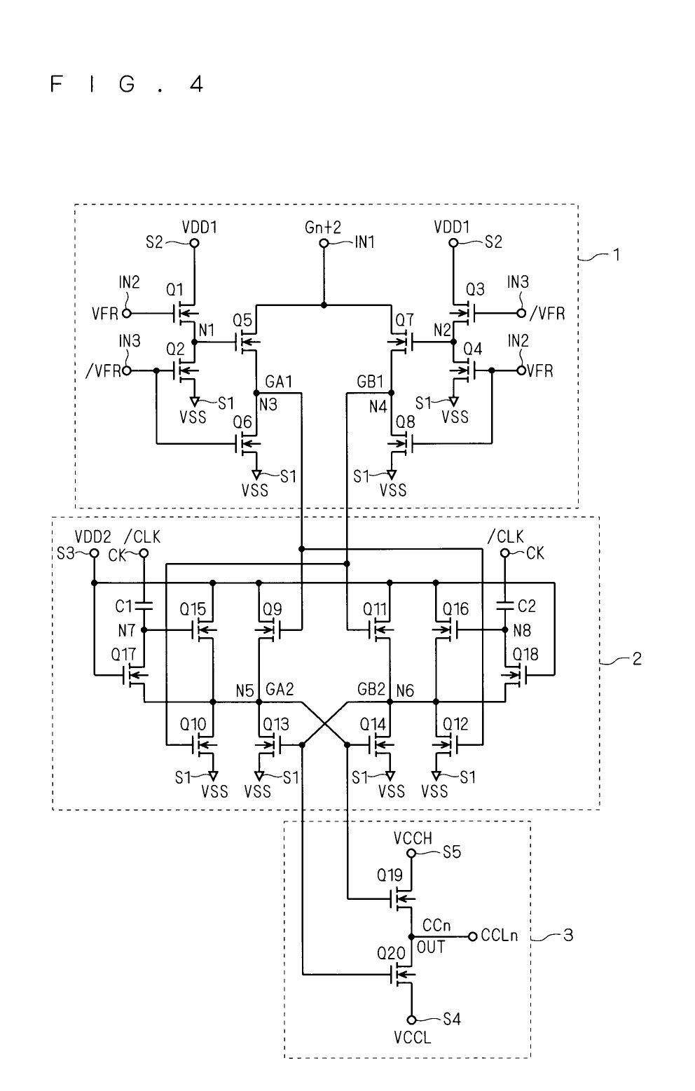

The storage capacitance line drive circuit 90 of the image display device according to the present embodiment is shown in FIG. 4. The storage capacitance line drive circuit 90 shown in FIG. 4 shows the storage capacitance line drive circuit 90 corresponding to the gate line drive signal in odd rows of the pixel lines. The transistor used in the storage capacitance line drive circuit 90 shown in FIG. 4 may be any one of polysilicon TFT, amorphous silicon TFT, or organic TFT. However, the amorphous TFT and the organic TFT have a possibility that the threshold voltage of the TFT might shift and cause malfunction when a DC (Direct Current) bias is continuously applied between the gate and the source of the TFT. Thus, some kind of countermeasure needs to be considered on the shift of the threshold voltage when using the amorphous TFT and the organic TFT.

In the image display device according to the present embodiment described below, the polysilicon TFT in which shift of the threshold voltage is less likely to occur will be described. In the present embodiment, a circuit provided as a countermeasure for the shift of the threshold voltage when using the amorphous silicon TFT and the organic TFT will be described in the subsequent embodiments. The relevant circuit may, of course, be used in the polysilicon TFT.

It is assumed that the transistor used in the storage capacitance line drive circuit 90 shown in FIG. 4 is an N-type and the threshold voltages Vth thereof are all equal. The N-type transistor is in the activated (ON) state when the gate becomes H (High) level with respect to the source, and is in the inactivated (OFF) state when the gate becomes L (Low) level with respect to the source. The transistor used in the storage capacitance line drive circuit 90 shown in FIG. 4 is an N-type, but the transistor used in the storage capacitance line drive circuit 90 of the present invention may be configured by a P-type transistor. The P-type transistor is activated (ON) state when the gate becomes L (Low) level with respect to the source, and is in the inactivated (OFF) state when the gate becomes H (High) level with respect to the source.

The reference potential of the image display device is generally set with the potential of the display signal written to the pixel as the reference, but the potential of the low potential power supply of the storage capacitance line drive circuit 90 is conveniently set as the reference potential VSS for the sake of simplifying explanation for the reference potential of the image display device according to the present embodiment. Similarly, the potentials of the high potential power supplies VDD1, VDD2 of the image display device according to the present embodiment are the same or VDD. VFR signal and /VFR signal or control signals of the image display device according to the present embodiment have the H level as VDD and the L level as VSS. Furthermore, clock signals (CLK, /CLK) of the image display device according to the present embodiment also have the H level as VDD and the L level as VSS. VCCH and VCCL shown in FIG. 4 are voltage sources that respectively supply H level and L level with respect to a compensation signal CCn for driving the storage capacitance lines CCL.

The storage capacitance line drive circuit 90 shown in FIG. 4 includes an output level switching circuit 1, an output level holding circuit 2, and an output circuit 3. The output level switching circuit 1 determines pull-up and pull-down of the output signal. The output level switching circuit 1 shown in FIG. 4 includes transistors Q1, Q2 and transistors Q3, Q4 connected in series between a terminal S1 connected to the reference potential VSS and a terminal S2 connected to the high potential power supply VDD1; and transistors Q5, Q6 and transistors Q7, Q8 connected in series between a terminal IN1 of the input signal and the terminal S1 connected to the reference potential VSS. The transistor Q1, the transistor Q4, and the transistor Q8 have the VFR signal input to the gate, and the transistor Q2, the transistor Q3, and the transistor Q6 have the /VFR signal input to the gate. The transistor Q5 has the output of a node N1, which is a common connection node of the transistor Q1 and the transistor Q2, input to the gate, and the output of a node N3, which is a common connection node with the transistor Q6, becomes a switching signal GA1. The transistor Q7 has the output of a node N2, which is a common connection node of the transistor Q3 and the transistor Q4, input to the gate, and the output of a node N4, which is a common connection node with the transistor Q8, becomes a switching signal GB1.

The output level holding circuit 2 provides a driving ability to the output signals of the output level switching circuit 1, and holds the output level thereof for one frame. The output level holding circuit 2 shown in FIG. 4 includes transistors Q9, Q13, transistors Q15, Q10, transistors Q11, Q14, and transistors Q16, Q12 connected in series between the terminal S1 and a terminal S3 connected to the high potential power supply VDD2; and a transistor Q17 and a transistor Q18 having the high potential power supply VDD2 connected to the gate. The transistor Q9 and the transistor Q12 have the switching signal GA1, which is the output of the node N3, input to the gate, and the transistor Q11 and the transistor Q10 have the switching signal GB1, which is the output of the node N4, input to the gate. The output of a node N5, which is a common connection node between the transistor Q9 and the transistor Q13, becomes an output signal GA2, and the output of a node N6, which is a common connection node of the transistor Q11 and the transistor Q14, becomes an output signal GB2. A node N7, which is a common connection node between the gate of the transistor Q15 and the drain of the transistor Q17, is connected to a terminal CK to be input with the clock signal /CLK by way of a capacitance element C1. A node N8, which is a common connection node between the gate of the transistor Q16 and the drain of the transistor Q18, is connected to the terminal CK to be input with the clock signal /CLK by way of a capacitance element C2.

The output circuit 3 outputs the compensation signal CCn having higher driving ability in response to the output of the output level holding circuit 2. The output circuit 3 shown in FIG. 4 includes transistors Q19, Q20 connected in series between a terminal S4 connected to the power supply VCCL and a terminal S5 connected to the power supply VCCH. The output signal GA2, which is the output of the node N5, is input to the gate of the transistor Q19, and the output signal GB2, which is the output of the node N6, is input to the gate of the transistor Q20. The compensation signal CCn is output to the storage capacitance lines CCLn from the output node OUT which is a common connection node between the transistor Q19 and the transistor Q20.

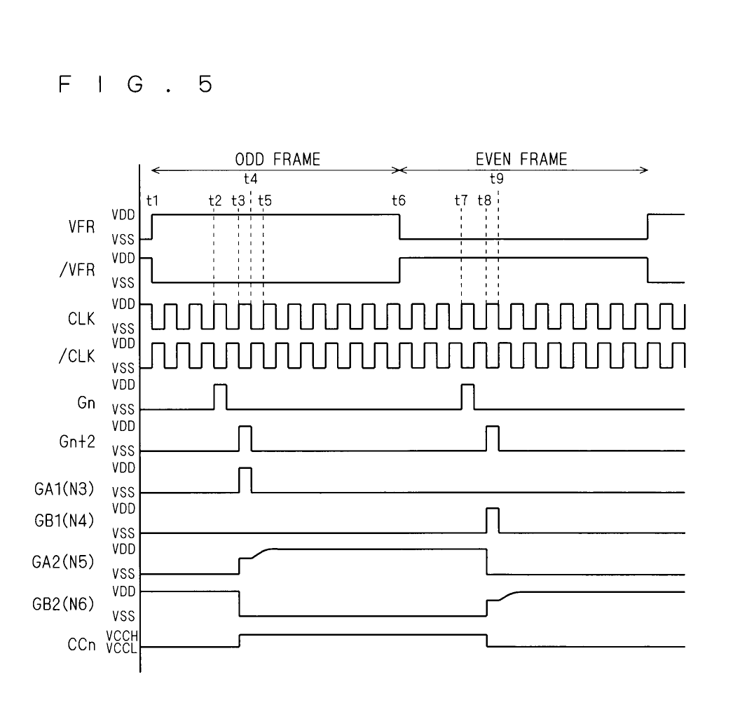

FIG. 5 shows an operation waveform chart of the storage capacitance line drive circuit 90 according to the present embodiment. In the operation waveform shown in FIG. 5, the VFR signal and the /VFR signal are signals complementary to each other, and the levels thereof alternate for every one frame in a blanking period of the image display device. In the operation waveform shown in FIG. 5, a period in which the VFR signal is H level is defined as an odd frame, and a period in which the VFR signal is L level is defined as an even frame.

In the operation waveform shown in FIG. 5, the clock signals CLK, /CLK are repeating signals that alternate at a constant cycle. A clock signal used to generate the gate line drive signal Gn in the gate line drive circuit 30 may be used for the clock signals CLK, /CLK. The clock signal used in the gate line drive circuit 30 is used for the clock signals CLK, /CLK shown in FIG. 5.

The input signal of the storage capacitance line drive circuit 90 shown in FIG. 4 is the gate line drive signal Gn+2 of two rows after the gate line drive signal Gn corresponding to the compensation signal CCn. In the present embodiment, the gate line drive signal Gn+2 provided to the gate line GLn+2 that can be easily obtained is directly used as the input signal of the storage capacitance line drive circuit 90, but the signal is not limited to the gate line drive signal Gn+2 as long as the signal has the same timing and a predetermined voltage level.

The operation of the storage capacitance line drive circuit 90 shown in FIG. 4 will now be described with reference to the operation waveform of FIG. 5. First, at time t1, when the levels of the VFR signal, /VFR signal respectively change, the transistor Q1 shown in FIG. 4 is turned ON and the transistor Q2 is turned OFF, whereby the node N1 is charged to the potential of VDD-Vth by the high potential power supply VDD1. The transistor Q5 is turned ON when the potential of the node N1 becomes VDD-Vth.

At time t1, the transistor Q3 is turned OFF and the transistor Q4 is turned ON, and the node N2 is charged to the potential of the VSS, whereby the transistor Q7 is turned OFF. Furthermore, at time t1, the transistor Q6 is turned OFF and the transistor Q8 is turned ON. Since the gate line drive signal Gn+2 (hereinafter also simply referred to as Gn+2 signal), which is the input signal, is at L level, the node N3 is set to the L level through the transistor Q5, and the node N4 is set to the L level through the transistor Q8.

The gate line drive signal Gn becomes H level at time t2, and the gate line drive signal Gn+2 becomes H level at time t3, which is after two horizontal periods (2H) from time t2. When the Gn+2 signal becomes H level, the voltage level (GA1) of the node N3 rises through the transistor Q5 in the ON state. The voltage level change (GA1) of the node N3 couples to the node N1 through the gate-channel capacitance of the transistor Q5, and the level of the node N1 rises. As a result, the transistor Q5 operates in an unsaturated region, and the output voltage (GA1) of the node N3 becomes H level (VDD) without Vth loss.

When the output signal of the output level switching circuit 1 is at H level (VDD), the output level holding circuit 2 has the transistor Q9 and the transistor Q12 turned ON. The voltage level (GA2) of the node N5 rises when the transistor Q9 is turned ON, and the voltage level (GB2) of the node N6 falls when the transistor Q12 is turned ON. As a result, the node N5 becomes H level (VDD-Vth), and the node N6 becomes L level (VSS). In other words, at time t3, the transistor Q9 is turned ON, the transistor Q10 and the transistor Q13 are turned OFF, the transistor Q11 is turned OFF, and the transistor Q12 is turned ON, and thus pass-through current does not flow between the high potential power supply VDD2 and the VSS potential.

Here, the transistors Q9 (Q11), Q12 (Q10) are given sufficient driving ability so as to charge/discharge the nodes N5, N6 within a predetermined time. That is, the transistors Q9 (Q11), Q12 (Q10) also serve as buffer circuits.

At time t4, the Gn+2 signal becomes L level, and the node N3 is discharged through the transistor Q5 since the transistor Q5 is in the ON state. As a result, the transistors Q9, Q12 are turned OFF at time t4. When the node N5 is charged and becomes H level, and the transistor Q14 is turned ON accompanied therewith, the node N5 holds the H level and the node N6 holds the L level. However, as time elapses, the level of the node N5 lowers due to the leakage current between the node N5 and the S1 terminal, and the H level can be no longer maintained. The transistors Q15, Q17 and the capacitance element C1 thus configure a level holding circuit for holding the H level of the node N5.

When the clock signal /CLK rises immediately after time t4, the potential of the VDD or the voltage change amount of the clock terminal CK couples to the node N7 through the capacitance element C1. The node N7 has already been charged to the potential of VDD-Vth the transistor Q17 from the node N5, and thus the voltage of the node N7 is stepped up to about two times (2·VDD-Vth) of the VDD-Vth. When the node N7 is stepped up, the transistor Q15 is turned ON, the node N5 is charged to the potential of the VDD by the high potential power supply VDD2, and the lowering in level of the node N5 due to the leakage current is compensated.

When the clock signal /CLK becomes L level at time t5, the voltage level of the node N7 again becomes VDD-Vth. The source (node N5) of the transistor Q15 then becomes higher than the voltage level of the gate (node N7), and thus the transistor Q15 is turned OFF and the node N5 again starts to fall by the leakage current. However, since the clock signal /CLK again changes to H level after one horizontal period (H) from time t5, the voltage level of the node N5 recovers to the potential of the VDD. That is, the H level of the node N5 is refreshed at a constant period (clock signal period) by the clock signal /CLK and thus held.

A circuit configured by the transistors Q16, Q18 and the capacitance element C2 has the node N6 at L level and also the node N8 at L level. Thus, when the clock signal /CLK rises, the level of the node N8 coupled through the capacitance element C2 rises, but instantaneously lowers to L level after rising to a constant level since the transistor Q14 is turned ON. That is, a voltage of spike-form is generated at the node N8. The voltage of spike-form can be made small by appropriately setting the on-resistance value of the transistor Q14 and the capacitance value of the capacitance element C2. Thus, the OFF state of the transistor Q16 can be maintained. That is, the node N6 can be held at the L level. The pass-through current also does not flow between the transistor Q16 and the transistor Q14, and invalid power consumption does not exist.

A case in which the clock signal used in the gate line drive circuit 30 is adopted for the clock signal /CLK for the node N5 (N6) holding the H level has been described above. The present invention is not limited thereto, however, a clock signal of lower frequency may be used as long as the lowering of the level due to leakage current can be compensated. The power consumption due to the clock signal can be reduced if the clock signal of lower frequency is used.

The operation of the storage capacitance line drive circuit 90 shown in FIG. 4 will be again described returning to time t3. When the node H5 becomes H level and the node N6 becomes L level at time t3, the transistor Q19 is turned ON, the transistor Q20 is turned OFF, the output node OUT is charged by the power supply VCCH, and the voltage of the VCCH is output.

That is, the level of the output node OUT is VCCL before time t3 but is changed to VCCH at time t3, where such voltage change amount (VCCH-VCCL) is provided to the storage capacitance element 27 of the pixel through the storage capacitance line CCL as the compensation signal CCn. The compensation signal CCn of the voltage change amount (VCCH-VCCL) couples to the pixel electrode Np through the storage capacitance element 27 of the pixel, and sets the potential of the pixel electrode Np to a desired level. Since the pixel electrode Np and the output node OUT are capacitance coupled, if the voltage change amount (VCCH-VCCL) is a predetermined value, the absolute value thereof will not be a problem.

Therefore, the level of the output node OUT can be set to conditions convenient in driving. For instance, if the potential of the VCCL is set to the ground potential (reference level of the pixel write signal) of the display device, the VCCL power supply does not need to be newly prepared, and the cost of the display device can be reduced. In this case, it is generally possible to use the VCCK power supply on the positive pole side from another power supply in a relatively easy manner.

If the amorphous silicon TFT is used in the storage capacitance line drive circuit 90 shown in FIG. 4, the driving ability thereof is low compared to the polysilicon TFT, and the driving ability of the transistor can be made the highest by having the potential of the VSS as the VCCL power supply to obtain as large as possible gate-source voltage of the transistor Q19. In this case, the VCCL power supply is unnecessary.

The level of the nodes N5, N6 is held by the output level holding circuit 2 until inverted the next time (after one frame in FIG. 5). The output node OUT thus will not be high impedance (floating).

At time t6, the VFR signal changes to L level, the /VFR signal changes to H level, and the output level switch circuit 1 performs an operation opposite to time t1. That is, the node N1 becomes L level and the node N2 becomes H level (VDD-Vth), but the node N3 maintains L level since the transistor Q6 is turned ON, and the node N4 maintains L level since the transistor Q7 is turned ON. Therefore, at time t6, the respective output levels (GA1, GB2) of the output level holding circuit 2 do not change, and the level (CCn) of the output node OUT of the output circuit 3 also does not change, as shown in FIG. 5.

At time t7, the gate line drive signal Gn becomes H level, and two horizontal periods (2H) thereafter, the gate line drive signal Gn+2 becomes H level at time t8. When the gate line drive signal Gn+2 becomes H level at time t8, the level of the node N4 rises and becomes H level (VDD) through the transistor Q7 in the ON state. When the node N4 becomes H level, the transistor Q11 and the transistor Q10 of the output level holding circuit 2 are turned ON. The level of the node N6 rises when the transistor Q11 is turned ON, and the level of the node N5 falls when the transistor Q10 is turned ON. As a result, the node N6 becomes H level (VDD-Vth) and the node N5 becomes L level (VSS) at time t8, and the output levels (GA2, GB2) of the output level holding circuit 2 invert as shown in FIG. 5.

The Gn+2 signal becomes L level at time t9, but the output state of the output level holding circuit 2 does not change similar to time t4. Subsequently, the output levels (GA2, GB2) of the output level holding circuit 2 are held by a circuit including the transistors Q16, Q18 and the capacitance element C2 and the clock signal /CLK.

When the node N5 becomes L level and the node N6 becomes H level at time t8, the transistor Q19 is turned OFF and the transistor Q20 is turned ON, the output node OUT is discharged by the VCCL power supply, and the voltage of the VCCL is output. That is, the level (CCn) of the output node OUT changes from VCCH to VCCL, and voltage change amount (VCCH-VCCL) is supplied to the storage capacitance element 27 of the pixel via the storage capacitance line CCLn as compensation signal CCn. The compensation signal CCn of the voltage change amount (VCCH-VCCL) couples to the pixel electrode Np through the storage capacitance element 27 of the pixel and causes the potential of the pixel electrode Np to become the desired level.

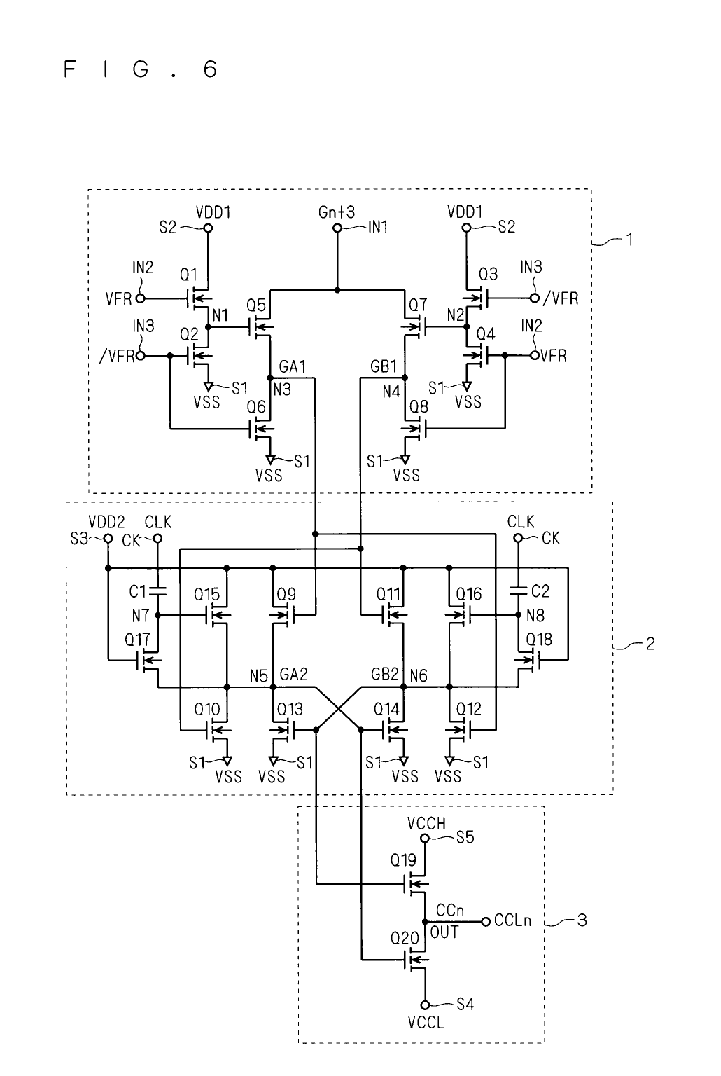

The storage capacitance line drive circuit 90 corresponding to odd rows has been described above, and now a circuit diagram of the storage capacitance line drive circuit 90 with respect to even rows will be shown in FIG. 6. The storage capacitance line drive circuit 90 shown in FIG. 6 has the gate line drive signal after two rows of the corresponding gate line input as an input signal, similar to the storage capacitance line drive circuit 90 shown in FIG. 4. In the storage capacitance line drive circuit 90 shown in FIG. 6, a gate line drive signal Gn+3 (hereinafter also simply referred to as Gn+3) is input as the input signal assuming the corresponding even row as the gate line GLn+1.

However, the storage capacitance line drive circuit 90 shown in FIG. 6 differs from the storage capacitance line drive circuit 90 shown in FIG. 4 and is input with the clock signal CLK, which active level does not overlap the Gn+3 signal, at the clock terminal CK. The circuit configuration of the storage capacitance line drive circuit 90 shown in FIG. 6 is basically the same as the storage capacitance line drive circuit 90 shown in FIG. 4, but the gate inputs of the transistors Q19, Q20 of the output circuit 3 etc. are interchanged with each other to obtain an inverted output of the storage capacitance line drive circuit 90 shown in FIG. 4. Alternatively, the storage capacitance line drive circuit 90 shown in FIG. 6 may interchange the output signals of the nodes N3, N4 with each other to obtain the inverted output of the storage capacitance line drive circuit 90 shown in FIG. 4.

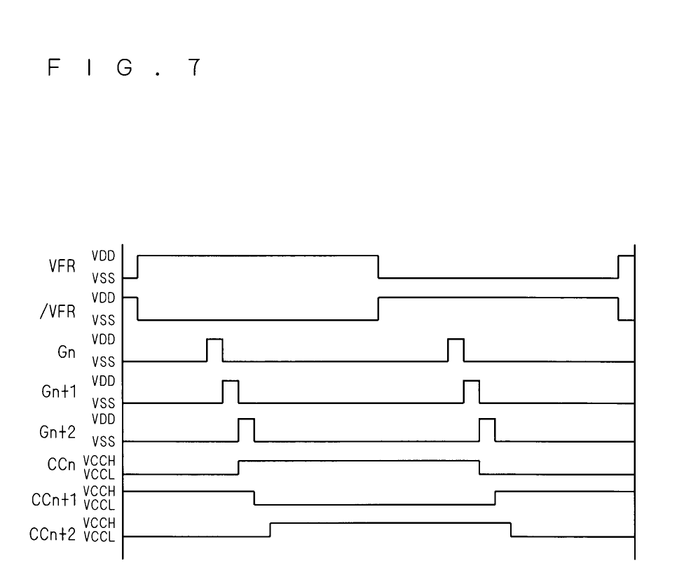

In other words, opposite to the case of the storage capacitance line drive circuit 90 shown in FIG. 4, in the storage capacitance line drive circuit 90 shown in FIG. 6, the compensation signal CCn falls at the odd frames (VFR signal is H level), and rises at the even frames (VFR signal is L level). FIG. 7 shows an operation waveform of the display device (not shown) collectively showing the odd rows and the even rows. In FIG. 7, the temporal change of the VFR signal, the /VFR signal, the input signal (Gn, Gn+1, Gn+2) and the compensation signal (CCn, CCn+1, CCn+2) is shown.

### Variant

A variant of the storage capacitance line drive circuit 90 according to the present embodiment will now be described. In the following description, a circuit corresponding to odd rows will be representatively described for the sake of simplifying the description, but the relevant content is also applicable to a circuit corresponding to even rows.

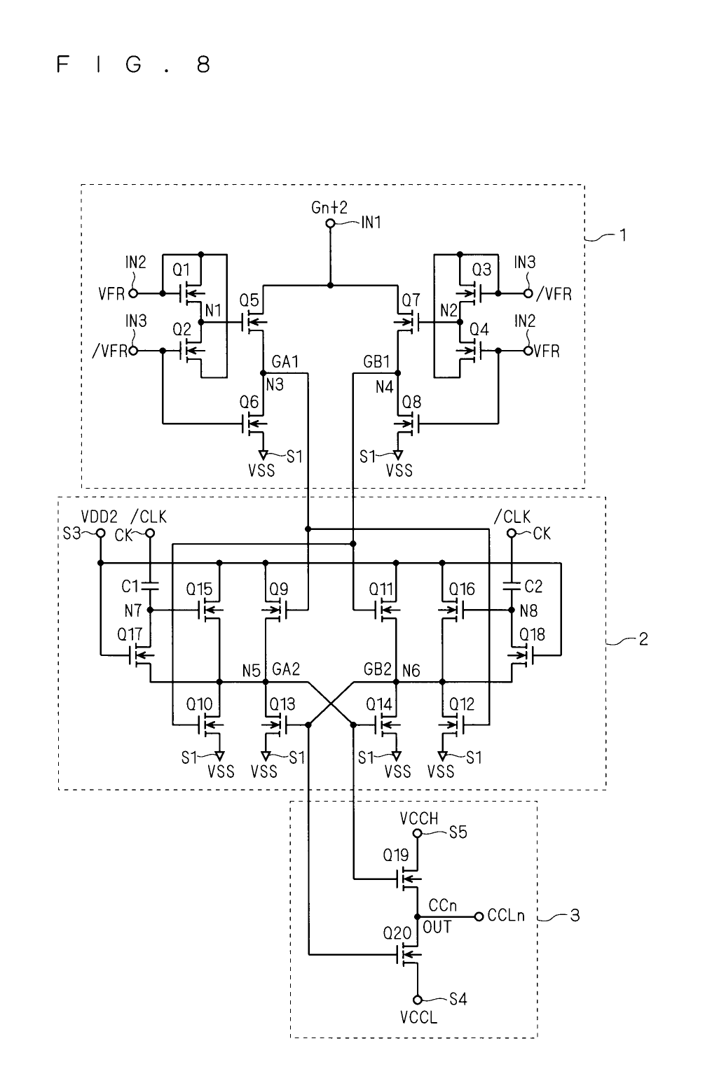

First, FIG. 8 shows a circuit diagram of a first variant of the storage capacitance line drive circuit 90. In the capacitance line drive circuit 90 shown in FIG. 8, the VFR signal is provided to the drain of the transistor Q1 and the source of the transistor Q2 in the output level switching circuit 1, unlike the storage capacitance line drive circuit 90 shown in FIG. 4. Furthermore, in the storage capacitance line drive circuit 90 shown in FIG. 8, the /VFR signal is provided to the drain of the transistor Q3 and the source of the transistor Q4 in the output level switching circuit 1, unlike the storage capacitance line drive circuit 90 shown in FIG. 4.

Thus, in the storage capacitance line drive circuit 90 shown in FIG. 8, the layout design is facilitated since the lines to the high potential power supplies VDD1 and VSS are unnecessary. In FIG. 8, the provision of VFR (/VFR) signal to the transistors Q1 (Q3) and Q2 (Q4) is carried out as a whole, but the present invention is not limited thereto and may be carried out individually.

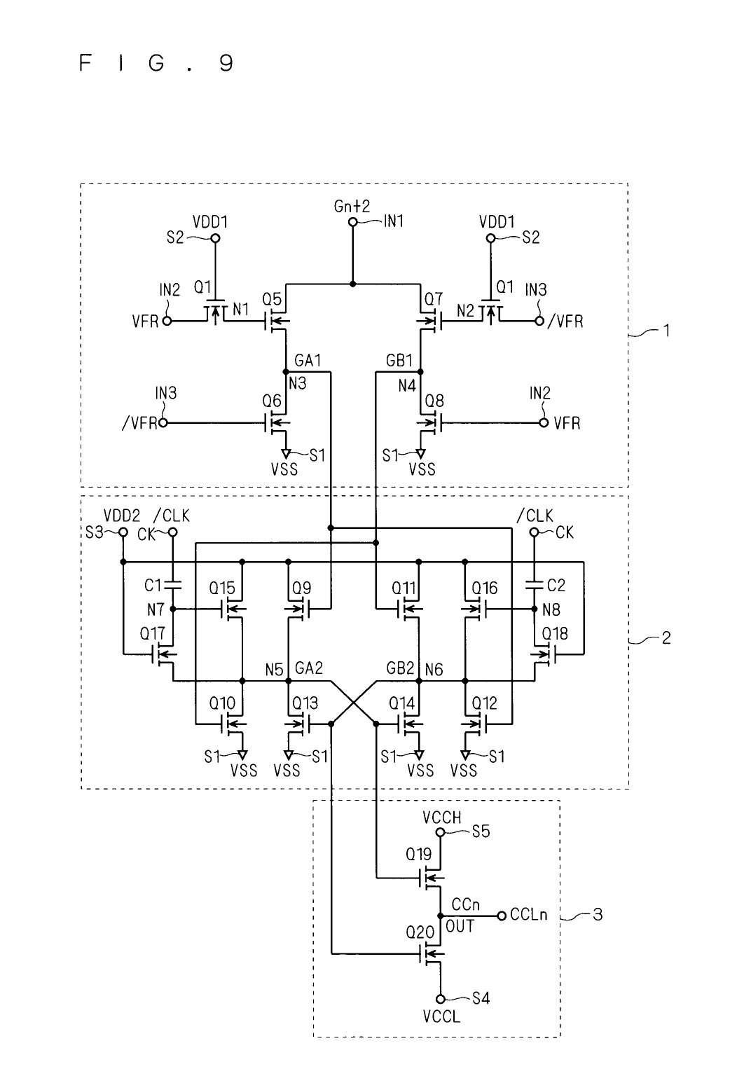

FIG. 9 shows a circuit diagram of a second variant of the storage capacitance line drive circuit 90. In the storage capacitance line drive circuit 90 shown in FIG. 9, the VFR signal is provided to the gate of the transistor Q5 through the transistor Q1 in the output level switching circuit 1, unlike the storage capacitance line drive circuit 90 shown in FIG. 4. Furthermore, in the storage capacitance line drive circuit 90 shown in FIG. 9, the /VFR signal is provided to the gate of the transistor Q7 through the transistor Q3 in the output level switching circuit 1, unlike the storage capacitance line drive circuit 90 shown in FIG. 4.

Thus, in the storage capacitance line drive circuit 90 shown in FIG. 9, the circuit area can be reduced since the transistors Q2, Q4 of the output level switching circuit 1 shown in FIG. 4 are unnecessary and the number of transistors can be reduced.

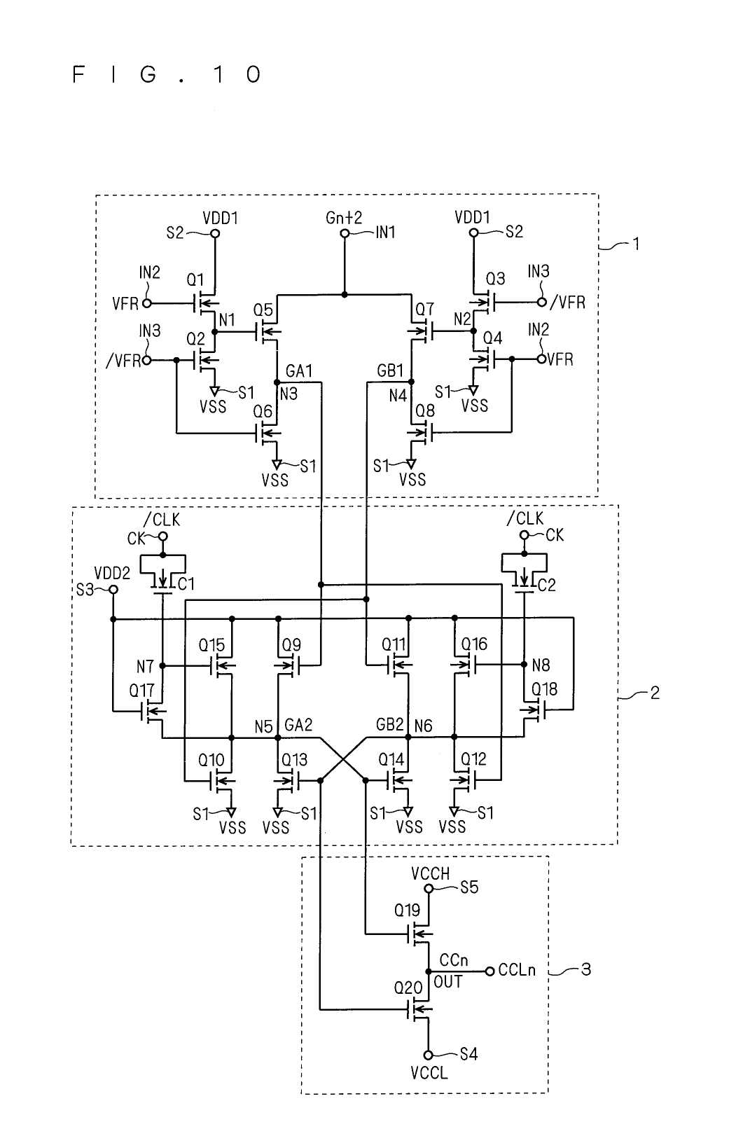

FIG. 10 shows a circuit diagram of a third variant of the storage capacitance line drive circuit 90. In the storage capacitance line drive circuit 90 shown in FIG. 10, MOS capacitance is used for the step-up capacitance elements C1, C2 of the output level holding circuit 2, unlike the storage capacitance line drive circuit 90 shown in FIG. 4. The MOS capacitance does not become a capacitance unless a channel is formed, and thus the capacitance does not exist in appearance when the output level is on the L level side. Thus, when using the MOS capacitance in the storage capacitance line drive circuit 90 shown in FIG. 10, the spike voltage generated at the nodes N5, N6 can be eliminated at the rise of the clock signal /CLK. The MOS capacitance can be applied to the capacitance elements C1, C2 in any one of the embodiments described below.

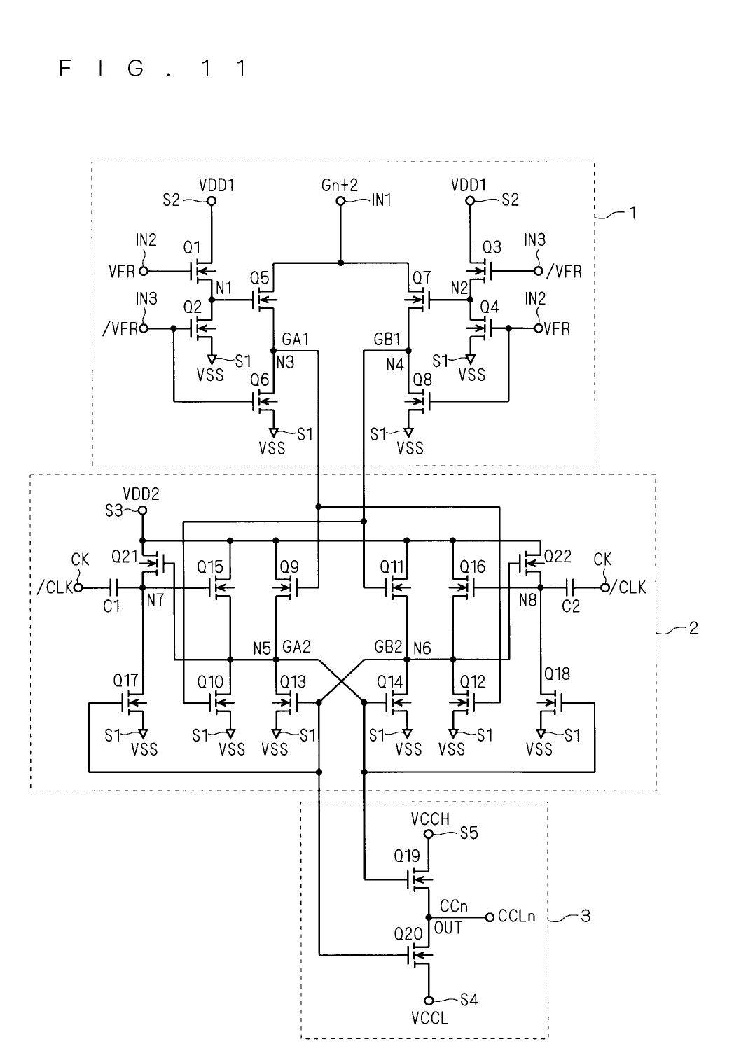

FIG. 11 shows a circuit diagram of a fourth variant of the storage capacitance line drive circuit 90. In the storage capacitance line drive circuit 90 shown in FIG. 11, the step-up capacitance elements C1, C2 and the nodes N5, N6 are not directly coupled in the output level holding circuit 2, unlike the storage capacitance line drive circuit 90 shown in FIG. 4. Thus, the storage capacitance line drive circuit 90 shown in FIG. 11 can present rise of the output L level by the clock signal /CLK in time of refresh. Furthermore, in the storage capacitance line drive circuit 90 shown in FIG. 11, the output signal of an inverter including the transistors Q21 (Q22) and Q17 (Q18) is input to the gate of the transistor Q15 (Q16).

When the node N5 shown in FIG. 11 becomes L level and the node N6 becomes H level, the coupling of the clock signal /CLK through the capacitance element C1 is discharged to the S1 terminal by the transistor Q17 in the ON state due to the H level of the node N6 and thus does not directly influence the node N5.

The node N8 shown in FIG. 11 is initially charged to the potential of VDD-2·Vth by the H level of the node N6, but then stepped up to the potential of about 2·VDD-2·Vth by the coupling of the clock signal /CLK through the capacitance element C2. Thus, the transistor Q16 is turned ON in the unsaturated region, and is raised to the potential of VDD at the same time the level of the node N6 is refreshed.

The level of the node N8 shown in FIG. 11 also lowers by the off leakage current of the transistor Q18. However, the node N8 shown in FIG. 11 is refreshed to the potential of VDD-Vth through the transistor Q22 when the clock signal /CLK becomes L level and the level becomes lower than or equal to the potential of VDD-Vth.

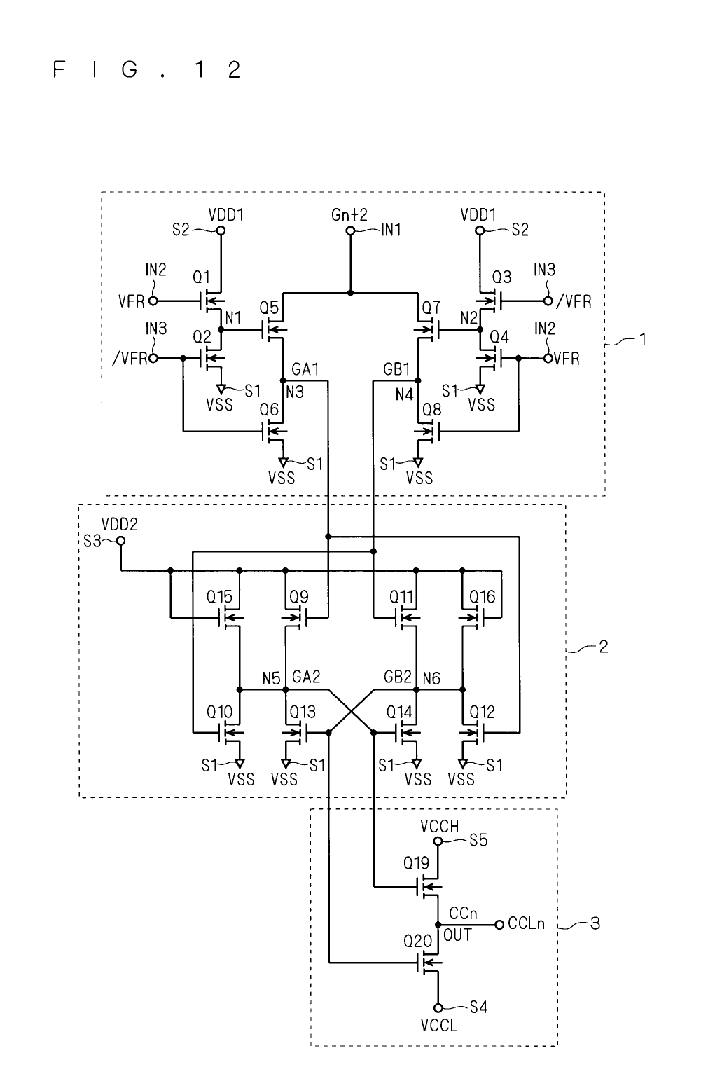

FIG. 12 shows a circuit diagram of a fifth variant of the storage capacitance line drive circuit 90. In the storage capacitance line drive circuit 90 shown in FIG. 12, the holding of the output level in the output level holding circuit 2 is carried out by the transistors Q15, Q16 to which the power supply voltage VDD is supplied to gates, unlike the storage capacitance line drive circuit 90 shown in FIG. 4. Thus, in the storage capacitance line drive circuit 90 shown in FIG. 12, the number of circuit elements for holding the output level is reduced, and the circuit area can be reduced.

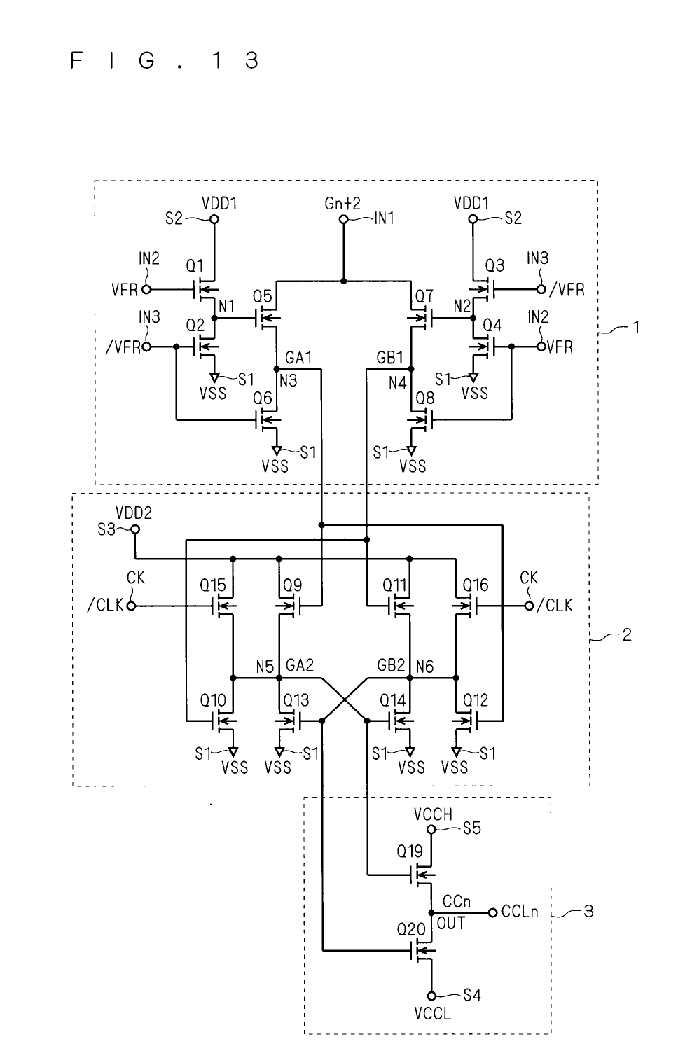

FIG. 13 shows a circuit diagram of a sixth variant of the storage capacitance line drive circuit 90. In the storage capacitance line drive circuit 90 shown in FIG. 13, the clock signal /CLK is provided to the gates of the transistors Q15, Q16, unlike the storage capacitance line drive circuit 90 shown in FIG. 12. Thus, in the storage capacitance line drive circuit 90 shown in FIG. 13, the current flows only during the active period of the clock signal /CLK, and power consumption can be reduced compared to the storage capacitance line drive circuit 90 shown in FIG. 12.

### Second Embodiment

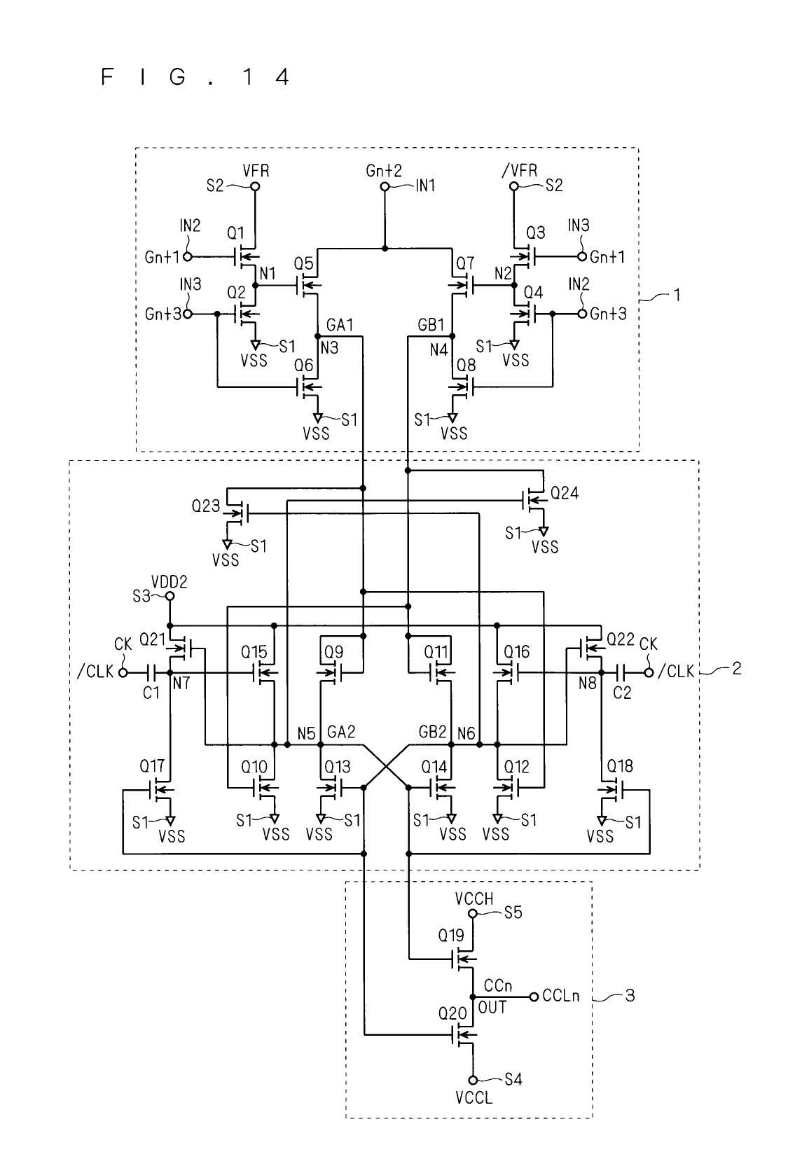

FIG. 14 shows a circuit diagram of the storage capacitance line drive circuit 90 of an image display device according to the present embodiment. The configuration of the image display device according to the present embodiment is the same as the configurations shown in FIGS. 1, 2, and 3, and the detailed description will be omitted. In the storage capacitance line drive circuit 90 shown in FIG. 14, the configurations common with the storage capacitance line drive circuit 90 shown in FIG. 4 are denoted with the same reference numerals and the detailed description thereof will be omitted. The storage capacitance line drive circuit 90 shown in FIG. 14 is effective when using the amorphous silicon TFT. In the following description, a circuit corresponding to odd rows will be representatively described for the sake of simplifying the description, but the relevant content is also applicable to a circuit corresponding to even rows.

First, in the output level switching circuit 1 shown in FIG. 14, the time when the gates of the transistors Q5, Q7 become H level is reduced to alleviate the shift of threshold value Vth of the transistors Q5, Q7 for charging the nodes N3, N4, respectively. That is, the transistor Q1 (Q3) for charging the node N1 (N2) connected to the gate of the transistor Q5 (Q6) is turned ON with the Gn+1 signal before one horizontal period (1h) from the input signal Gn+2. Similarly, the transistor Q2 (Q4) for discharging the node N1 is turned ON with the Gn+3 signal after one horizontal period (1H) from the Gn+2 signal. Thus, the time when the gate of the transistor Q5 (Q7) becomes H level becomes two horizontal periods (2H). The signal before the Gn+1 signal or the signal after the Gn+3 signal may be used for driving, but the shift amount of the threshold value Vth becomes larger depending on the time the gate of the transistor Q5 (Q7) is at H level.

In the output level holding circuit 2 shown in FIG. 14, the drains of the transistors Q9, Q11 are connected to the gates to alleviate the shift towards the negative side of the threshold value Vth of the transistors Q9, Q11 for initially charging the nodes N5, N6, respectively. That is, the nodes N3, N4 shown in FIG. 14 are maintained at L level after being at H level for one horizontal period (1H). Thus, in the output level holding circuit 2 shown in FIG. 4, if the amorphous silicon TFT is used, the bias in which the gates of the transistors Q9, Q11 which output becomes H level is L level and the drain and the source are H level is applied, and the threshold value Vth of the transistors Q9, Q11 shifts towards the negative side. When the threshold value Vth of the transistors Q9, Q11 shifts towards the negative side, the transistors Q9, Q11 are in the normally ON state. In the output level holding circuit 2 shown in FIG. 14, the above conditions are avoided even if the amorphous silicon TFT is used since the drains of the transistors Q9, Q11 are connected to the gates.

The transistors Q15, Q16 shown in FIG. 14 have the threshold value Vth shifted towards the positive side since the gate-source is biased towards the positive side, but is an alternating bias, and thus the transistors Q15, Q16 are turned ON even if shifted to the maximum value. The transistors Q15, Q16 merely need to compensate the lowering in level due to the leakage current of the nodes N5, N6, and thus the threshold value Vth does not become a problem. The transistors Q23, Q24 shown in FIG. 14 are transistors for avoiding the nodes N3, N4 from becoming a high impedance state of L level and the circuit from malfunctioning. The transistors Q23, Q24 shown in FIG. 14 set the node to be at the L level to the L level of low impedance.

The transistors Q21, Q22 shown in FIG. 14 have the source (nodes N7, N8) at L level when the gate is at L level, and have only the drain (S3 terminal) applied with positive bias, and thus the shift amount of the threshold value Vth is small and does not become a problem. Furthermore, the transistors Q21, Q22 shown in FIG. 14 have the drain (nodes N7, N8) at alternating H level when the gate is at H level, and the source (S3 terminal) at the H level same as the gate, and thus the shift amount of the threshold value Vth is small and does not become a problem.

The transistors of the output level holding circuit 2 shown in FIG. 14 other than the above have the gate-source biased to H level and L level in an alternating manner for every one frame, and the threshold value Vth shifts but does not become a problem due to the discharge operation.

In the output circuit 3 shown in FIG. 14, the transistors Q19, Q20 are biased in an alternating manner for every one frame, and the threshold value Vth shifts to about ½ of the amplitude of the gate voltage. Since the transistor Q20 performs the discharge operation, the shift of the threshold value Vth does not become a problem if the gate width of the transistor Q20 is set so that the discharge time is performed at a predetermined time.

The transistor Q19 performs the charge operation, but the H level (=VCCH) to be output is normally set to a value close to the VCCL (e.g., about 3V). However, since the H level (=VDD, e.g., about 30V) sufficiently higher than the VCCH is set to the gate voltage of the transistor Q19, the transistor Q19 operates in the unsaturated operation even if the shift of the threshold value Vth occurs at the transistor Q19. Therefore, the shift of the threshold value Vth does not become a problem if the gate width of the transistor Q19 is set so that the charge time is performed at a predetermined time.

### Variant

A variant of the storage capacitance line drive circuit 90 according to the present embodiment will now be described. First, FIG. 15 shows a circuit diagram of a first variant of the storage capacitance line drive circuit 90. In the storage capacitance line drive circuit 90 shown in FIG. 15, the gate and the drain of the transistor Q21 in the output level holding circuit 2 are connected to the node N3, and the gate and the drain of the transistor Q22 are connected to the node N4, unlike the storage capacitance line drive circuit 90 shown in FIG. 14. Furthermore, in the storage capacitance line drive circuit 90 shown in FIG. 15, the transistor Q17 is connected between the node N7 and the node N5, and the transistor Q18 is connected between the node N8 and the node N6.

The transistors Q21, Q22 shown in FIG. 15 are used to charge the nodes N7, N8 to the H level at the initial stage. The transistors Q17, Q18 shown in FIG. 15 are respectively used to selectively discharge the nodes N7, N8.

In the output level holding circuit 2 shown in FIG. 15, the discharge of the nodes N7, N8 is performed when the nodes N5, N6 are respectively at L level, and the discharge is not performed when at H level. When the nodes N5, N6 are respectively at H level, the nodes N7, N8 are stepped up, and the nodes N5, N6 are respectively charged to VDD. When the nodes N5, N6 become H level, the nodes N7, N8 are respectively charged through the transistors Q17, Q18, thereby compensating for the lowering in H level by the leakage current of the nodes N7, N8.

The transistors Q17, Q18 shown in FIG. 15 are applied with positive bias between gate-source when the nodes N5, N6 are at L level, and the threshold value Vth shifts towards the positive side, but does not become a problem with respect to the compensation operation of the leakage current.

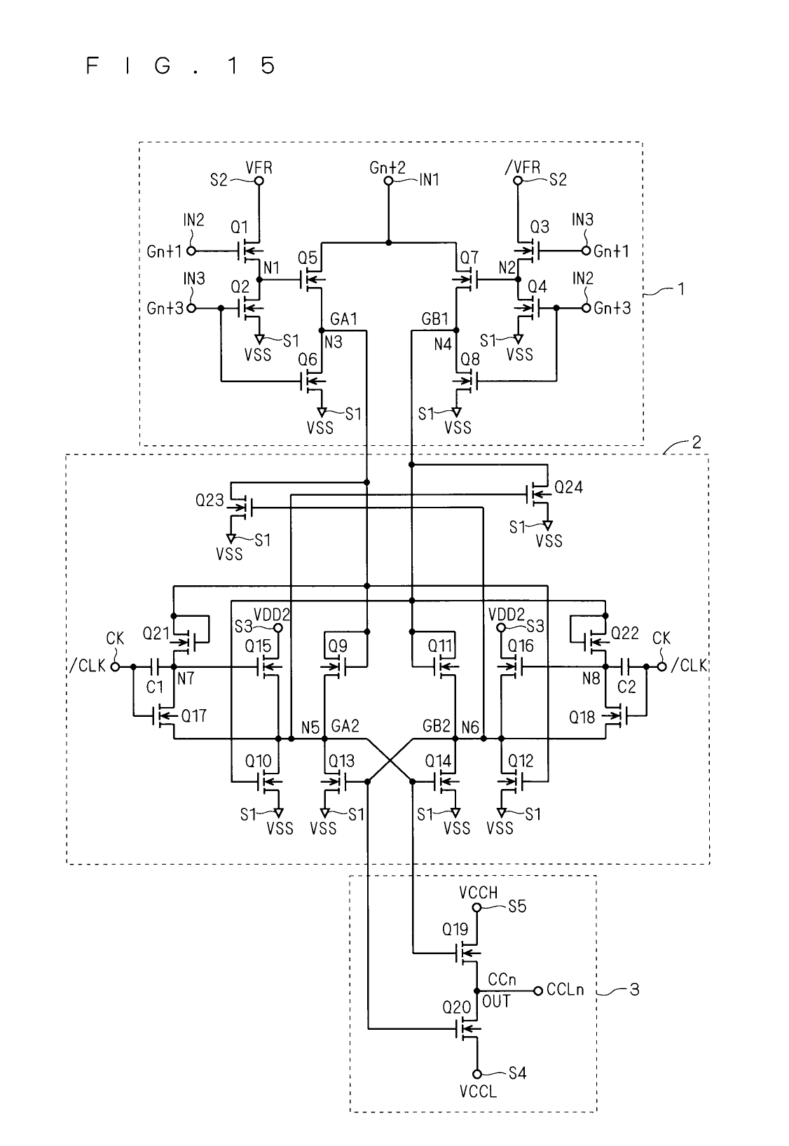

FIG. 16 shows a circuit diagram of a second variant of the storage capacitance line drive circuit 90. In the storage capacitance line drive circuit 90 shown in FIG. 16, the transistors Q25, Q26 are arranged between the nodes N1, N2 of the output level switching circuit 1 and the S1 terminal, respectively, unlike the storage capacitance line drive circuit 90 shown in FIG. 14.

At the nodes N1, N2 shown in FIG. 14, the non-selective side becomes L level of high impedance at the time when the Gn+2 signal rises. Since an overlap capacitance (not shown) exists between the gate and the drain of the transistor Q5 or the transistor Q7 shown in FIG. 14, the gate voltage of the non-selective side transistor rises due to voltage change at the rise of the Gn+2 signal, whereby the relevant transistor is turned ON to be in the selected state.

In the output level switching circuit 1 shown in FIG. 16, the transistors Q25, Q26 are arranged between the nodes N1, N2 and the S1 terminal, respectively, to be turned ON by the potential on the selective side, so that the gate potential of the non-selective side transistor is set to L level of low impedance and malfunctioning of the output level circuit 3 is prevented. The configuration of the output level switching circuit 1 shown in FIG. 16 is also applicable to the storage capacitance line drive circuit 90 shown in FIG. 15.

### Third Embodiment

In the image display device according to the above embodiments, a case in which the gate line drive circuit 30 is operated in one direction has been described, but a case in which the gate line drive circuit 30 has a function of scanning in two-ways will be described in the image display device according to the present embodiment.

If the gate lines are scanned in the backward direction, the storage capacitance line drive circuit 90 shown in FIG. 4 does not normally operate since the input signal to be input after one horizontal period (1H) from the Gn signal needs to be the Gn−2 signal before one horizontal period (1H).

The configuration of the bidirectional gate line drive circuit (shift register) using a single channel transistor is disclosed in Japanese Laid-Open Patent Publication No. 2001-350438. In the relevant configuration, the shift direction is switched by switching the level of two types of voltage signals V1, V2. That is, the gate lines are scanned in the forward direction when the voltage signal V1 is at H level and the voltage signal V2 is at L level, and the gate lines are scanned in the backward direction when the voltage signal V1 is at L level and the voltage signal V2 is at H level.

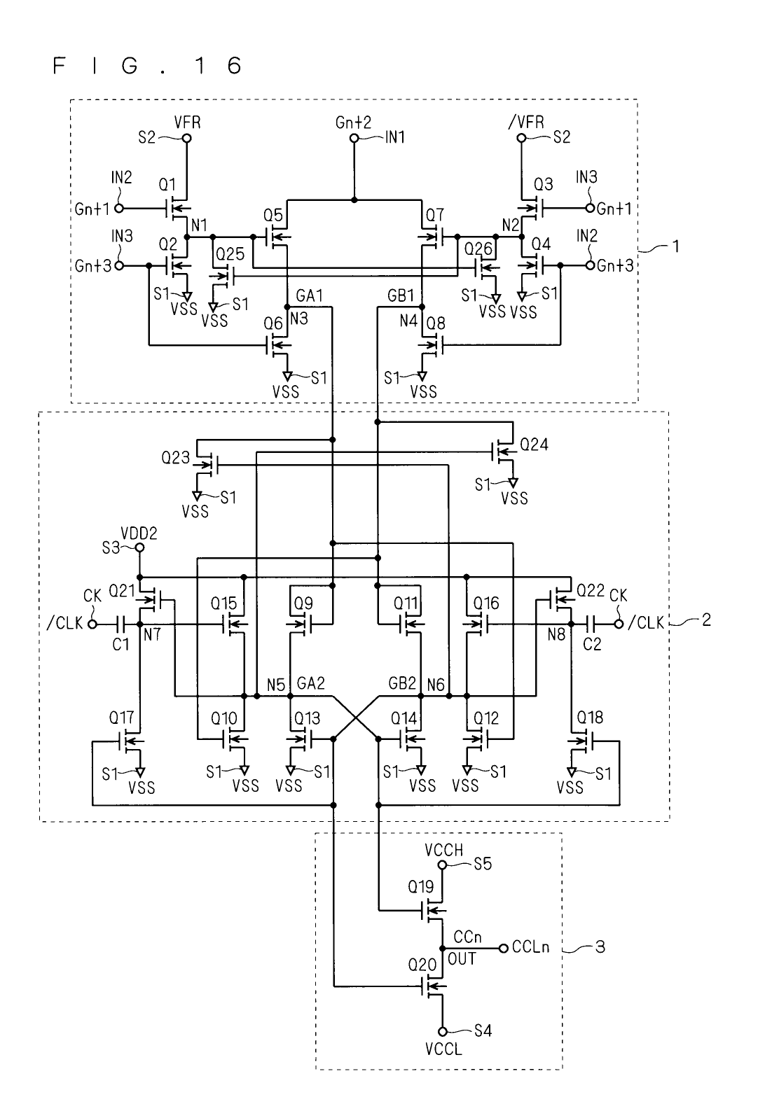

In the image display device according to the present embodiment, the storage capacitance line drive circuit 90 shown in FIG. 17 is used. The capacitance line drive circuit 90 shown in FIG. 17 includes a scanning direction switching circuit 4, in addition to the output level switching circuit 1, the output level holding circuit 2, and the output circuit 3. The storage capacitance line drive circuit 90 shown in FIG. 17 uses the output level switching circuit 1, the output level holding circuit 2, and the output circuit 3 shown in FIG. 4, but the present invention is not limited thereto, and the circuit configurations (FIGS. 8 to 16) described in the above embodiments may be used.

The scanning direction switching circuit 4 shown in FIG. 17 is configured with a circuit by transistors Q27 to Q30. In FIG. 17, the subscript indicating the scanning order of Gn−2, Gn+2 takes the forward scan as a reference.

In the forward scan, since the voltage signal V1 becomes H level (VDD) and charges the node N9 to VDD-Vth, the transistor Q27 is turned ON. On the other hand, since the voltage signal V2, becomes L level (VSS) and discharges the node N10 to VSS, the transistor Q28 is turned OFF. When the transistor Q28 is turned OFF, the gate line drive signal Gn−2 is not transmitted to the node N11.

Therefore, the level of the gate line drive signal Gn+2 is input to the node N11. When the Gn+2 signal changes from L level to H level, the change in level couples to the node N9 through the gate-channel capacitance of the transistor Q27, and raises the level of the node N9. As a result, the transistor Q27 operates in the unsaturated region, and H level signal having a potential of VDD is output to the node N11.

In the backward scan, since the voltage signal V2 becomes H level (VDD) and charges the node N10 to VDD-Vth, the transistor Q28 is turned ON. When the transistor Q28 is turned ON, the gate line drive signal Gn−2 is input to the node N11, and the Gn−2 signal acts the same as the Gn+2 signal of the forward scan. The operations of the output level switching circuit 1, the output level holding circuit 2, and the output circuit 3 in the forward scan and the backward scan are the same as the circuit of FIG. 4 described in the first embodiment, and thus the description thereof will be omitted.

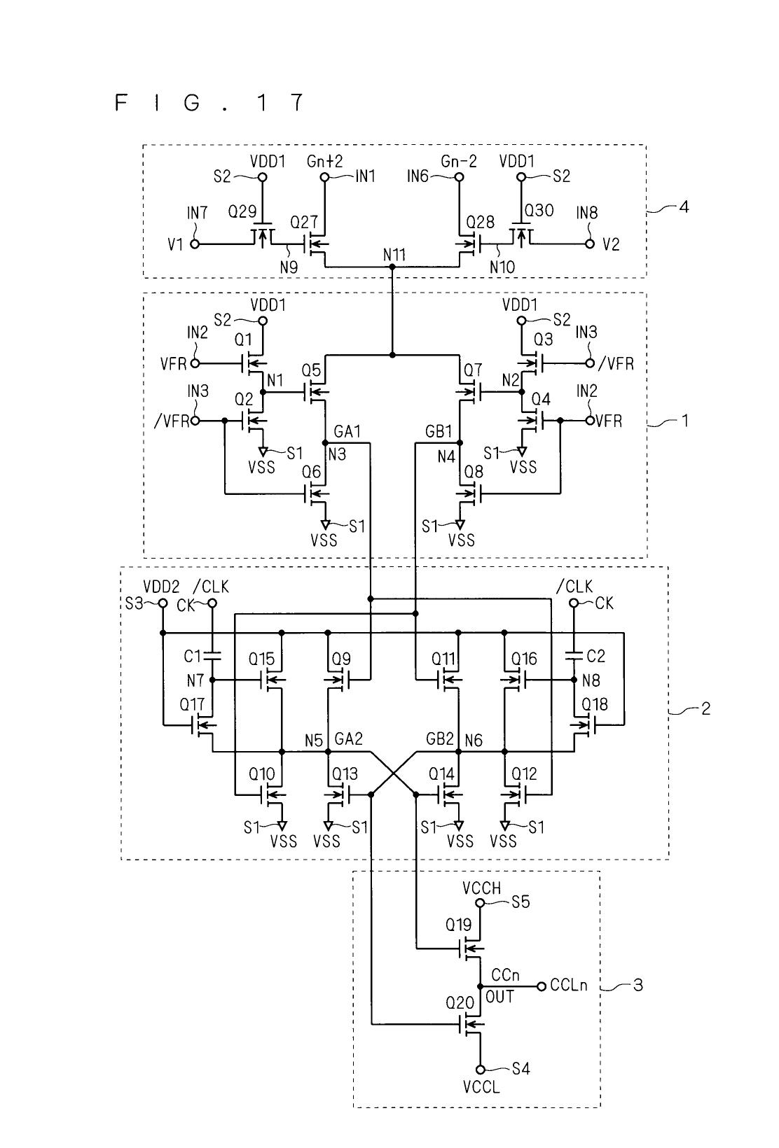

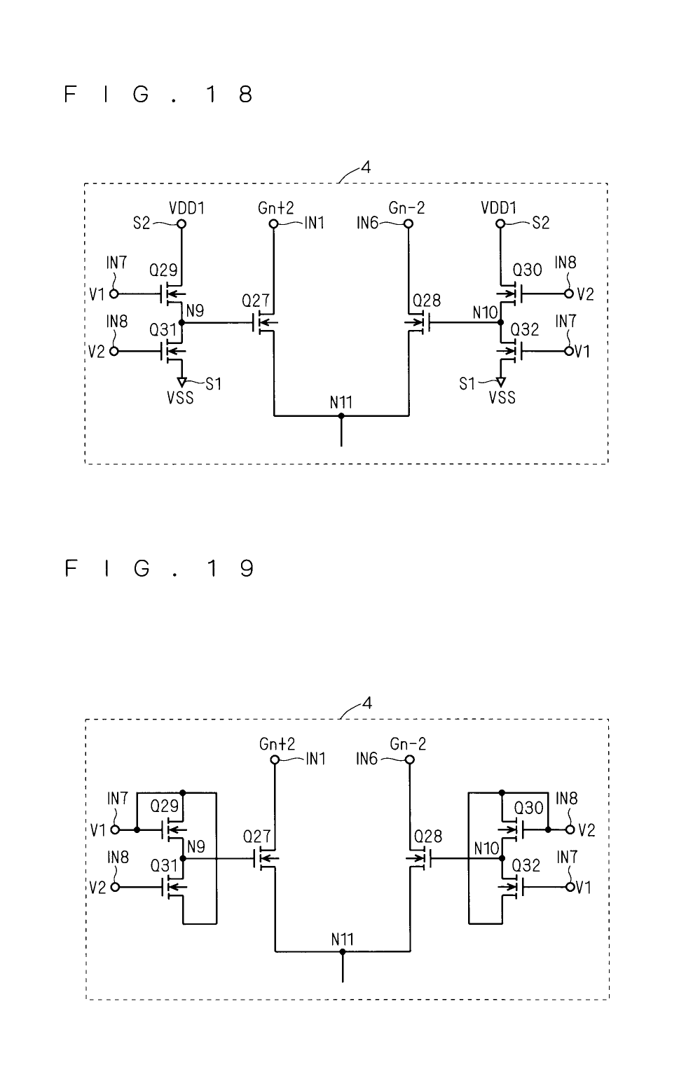

The scanning direction switching circuit 4 is not limited to the circuit configuration shown in FIG. 17, and the circuit configurations shown in FIGS. 18 and 19 may be used. The scanning direction switching circuit 4 shown in FIG. 18 further includes transistors Q31, Q32, wherein the voltage signal V1 is provided to the gates of the transistors Q29, Q32, and the voltage signal V2 is provided to the gates of the transistors Q30, Q31. In the scanning direction switching circuit 4 shown in FIG. 18, the drains of the transistors Q29, Q30 are connected to the high potential power supply VDD1, the sources of the transistors Q31, Q32 are connected to the VSS, the source of the transistor Q29 and the drain of the transistor Q31 are connected to the node N9, and the source of the transistor Q30 and the drain of the transistor Q32 are connected to the node N10.

The scanning direction circuit 4 shown in FIG. 19 has a circuit configuration in which the drain of the transistor Q29 and the source of the transistor Q31 are connected to the gate of the transistor Q29, and the drain of the transistor Q30 and the source of the transistor Q32 are connected to the gate of the transistor Q30 in the circuit configuration of the scanning direction switching circuit 4 shown in FIG. 18.

### Variant

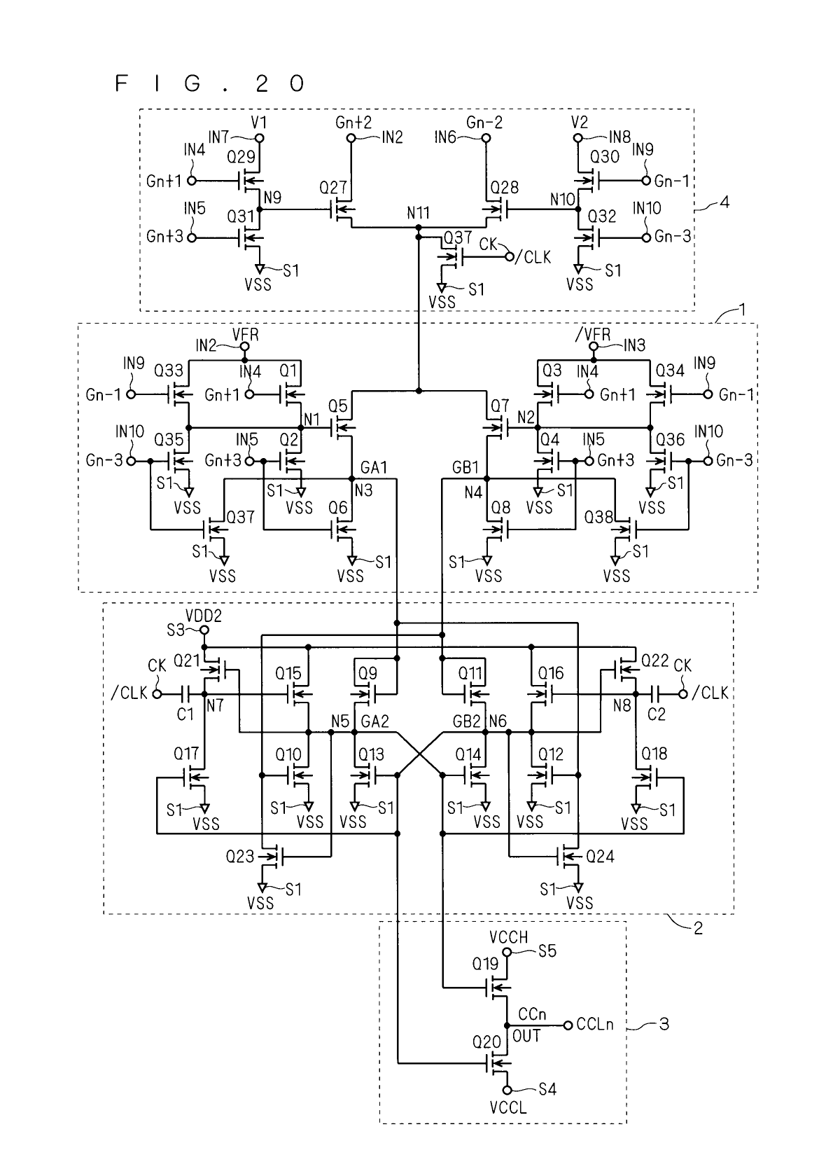

In the scanning direction switching circuit 4 shown in FIGS. 17 to 19, the gate, source-drain of the transistors Q27, Q28 are continuously applied with DC bias, and thus when the amorphous silicon TFT is used, the threshold value Vth may shift, and the circuit may malfunction. Thus, the storage capacitance line drive circuit 90 for alleviating the shift of the threshold value Vth is adopted in the storage capacitance line drive circuit 90 according to the present example. FIG. 20 shows a circuit diagram of a variant of the storage capacitance line drive circuit 90.

In the scanning direction switching circuit 4 shown in FIG. 20, the voltage signal V1=H level and the voltage signal V2=L level in the forward scan. On the node N10 side, the voltage signal V2 is L level, and thus the transistor Q28 is turned OFF even if the Gn−1 signal becomes H level. On the node N9 side, the node N9 is charged to H level when the Gn+1 signal becomes H level. When the Gn+2 signal becomes H level after the Gn+1 signal becomes L level, the node N9 is stepped up, and the node N11 becomes H level (VDD) through the transistor Q27. When the Gn+2 signal becomes L level, the node N11 becomes L level. That is, a state equivalent to the state in which the Gn+2 signal is input to the IN1 terminal is obtained in the storage capacitance line drive circuit 90 shown in FIG. 12.

In the output level switching circuit 1 shown in FIG. 20, when the VFR signal is H level and the /VFR signal is L level, on the node N2 side, the node N2 is L level even if the Gn−1 signal and the Gn+1 signal are H level since /VFR signal is L level, and the transistor Q7 is turned OFF. On the node N1 side, the node N1 is charged to H level through the transistor Q33 when the Gn−1 signal becomes H level, and the transistor Q5 is turned ON. However, the node N9 at this point is pulled down to L level by the clock signal /CLK through the transistor Q37, and thus the node N3 is maintained at L level.

When the Gn+1 signal becomes H level, the node N1 is charged to H level through the transistor Q1, and the transistor Q5 is turned ON. In this case, the node N11 becomes H level by the Gn+2 signal, and the node N3 becomes H level through the transistor Q5. The Gn+2 signal and the clock signal /CLK have the respective phases of the active level different from each other, and thus the node N11 will not lower from H level by the clock signal /CLK. The subsequent operation is the same as in the capacitance line drive circuit 90 shown in FIG. 12 of the second embodiment.

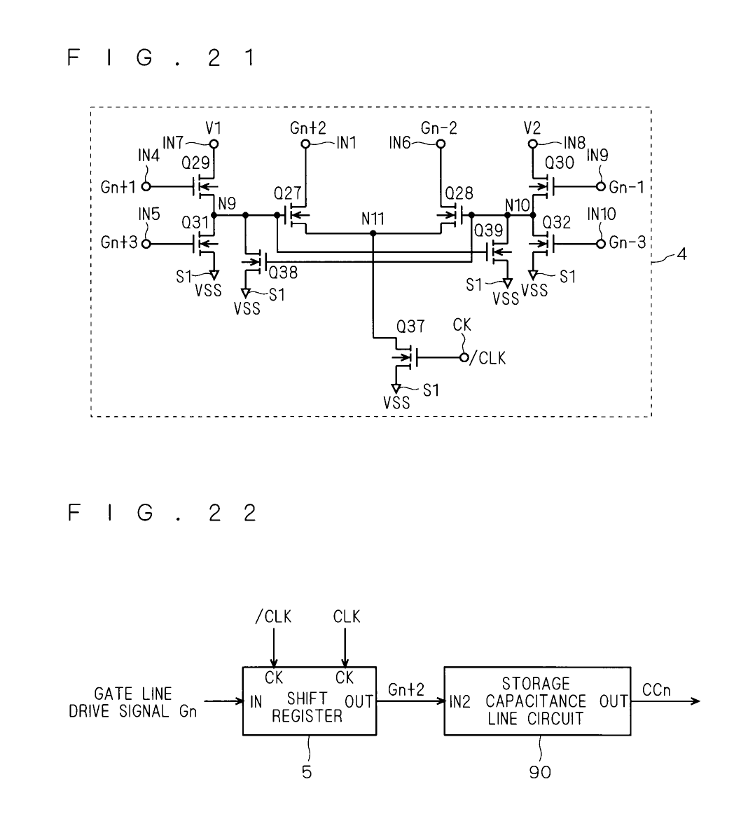

FIG. 21 shows another circuit configuration of the scanning direction switching circuit 4. The scanning direction switching circuit 4 shown in FIG. 21 is a modified form of the scanning direction switching circuit 4 shown in FIG. 20, and can be replaced with the scanning direction switching circuit 4 shown in FIG. 20.

In the scanning direction switching circuit 4 shown in FIG. 20, the non-selective side becomes L level of high impedance when the Gn−2 signal rises in the nodes N9, N10. An overlap capacitance (not shown) exists between the gate and the drain (node N11) of the transistor Q27 or Q28. Thus, the gate voltage of the non-selective side transistor rises and the transistor is turned ON due to voltage change at the time of rise of the Gn+2 signal, and the level of the node N11 may lower. In the scanning direction switching circuit 4 shown in FIG. 21, the transistors Q38, Q39 are arranged between the node N9, N10 and the S1 terminal, respectively, and are turned ON by the potential of the selective side, so that the gate potential of the non-selective side transistor is set to L level of low impedance, and malfunction of the circuit is prevented.

### Fourth Embodiment

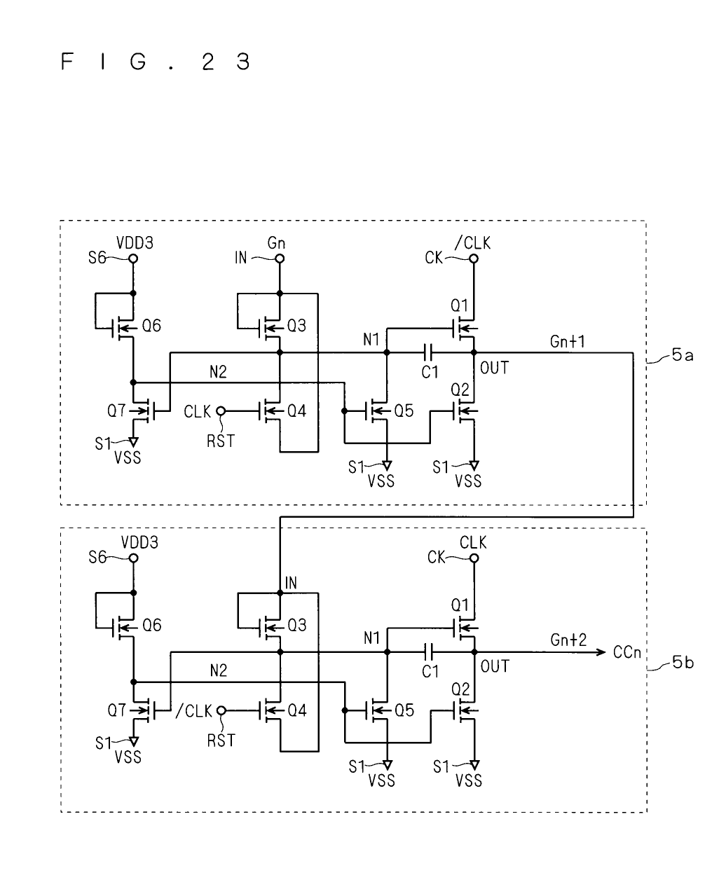

FIG. 22 shows a block diagram of one part of the image display device according to the present embodiment. In the block diagram shown in FIG. 22, a state in which a shift register 5 and the storage capacitance line drive circuit 90 are arranged, and the compensation signal CCn is generated from the gate line drive signal Gn is shown. In the storage capacitance line drive circuit 90 shown in the first to the third embodiments, the gate line drive signal Gn+2 two rows after the gate line drive signal Gn is used as the input signal. However, in the image display device according to the present embodiment, a function of generating the input signal from the gate line drive signal Gn as shown in FIG. 22 instead of using the gate line drive signal Gn+2 directly as the input signal is provided.

In the shift register 5 shown in FIG. 22, a signal after a predetermined time from when the gate line drive signal Gn becomes a selected state (the relevant signal is written as Gn+2 signal to achieve consistency with other embodiments) is generated, and the relevant signal (Gn+2 signal) is input to the storage capacitance line drive circuit 90. In the present embodiment, the input signal (Gn+2 signal) delayed by a predetermined time irrespective of the scanning direction can be generated by generating a delay signal from the gate line drive signal Gn. Therefore, the scanning direction switching circuit 4 as shown in FIG. 17 is not necessary, whereby the layout design of the signal lines and the circuits is facilitated.

The input signal of the shift register 5 is not limited to the gate line drive signal Gn, and may be other signals as long as it is a signal having the same phase and a predetermined voltage level. The configuration of the image display device according to the present embodiment is the same as the configuration shown in FIGS. 1 to 3, and thus the detailed description will be omitted. The storage capacitance line drive circuit of FIG. 4 and the like without the scanning direction switching circuit 4 may be applied to the storage capacitance line drive circuit 90 according to the present embodiment.

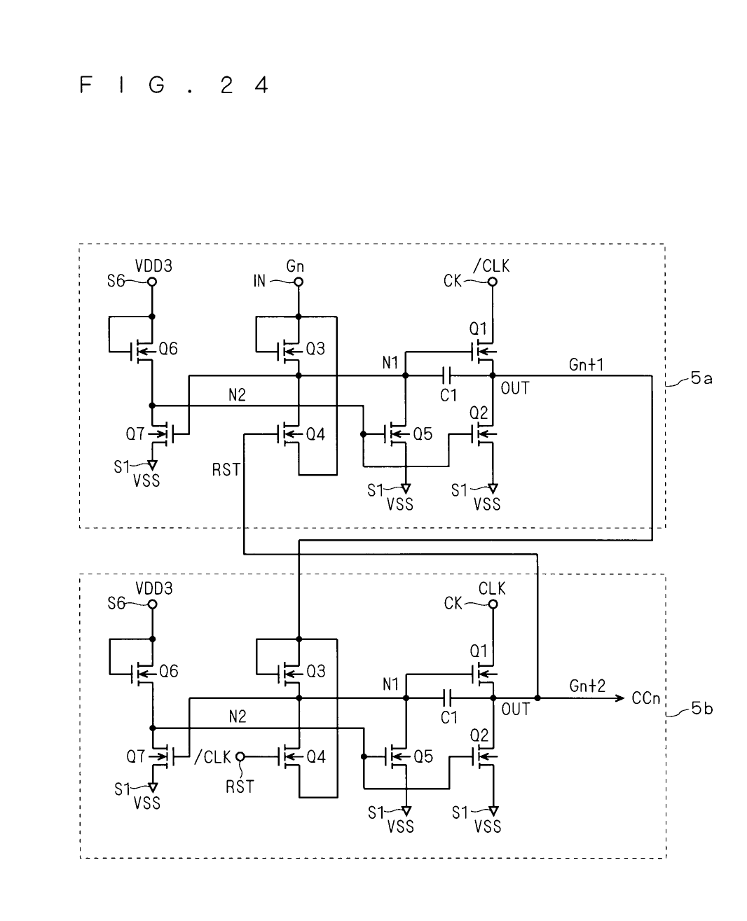

FIG. 23 shows a circuit diagram of the shift register 5 according to the present embodiment. The shift register 5 consisting of a single conductivity-type TFT shown in FIG. 23 is merely illustrative, and is not limited to the relevant circuit. The shift register 5 shown in FIG. 23 is configured by two-step unit shift registers of a pre-stage 5a and a post-stage 5b, and operates with two-phase clock signals complementary to each other having a cycle of two horizontal periods (2H).

The shift register 5 shown in FIG. 23 has an output that rises after two horizontal periods (2H) from the rise of the Gn signal, and outputs a pulse having a width of substantially one horizontal period (1H). The step-up capacitance element C1 shown in FIG. 23 is not an essential circuit element as it can be substituted with gate-channel capacitance of the transistor Q1. The voltage of the voltage source VDD3 is assumed as VDD.

In the pre-stage 5a shown in FIG. 23, the transistor Q3 is turned ON when the Gn signal becomes H level. At the same time, the clock signal CLK in-phase with the Gn signal is input to the gate of the transistor Q4, but the transistor Q4 is turned OFF since the Gn signal is input to the source of the transistor Q4. Therefore, the node N1 is charged to a potential of VDD-Vth, and the transistor Q7 is turned ON. The inverter configured by the transistor Q6 and the transistor Q7 configures a ratio circuit in which the on-resistance ratio of the transistors Q6, Q7 is set to a predetermined ratio. The node N2 then becomes L level, and the transistors Q5, Q2 are turned OFF. At the same time, the transistor Q1 is turned ON and the output node OUT becomes L level according to the L level of the clock signal /CLK.

In the pre-stage 5a shown in FIG. 23, the transistor Q3 is turned OFF when the Gn signal becomes L level. However, the node N1 maintains H level. Therefore, the L level of the node N2 is also maintained, and the transistors Q5, Q2 are maintained in the OFF state.

In the pre-stage 5a shown in FIG. 23, when the clock signal /CLK becomes H level, the output node OUT becomes H level through the transistor Q1. The voltage change amount of the output node OUT couples with the node N1 through the step-up capacitance C1, the level of the node N1 steps up, the transistor Q1 operates in the unsaturated region, and the output node OUT becomes H level having the potential of the VDD.

In the pre-stage 5a shown in FIG. 23, when the clock signal /CLK becomes L level, the output node OUT becomes L level since the transistor Q1 is turned ON. The pre-stage 5a shown in FIG. 23 outputs the Gn+1 signal that is delayed by one horizontal period from the Gn signal.

In the pre-stage 5a shown in FIG. 23, when the clock signal CLK becomes H level, since the Gn signal has already been at L level, the transistor Q4 is turned ON, and the charges corresponding to the VDD-Vth remaining at the node N1 are discharged to L level. Thus, the output node OUT can be prevented from becoming H level when the next clock signal /CLK becomes H level. Furthermore, since the transistor Q7 is turned OFF, the node N2 becomes H level by the transistor Q6, and the transistors Q5, Q2 are turned ON. The node N1 and the output node OUT maintain L level of low impedance, and stabilize the operation of the shift register 5.

The post-stage 5b shown in FIG. 23 is the same circuit configuration as the pre-stage 5a, and the operation thereof is equivalent to the operation of the pre-stage 5a in which the phase of the clock signal CLK is delayed by one horizontal period (1H). Therefore, the Gn+2 signal of the output signal of the post-stage 5b is a signal delayed by one horizontal period (1H) from the Gn+1 signal of the output signal of the pre-stage 5a shown in FIG. 23, and is a signal delayed by two horizontal periods (2H) from the Gn signal of the input signal of the pre-stage 5a.

### Variant

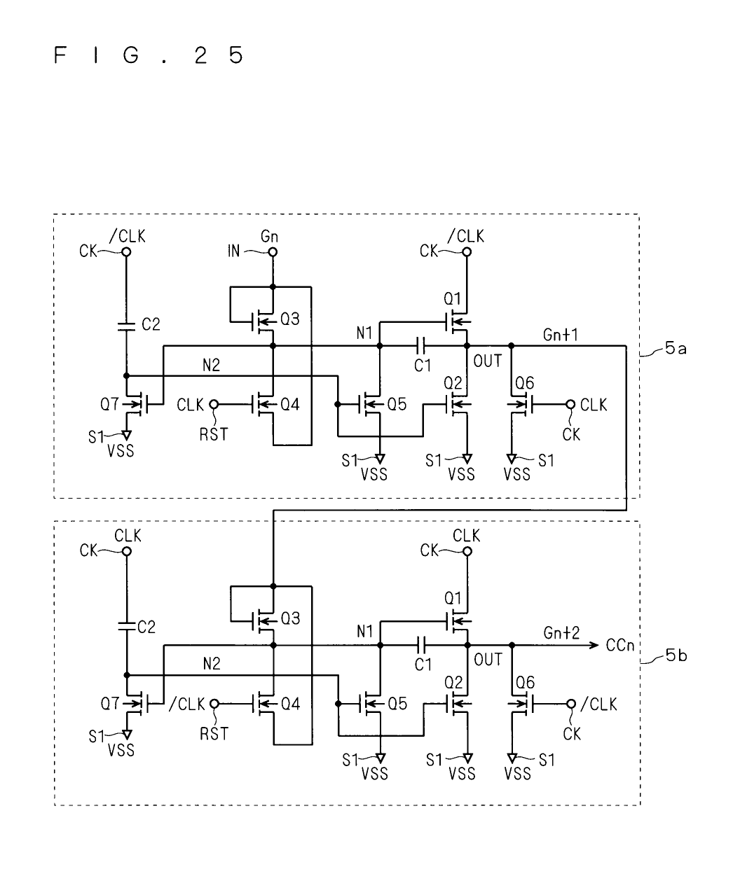

FIG. 24 shows a circuit diagram of a variant of the shift register 5 according to the present embodiment. The shift register 5 shown in FIG. 24 has reduced power consumption compared to the shift register 5 shown in FIG. 23. The shift register 5 shown in FIG. 24 has the gate input of the transistor Q4 of the pre-stage 5a as the output signal form the post-stage 5b instead of the clock signal CLK, so that the power consumption when charging/discharging the gate capacitance of the transistor Q4 is reduced.

The shift register 5 shown in FIGS. 23 and 24 described above generates a signal (Gn+2 signal) that rises after two horizontal periods (2h) from the rise of the Gn signal, by way of example, but may have a circuit configuration of only the pre-stage 5a if only the signal that rises after one horizontal period (1H) is necessary.

### Fifth Embodiment

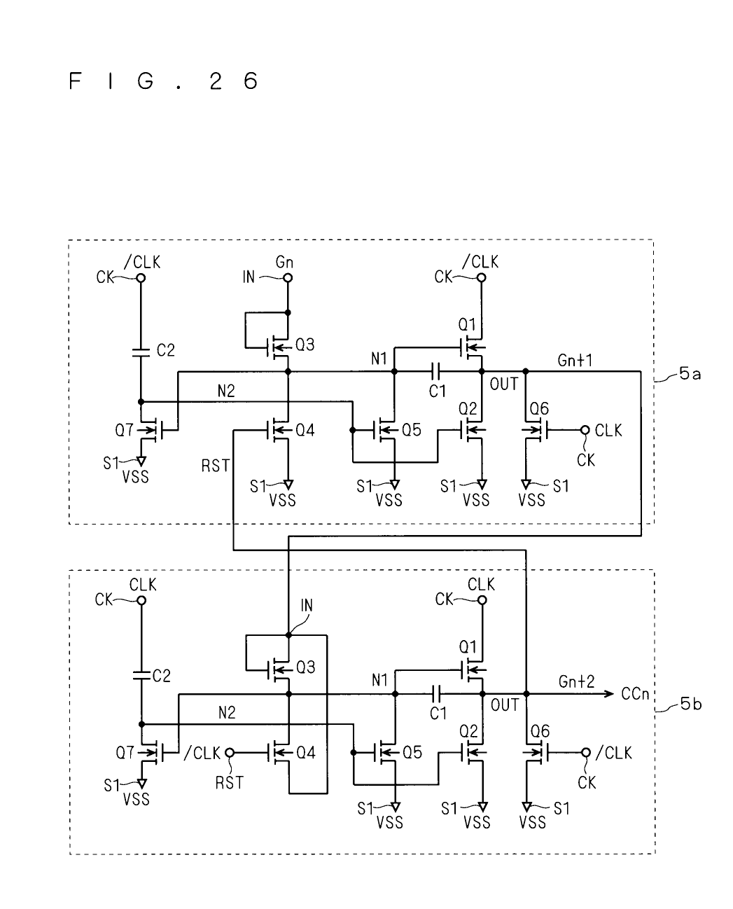

FIG. 25 shows a circuit diagram of the shift register 5 according to the present embodiment. The shift register 5 according to the present embodiment has a configuration particularly effective when using the amorphous TFT. The display device including the shift register 5 shown in FIG. 25 does not require the scanning direction switching circuit 4 as well as six gate line drive signals and two voltage signals V1, V2 as in the storage capacitance line drive circuit 90 shown in FIG. 20, and thus the layout design of the circuits and the signal lines is facilitated. In the image display device according to the present embodiment, configurations other than the shift register 5 shown in FIG. 25 are the same as the configurations of the image display device according to the fourth embodiment.

The shift register 5 shown in FIG. 25 is configured by two-stage unit shift registers of the pre-stage 5a and the post-stage 5b, similar to the shift register 5 shown in FIG. 23, and operates with two-phase clock signals complementary to each other having a cycle of two horizontal periods (2H).

The shift register 5 shown in FIG. 25 has an output that rises after two horizontal periods (2H) from the rise of the Gn signal, and outputs a pulse having a width of about one horizontal period (1H). The shift register 5 shown in FIG. 25 is configured such that DC bias application to each transistor is avoided, whereby shift of the threshold value Vth can be alleviated. The step-up capacitance element C1 shown in FIG. 25 is not an essential circuit element as it can be substituted with gate-channel capacitance of the transistor Q1.

In the pre-stage 5a shown in FIG. 25, the transistor Q3 is turned ON when the Gn signal becomes H level. At the same time, the clock signal CLK in-phase with the Gn signal is input to the gate of the transistor Q4, but the transistor Q4 is turned OFF since the Gn signal is input to the source of the transistor Q4. Therefore, the node N1 is charged to a potential of VDD-Vth, and the transistor Q7 is turned ON. The node N2 then becomes L level and the transistors Q5, Q2 are turned OFF. At the same time, the transistors Q1, Q6 are turned ON and the output node OUT becomes L level.

In the pre-stage 5a shown in FIG. 25, the transistor Q3 is turned OFF when the Gn signal becomes L level. However, the node N1 maintains H level. Therefore, the L level of the node N2 is also maintained, and the transistors Q5, Q2 are maintained in the OFF state.

In the pre-stage 5a shown in FIG. 25, when the clock signal /CLK becomes H level, the node N2 couples with the clock signal /CLK through the capacitance element C2. However, since the transistor Q7 is turned ON, the node N2 maintains L level, and the transistors Q5, Q2 maintain the OFF state. At the same time, the output node OUT becomes H level through the transistor Q1. The voltage change amount of the output node OUT couples with the node N1 through the step-up capacitance C1, the level of the node N1 steps up, the transistor Q1 operates in the unsaturated region, and the output node OUT becomes H level having the potential of the VDD.

In the pre-stage 5a shown in FIG. 25, when the clock signal /CLK becomes L level, the output node OUT becomes L level since the transistor Q1 is turned ON. The pre-stage 5a shown in FIG. 25 outputs the Gn+1 signal that is delayed by one horizontal period from the Gn signal.

In the pre-stage 5a shown in FIG. 25, when the clock signal CLK becomes H level, since the Gn signal has already been at L level, the transistor Q4 is turned ON, and the charges corresponding to the VDD-Vth remaining at the node N1 are discharged to L level. Thus, the pre-stage 5a shown in FIG. 25 prevents the output node OUT from becoming H level when the clock signal /CLK becomes H level at the next time.

In the pre-stage 5a shown in FIG. 25, when the clock signal /CLK becomes H level after the clock signal CLK becomes L level, the node N2 becomes H level by coupling through the capacitance element C2, thereby turning ON the transistors Q5, Q2. Thereafter, the pre-stage 5a shown in FIG. 25 alternately turns ON the transistors Q2, Q6 by the clock signals CLK, /CLK to have the output node OUT at L level of low impedance, thereby stabilizing the operation.

The post-stage 5b shown in FIG. 25 is the same circuit configuration as the pre-stage 5a, and the operation thereof is equivalent to the operation of the pre-stage 5a in which the phase of the clock signal CLK is delayed by one horizontal period (1H). Therefore, the Gn+2 signal of the output signal of the post-stage 5b is a signal delayed by one horizontal period (1H) from the Gn+1 signal of the output signal of the pre-stage 5a shown in FIG. 25, and is a signal delayed by two horizontal periods (2H) from the Gn signal of the input signal of the pre-stage 5a.

In the above operation, the shift register 5 shown in FIG. 25 has the gates of all the transistors applied with an AC bias, and the DC bias is not applied, whereby the shift of the threshold value Vth can be alleviated.

### Variant

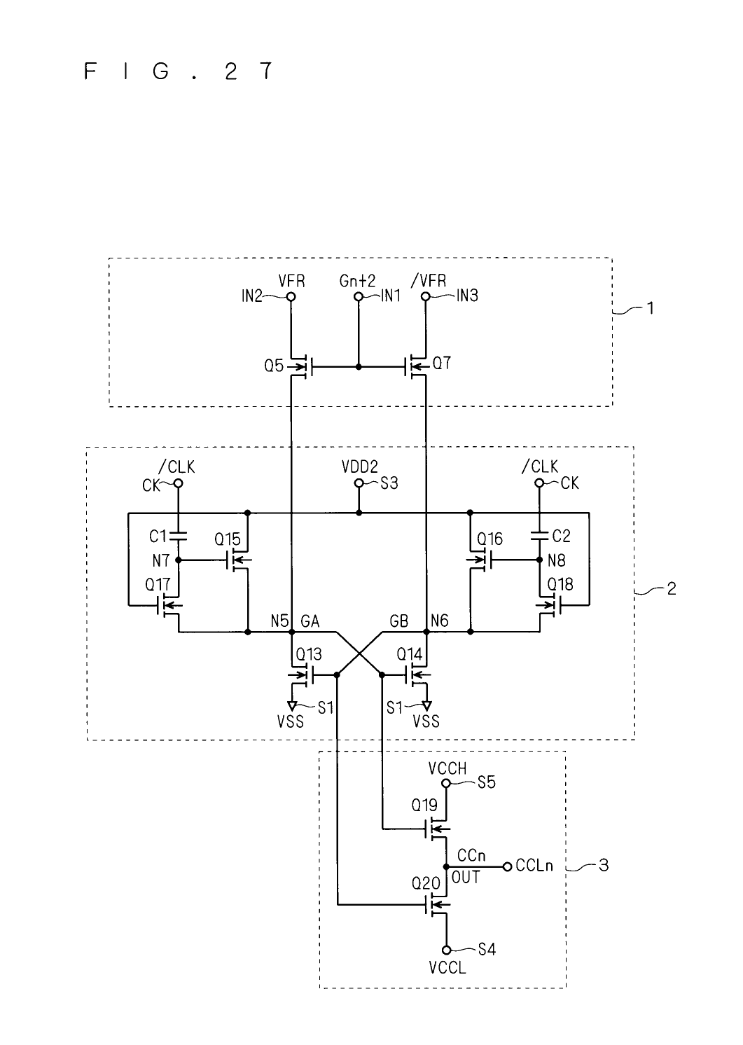

FIG. 26 shows a circuit diagram of a variant of the shift register 5 according to the present embodiment. The shift register 5 shown in FIG. 26 has reduced power consumption compared to the shift register 5 shown in FIG. 25. The shift register 5 shown in FIG. 26 has the gate input of the transistor Q4 of the pre-stage 5a as the output signal form the post-stage 5b instead of the clock signal CLK, so that the power consumption when charging/discharging the gate capacitance of the transistor Q4 is reduced.

The shift register 5 shown in FIGS. 25 and 26 described above generates a signal (Gn+2 signal) that rises after two horizontal periods (2h) from the rise of the Gn signal, by way of example, but may have a circuit configuration of only the pre-stage 5a if only the signal that rises after one horizontal period (1H) is necessary.

### Sixth Embodiment

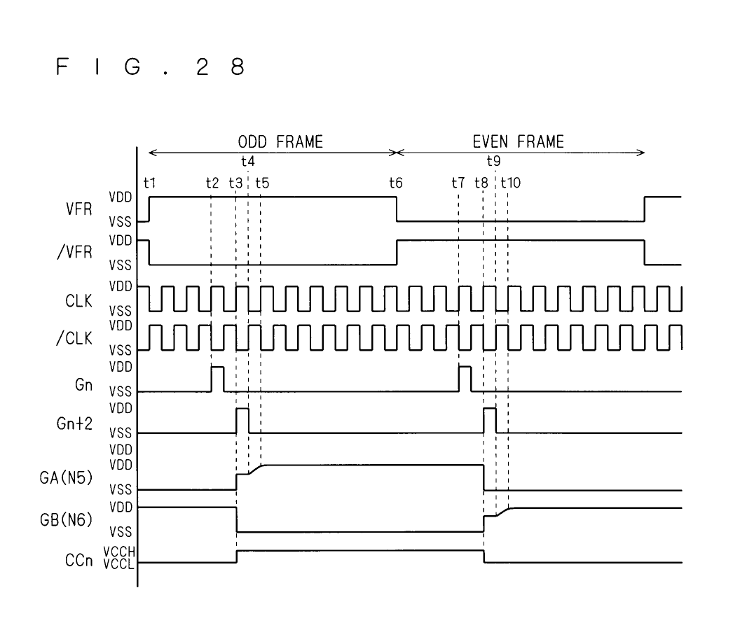

FIG. 27 is a circuit diagram of a storage capacitance line drive circuit of the image display device according to the present embodiment. The storage capacitance line drive circuit shown in FIG. 27 has the same function as the storage capacitance line drive circuit shown in FIG. 4, but differs in being configured with less number of transistors. As shown in FIG. 27, the storage capacitance line drive circuit according to the present embodiment has an effect in that an occupying area of the circuit can be reduced.

Similar to FIG. 4, the storage capacitance line drive circuit 90 shown in FIG. 27 includes the output level switching circuit 1, the output level holding circuit 2, and the output circuit 3. The output level switching circuit 1 determines pull-up and pull-down of the output signal. The output level switching circuit 1 shown in FIG. 27 includes a transistor Q5 having the terminal IN1 connected to the gate and the terminal IN2 connected to the source, and a transistor Q7 having the terminal IN1 connected to the gate and the terminal IN3 connected to the source. The gate line drive signal Gn+2 or the input signal is input to the terminal IN1, the VFR signal is input to the terminal IN2, and the /VFR signal is input to the terminal IN3. The switching signal GA is output from the drain of the transistor Q5, and the switching signal GB is output from the drain of the transistor Q7.

The output level holding circuit 2 provides a driving ability to the output signal of the output level switching circuit 1, and holds the relevant output level for one frame. The output level holding circuit 2 shown in FIG. 27 includes a transistor Q15 and a transistor Q16 connected in series between the terminal S1 connected to the reference potential VSS and the terminal S3 connected to the high potential power supply VDD2, and a transistor Q17 and a transistor Q18 having the high potential power supply VDD2 connected to the gate. The switching signal GA or the output of the output level switching circuit 1 is input to the node N5, and the switching signal GB or the output of the output level switching circuit 1 is input to the node N6.

A node N7, which is a common connection node of the gate of the transistor Q15 and the drain of the transistor Q17, is connected to a terminal CK to be input with the clock signal /CLK through the capacitance element C1. A node N8, which is a common connection node between the gate of the transistor Q16 and the drain of the transistor Q18, is connected to the terminal CK to be input with the clock signal /CLK through the capacitance element C2.

The output circuit 3 outputs the compensation signal CCn having a higher driving ability in response to the output of the output level holding circuit 2. The output circuit 3 shown in FIG. 27 includes transistors Q19, Q20 connected in series between the terminal S4 connected to the power supply VCCL and the terminal S5 connected to the power supply VCCH. The output signal GA or the output of the node N5 is input to the gate of the transistor Q19, and the output signal GB or the output of the node N6 is input to the gate of the transistor Q20. The compensation signal CCn is output to the storage capacitance lines CCLn from the output node OUT or the common connection node of the transistor Q19 and the transistor Q20.

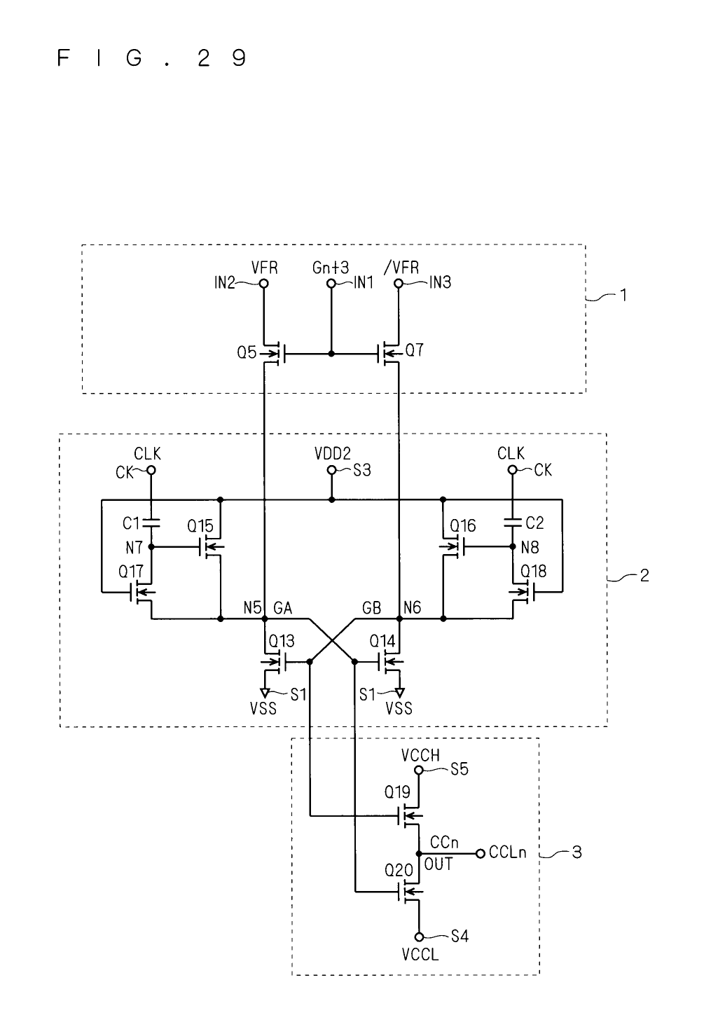

FIG. 28 shows an operation waveform chart of the storage capacitance line drive circuit according to the present embodiment. In the operation waveform shown in FIG. 28, the VFR signal and the /VFR signal are signals complementary to each other, and the level thereof alternates for every one frame in the blanking period of the image display device. In the operation waveform shown in FIG. 28, the period in which the VFR signal is H level is defined as odd frame, and the period in which the VFR signal is L level is defined as even frame.

In the operation waveform shown in FIG. 28, the clock signals CLK, /CLK are repeating signals that alternate at a constant period. The clock signal used to generate the gate line drive signal Gn in the gate line drive circuit 30 may be used for the clock signals CLK, /CLK. The clock signal used in the gate line drive circuit 30 is used for the clock signals CLK, /CLK shown in FIG. 28.

The input signal of the storage capacitance line drive circuit shown in FIG. 27 is the gate line drive signal Gn+2 after two rows from the gate line drive signal Gn corresponding to the compensation signal CCn. In the present embodiment, the gate line drive signal Gn+2 provided to the gate line GLn+2 that can be easily obtained is directly used as the input signal of the storage capacitance line drive circuit, but the signal is not limited to the gate line drive signal Gn+2 as long as the signal has the same timing and a predetermined voltage level.

The operation of the storage capacitance line drive circuit shown in FIG. 27 will now be described with reference to the operation waveform of FIG. 28. First, at time t1, when the levels of the VFR signal, /VFR signal respectively change, the input terminal IN2 is set to the voltage level of the VDD, and the input terminal IN3 is set to the voltage level of the VSS, respectively. The voltage levels of the node N5 to the node N8, and the output node OUT are determined by the operation of the previous frame, wherein the nodes N5, N7 and the output node OUT are the voltage level of VSS (hereinafter also referred to as L level), and the nodes N6, N8 are the voltage level of VDD (hereinafter also referred to as H level) herein.

At time t2, the gate line drive signal Gn becomes H level, and then becomes L level after one horizontal period (1H). At time t3, when the gate line drive signal Gn+2 becomes H level, the transistors Q5, Q7 are turned ON. First, the switching signal GB becomes L level, and the transistors Q13, Q20 are turned OFF. At substantially the same time, the switching signal GA becomes H level, and the transistors Q14, Q19 are turned ON. In response thereto, the node N8 becomes L level and the node N7 becomes H level. The output node OUT is at the level of the power supply VCCH since the voltage for the transistor Q19 operating in the unsaturated operation is supplied to the gate of the transistor Q19.

At time t4, when the Gn+2 signal becomes L level, the transistors Q5, Q7 are turned OFF, and the nodes N5, N6 and the input terminals IN2, IN3 are electrically separated, respectively. That is, the VFR signal, /VFR signal input to the input terminals IN2, IN3 are latched to the nodes N5, N6, respectively at time t4 that the gate line drive signal Gn+2 falls. Thus, the VFR signal, /VFR signal do not necessarily need to maintain the state of H level or L level for one frame. That is, the VFR signal, /VFR signal merely need to be set at a predetermined level when the gate line drive signal Gn+2 becomes L level. The power consumption increases as the voltage level of the VFR signal, /VFR signal alternates.

The clock signal /CLK becomes H level at time t4. The VDD that becomes the voltage change amount of the clock signal /CLK couples to the node N7 through the capacitance element C1. The node N7 has already been charged to the voltage level of VDD-Vth through the transistor Q17 from the node N5, and thus the voltage level is further stepped up to about 2·VDD-Vth. When the node N7 is further stepped up, the transistor Q15 is turned ON in the unsaturated region, and the node N5 is charged up to the voltage level of VDD by the high potential power supply VDD2.

In the circuit configured by the transistors Q16, Q18 and the capacitance element C2, the node N8 is at L level since the node N6 is at L level. When the clock signal /CLK rises, the voltage level of the node N8 coupled through the capacitance element C2 rises. However, since the transistor Q14 is turned ON, the voltage levels of the nodes N6, N8 instantaneously lowers to L level after rising at a constant level. That is, the spike-shaped voltage is generated at the nodes N6, N8. The spike voltage can be reduced by appropriately setting the on-resistance value of the transistor Q14 and the transistor Q18, and the capacitance value of the capacitance element C2, and the OFF state of the transistor Q16 can be maintained. That is, the node N6 is maintained at L level, and at the same time, the pass-through current barely flows between the power supply VDD2 and the VSS through the transistor Q16 and the transistor 14, and the power is barely consumed.

Therefore, in the storage capacitance line drive circuit according to the present embodiment, a selective pull-up operation in which only the H level side is pulled up and the L level side is not pulled up is carried out on the output without barely consuming power.

When the clock signal /CLK becomes L level at time t5, the voltage level of the node N7 again becomes VDD-Vth and the node N5 becomes VDD level of high impedance state.

Thereafter, the node N7 is stepped up to about 2·VDD-Vth every time when the clock signal /CLK changes to H level, and accordingly, the transistor Q15 is turned ON and the node N5 is charged to the voltage level of VDD by the high potential power supply VDD2, thereby compensating the lowering in the level of the node N5 by the leakage current. As a result, the output node OUT can maintain the H level of low impedance for one period. Furthermore, during this period, the pass-through current barely flows between the high potential power supply VDD2 and the low potential power supply VSS, and low power consumption state can be maintained.

A case of using the clock signal used in the gate line drive circuit for the clock signal for holding the H level of the switching signal GA (GB) has been described, but a clock signal having lower frequency may be used to reduce power consumption as long as lowering in the voltage level by the leakage current can be compensated.

At time t6, the VFR signal and the /VFR signal respectively change to L level and H level, but the voltage levels of the nodes N5, N6 and the output node OUT are maintained since the OFF state of the transistors Q5, Q7 is maintained.

After the gate line drive signal Gn becomes H level at time t7, the gate line drive signal Gn+2 becomes H level at time t8, the transistors Q5, Q7 are turned ON, and the operation opposite to that at time t2 is performed in the output level switching circuit 1. That is, the switching signal GA becomes L level, the switching signal GB becomes H level, and according thereto, the output node OUT becomes the voltage level of the power supply VCCL.

At times t8, t9, operation same as when the voltage levels of the nodes N5, N6 and the output node OUT are inverted at times t3, t4 is performed. After time t9, the voltage level of VDD at the node N6 is held by the clock signal /CLK, and according thereto, the node N5 and the output node OUT maintain the L level of low impedance for one frame.

### Variant

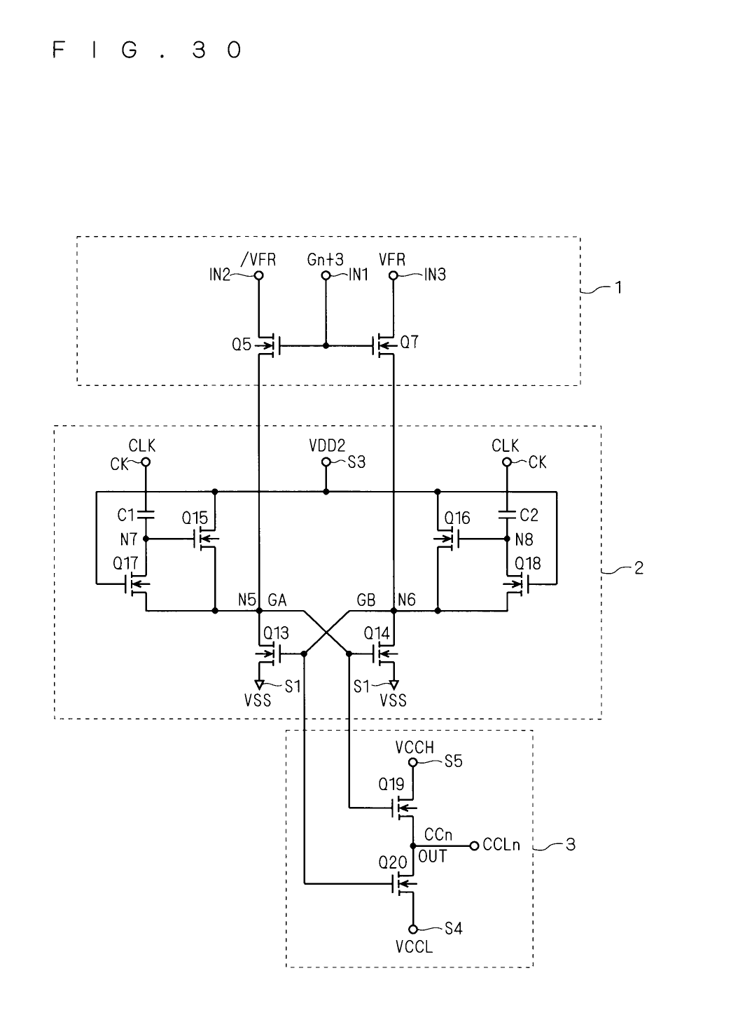

The storage capacitance line drive circuit shown in FIG. 27 described above relates to a circuit for generating the compensation signal corresponding to odd rows. In the present variant, a circuit for generating the compensation signal corresponding to the even row is shown in FIGS. 29 and 30. Similar to the circuit shown in FIG. 27 corresponding to the odd row, the gate line drive signal after two rows from the corresponding gate line is input as the input signal in the circuit shown in FIGS. 29 and 30. Assuming the corresponding even row as GLn+1, the gate line drive signal Gn+3 is input as an input of a circuit for generating the compensation signal. A clock signal CLK which active period does not overlap with the gate line drive signal Gn+3 is input to the clock terminal CK.

The circuit configuration shown in FIGS. 29 and 30 is basically the same as the circuit shown in FIG. 27 corresponding to the odd row, but in the circuit shown in FIG. 29, the input to the gates of the transistors Q19, Q20 of the output circuit 3 are interchanged with each other to obtain an inverted output with respect to the circuit shown in FIG. 27.

In the circuit shown in FIG. 30, the VFR signal and the /VFR signal input to the input terminals IN2, IN3 are interchanged with each other to obtain an inverted output with respect to the circuit shown in FIG. 27. In the circuit shown in FIGS. 29 and 30, the compensation signal falls at the odd frame (when VFR signal is H level) and rises at the even frame (when VFR signal is L level), opposite to the case of the odd rows.

A circuit corresponding to the odd row (FIG. 27 in the sixth embodiment) will be representatively described for the storage capacitance line drive circuit according to the embodiment described below to simplify the explanation. Even in this case, a storage capacitance line drive circuit corresponding to the even row is similarly obtained by applying changes used in the circuit configuration shown in FIGS. 29 and 30.

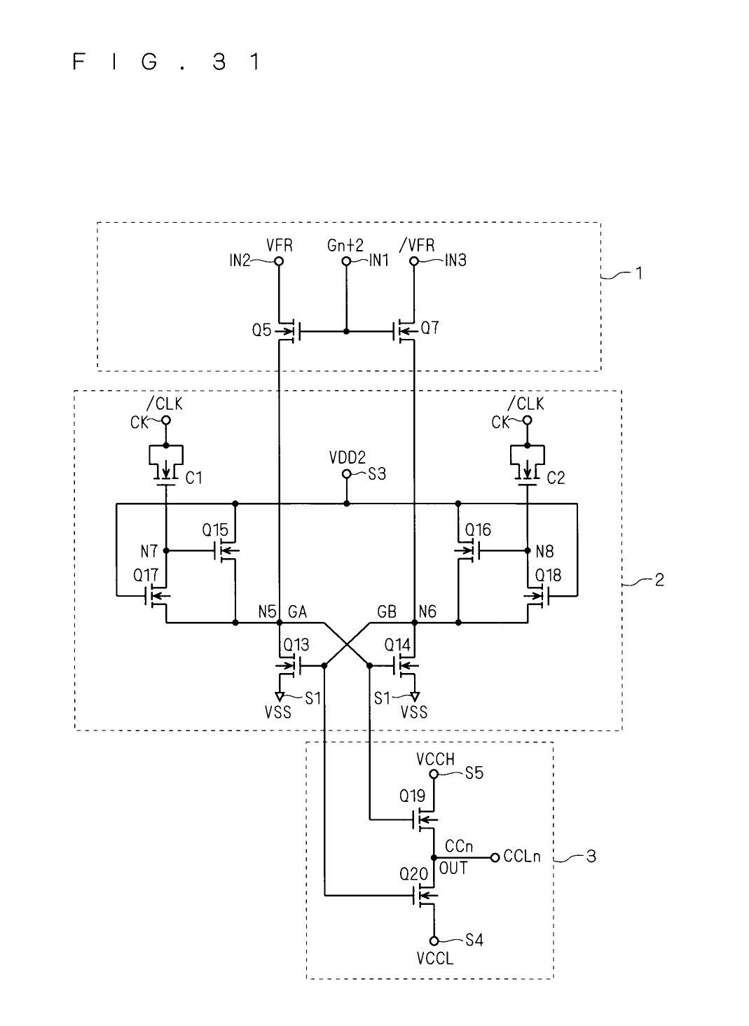

FIG. 31 shows another variant of the storage capacitance line drive circuit according to the present embodiment. The circuit shown in FIG. 31 differs from the circuit shown in FIG. 27 in that MOS capacitance element is used for the step-up capacitance elements C1, C2 of the output level holding circuit 2. The MOS capacitance element is formed with a channel if the voltage between the gate and the source/drain is greater than or equal to the threshold voltage Vth, and is formed with capacitance.

In the circuit shown in FIG. 31, the gate terminal of the MOS capacitance is connected to the nodes N7, N8, and the source/drain terminal is connected to the clock terminal CK. Thus, when the voltage levels of the switching signals GA, GB are H level, the voltage between the gate and the source/drain becomes greater than or equal to Vth, and the capacitance is formed, whereby the H level of the switching signals GA, GB is pulled up.

When the voltage levels of the switching signals GA, GB are L level, the voltage between the gate and the source/drain becomes lower than or equal to Vth and the capacitance is not formed, whereby the capacitance does not exist in appearance, and the spike voltage generated at the output node OUT in time of rise of the clock signal /CLK can be eliminated. In this case, the AC power by the clock signal consumed on the L level output side is reduced.

The capacitance elements C1, C2 can be changed to MOS capacitance elements for the storage capacitance line drive circuit according to the embodiment described below.

### Seventh Embodiment

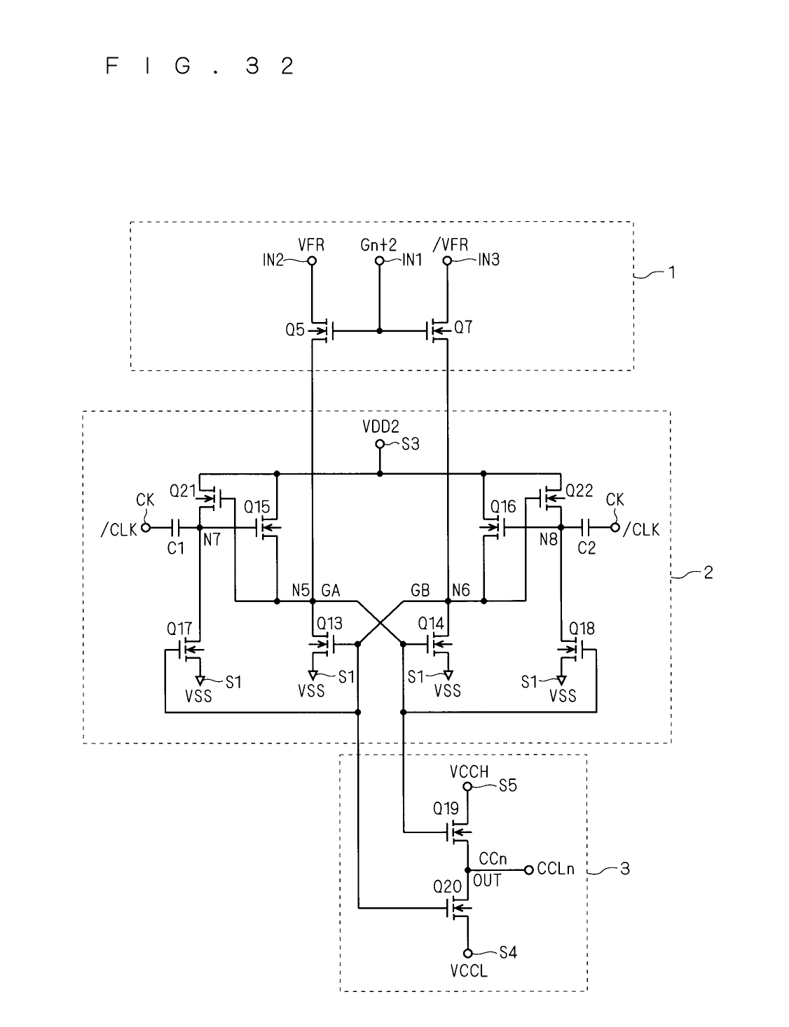

FIG. 32 is a circuit diagram of the storage capacitance line drive circuit according to the present embodiment. The circuit shown in FIG. 32 is a circuit in which the step-up capacitance elements C1, C2 and the nodes N5, N6 are not directly coupled so that rise of the output level by the clock signal is prevented at the time of refresh, unlike the circuit shown in FIG. 27. Specifically, the circuit shown in FIG. 32 differs from the circuit shown in FIG. 27 in that the output signal of the inverter including the transistors Q21, Q17 (Q22, Q18) is input to the gate of the transistor Q15 (Q16).

In the circuit shown in FIG. 32, when the node N5 becomes L level and the node N6 becomes H level, the clock signal /CLK through the step-up capacitance element C1 is discharged to the terminal S1 by the transistor Q17 turned ON by the H level of the node N6, and does not directly influence the node N5. The node N8 is initially charged to VDD-2·Vth since the node N6 is at H level, but thereafter, stepped up to about 2·VDD-2·Vth by the clock signal /CLK through the capacitance element C2. Accordingly, the transistor Q16 is turned ON in the unsaturated region, and the voltage level of the node N6 is pulled up, and at the same time, voltage level of the node N6 rises to VDD.

After the voltage level of the node N6 becomes VDD level, the clock signal /CLK becomes L level, and the voltage level of the node N8 again lowers towards the initial VDD-2·Vth. The voltage level of the node N8 is pulled up to the VDD-Vth level through the transistor Q22 by the voltage level (VDD) of the node N6.

Thereafter, the level of the node N8 lowers by the off leakage current of the transistor Q18, but when the clock signal /CLK becomes L level and the voltage level of the node N8 become lower than or equal to VDD-Vth, the level refreshes to the VDD-Vth level through the transistor Q22.

### Variant

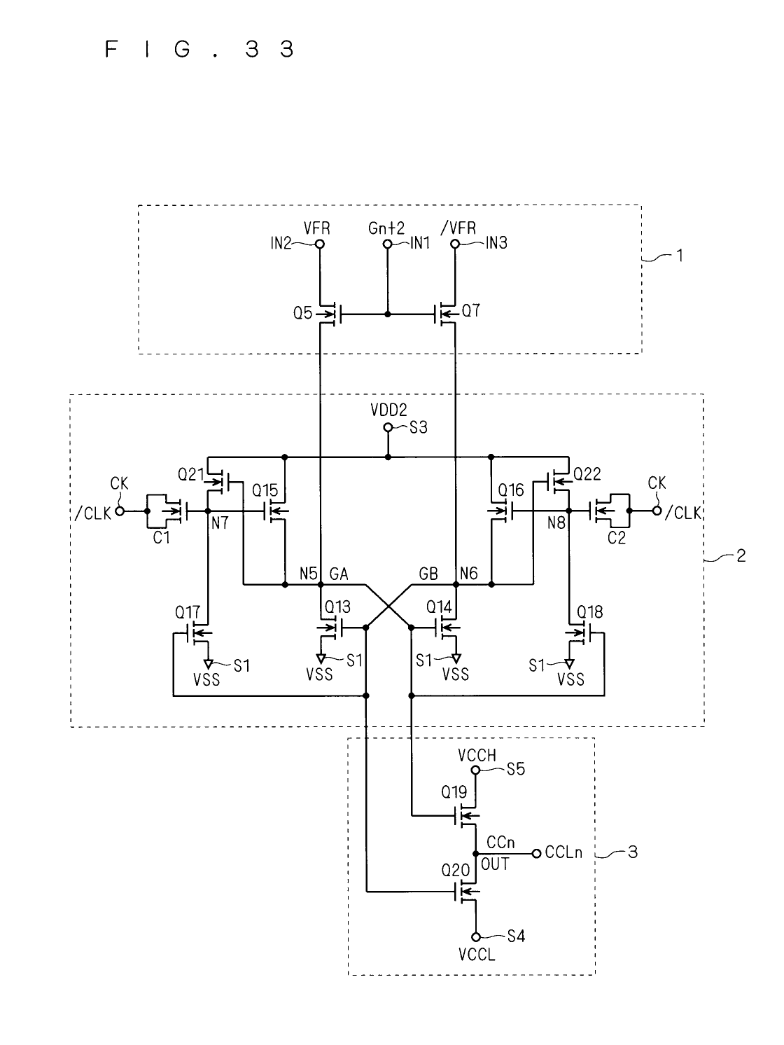

FIG. 33 shows a circuit diagram of the storage capacitance line drive circuit of a variant according to the present embodiment. The circuit shown in FIG. 33 has a configuration in which the MOS capacitance element is adopted for the step-up capacitance elements C1, C2 of the circuit shown in FIG. 32. The MOS capacitance element shown in FIG. 33 has the gate terminal connected to the nodes N7, N8 and the source/drain terminal connected to the clock terminal CK.

When the transistor Q15 or the transistor Q16 is turned OFF, the spike voltage is less likely to generate at the gate, and thus the pass-through current can be reduced and power consumption can be reduced. At the same time, invalid current by the clock signal /CLK flowing through the transistor Q17 or the transistor Q18 can also be reduced.

### Eight Embodiment

In the present embodiment, a case in which an image display device adopting the storage capacitance line drive circuit shown in FIG. 27 includes a gate line drive circuit for scanning in two-ways will now be described.

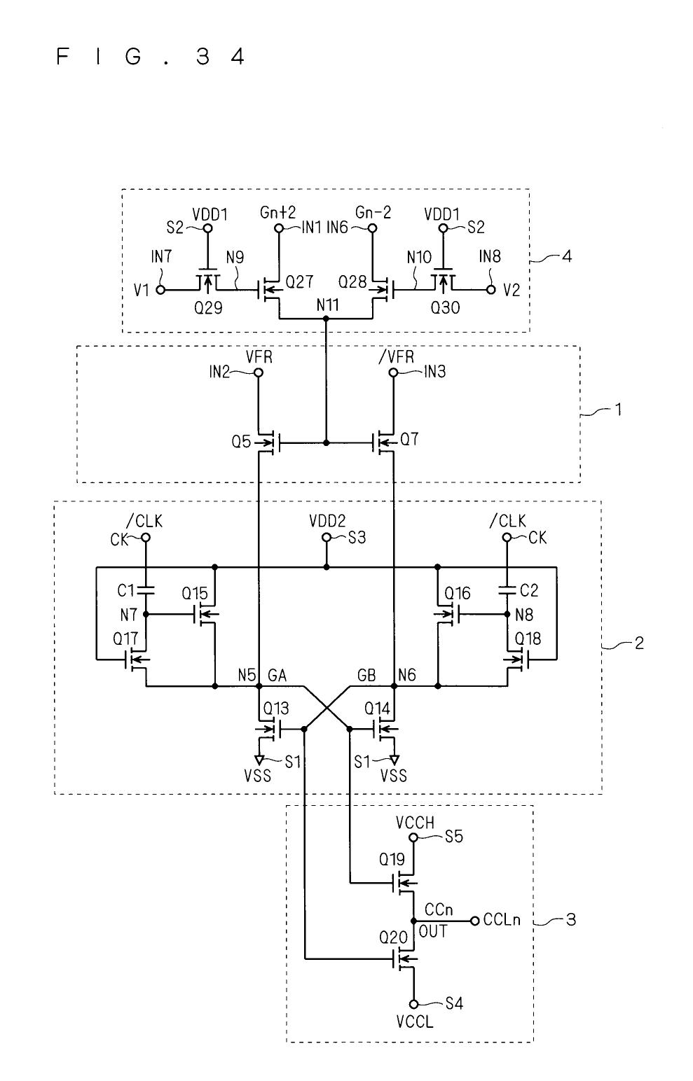

FIG. 34 shows a circuit diagram of the storage capacitance line drive circuit according to the present embodiment. In the circuit shown in FIG. 34, the scanning direction switching circuit 4 for responding to bidirectional scanning of the gate line drive circuit is arranged at the input part of the circuit shown in FIG. 27. That is, the circuit configured by the transistors Q27 to Q30 shown in FIG. 34 is the scanning direction switching circuit 4. The subscript of the gate line drive signals Gn+2 and Gn−2 takes forward scanning as a reference.

In the circuit shown in FIG. 34, if the voltage level of the high potential power supply VDD1 is VDD, the voltage signal V1 becomes H (VDD) level and charges the voltage level of the node N9 to VDD-Vth and thus the transistor Q27 is turned ON in the forward scanning. When the voltage signal V2 becomes L (VSS) level and the voltage level of the node N10 is discharged to VSS, the transistor Q28 is turned OFF. Thus, in the circuit shown in FIG. 34, the gate line drive signal Gn+2 is transmitted to the node N11 and the gate line drive signal Gn−2 is not transmitted in the above case.

When the gate line drive signal Gn+2 of L level changes to H level, the change in voltage level couples to the node N9 through the gate-channel capacitance of the transistor Q27, and the voltage level of the node N9 rises. As a result, the transistor Q27 operates in the unsaturated region, and the voltage level of the node N11 is output as the H level signal of VDD.

In the case of reveres scanning, the transistor Q28 is turned ON, and the gate line drive signal Gn−2 is input to the node N11, which acts the same as the gate line drive signal Gn+2 of the forward scanning. The configuration and the operation of other circuits are the same as the circuit shown in FIG. 27, and thus the detailed description thereof will be omitted. In the circuit shown in FIG. 34, the circuit configuration other than the scanning direction switching circuit 4 is the circuit shown in FIG. 27, but the present invention is not limited thereto, and the circuit shown in FIGS. 29 to 33 may be adopted instead of the circuit shown in FIG. 27. Furthermore, the circuit shown in FIG. 18 or FIG. 19 may be adopted for the circuit configuration of the scanning direction switching circuit 4.

### Ninth Embodiment

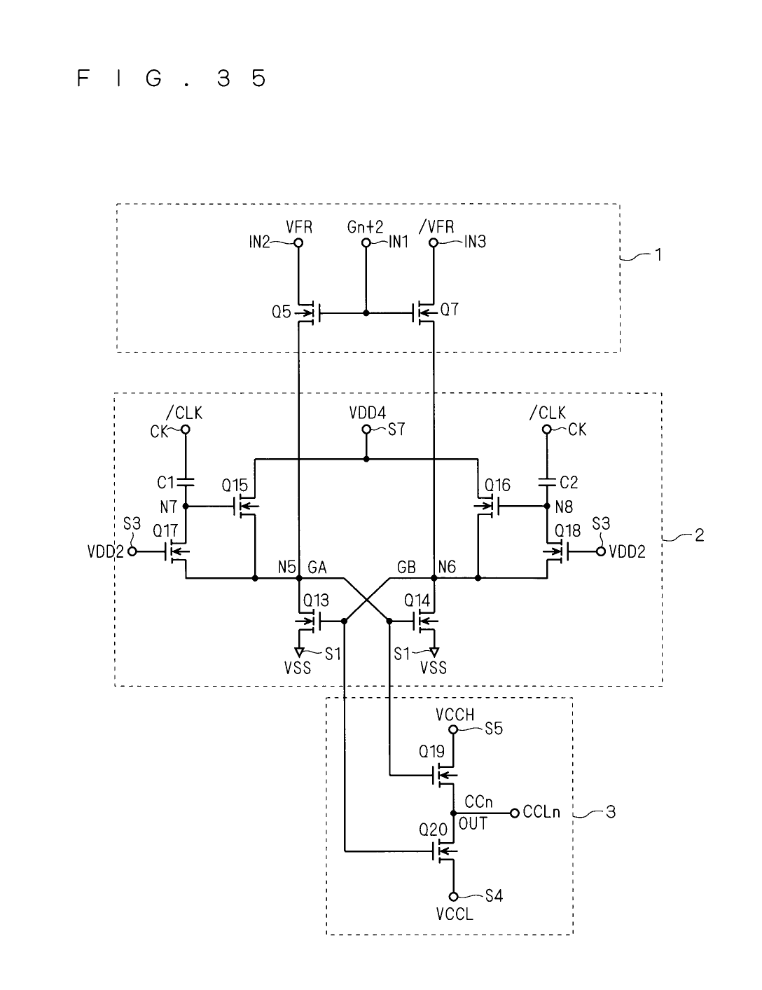

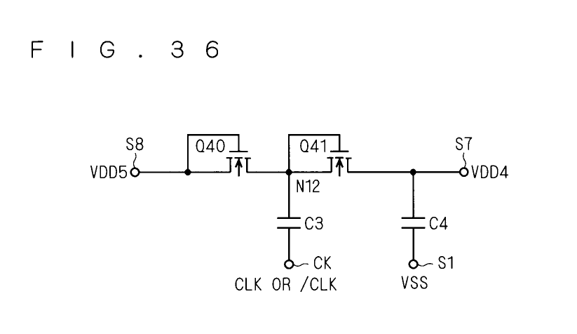

FIG. 35 shows a circuit diagram of the storage capacitance line drive circuit according to the present embodiment. In the circuit shown in FIG. 27, the voltage source VDD2 is supplied to the drain of the transistors Q15, Q16, but in the circuit shown in FIG. 35, the voltage source VDD4 is supplied in place of the voltage source VDD2. The voltage source VDD4 is a voltage source configured by a charge pump circuit as shown in FIG. 36, and has a voltage value of greater than or equal to VDD. The charge pump circuit shown in FIG. 36 has a configuration in which the transistors Q40, Q41 are diode connected, where the clock terminal CK is connected to the node N12 through the capacitance element C3, and the drain of the transistor Q41 is connected to the terminal S1 through the capacitance element C4. In the charge pump circuit shown in FIG. 36, if the voltage value of the voltage source VDD5 to be input to the terminal S8 is VDD, the voltage value of the voltage source VDD4 to be output becomes 2·VDD-2·Vth.

In the circuit shown in FIG. 35, when the node N7 is stepped up, the voltage level thereof ideally becomes 2 VDD-Vth, and thus the voltage level of the node N5 can be stepped up to 2·VDD-2·Vth. Therefore, in the circuit shown in FIG. 35, the H level of the node N5 can be made to 2·VDD-2·Vth by having the voltage level of the voltage source VDD4 as 2·VDD-2·Vth. This means that the gate voltage of the output transistor Q19 (Q20) is increased, whereby the on-resistance thereof can be lowered. That is, if set to the same resistance value, the dimension (gate width) thereof can be reduced, and the occupying area of the circuit can be reduced.

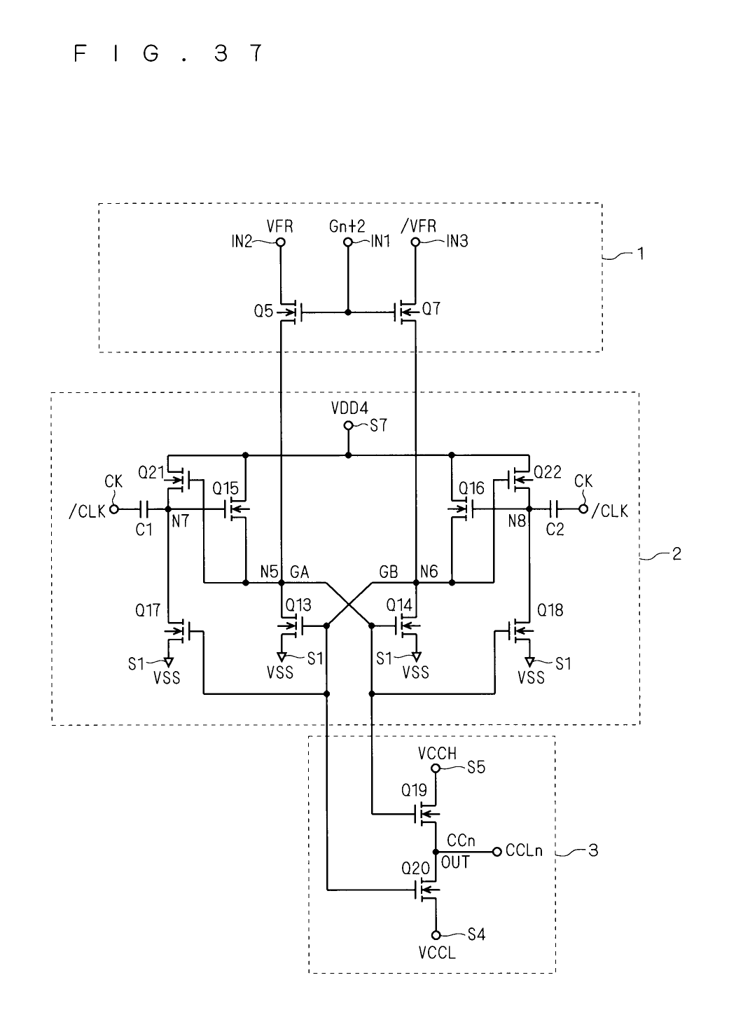

FIG. 37 shows another circuit diagram of the storage capacitance line drive circuit according to the present embodiment. In the circuit shown in FIG. 37, the voltage source VDD4 is supplied in place of the voltage source VDD2 in the circuit shown in FIG. 32. The voltage source VDD4 is a voltage source having a voltage value of 2·VDD-2·Vth generated in the charge pump circuit shown in FIG. 36.

In the circuit shown in FIG. 37, when the node N7 is stepped up, the voltage level of the node N7 rises from VDD-2·Vth to 2·VDD-2·Vth in the first step up. As a result, the voltage level of the node N5 becomes 2·VDD-3·Vth by the transistor Q15. When the clock signal /CLK becomes L level, the voltage level of the node N7 becomes 2·VDD-4·Vth by the voltage level of the relevant clock signal /CLK. When the clock signal /CLK again becomes H (VDD) level, the node N7 is stepped up, and the voltage level thereof becomes 3·VDD-4·Vth. As a result, the transistor Q15 operates in the unsaturated region, the voltage level of the node N5 becomes 2·VDD-2·Vth same as the voltage source VDD4, and the dimension of the transistor Q19 (Q20) can be reduced similar to the circuit shown in FIG. 35.

### Variant

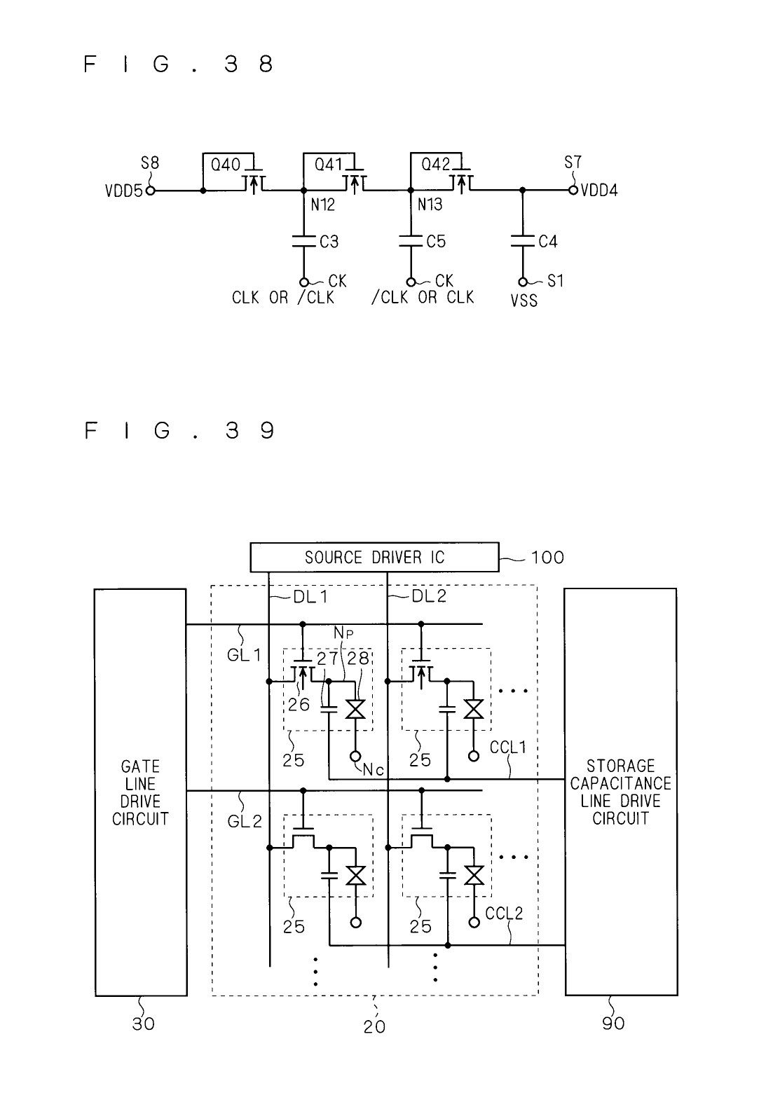

FIG. 38 shows a circuit diagram of a charge pump circuit of a variant according to the present embodiment. The circuit diagram shown in FIG. 38 is a charge pump circuit for generating voltage of 3·VDD-3·Vth. The charge pump circuit shown in FIG. 38 has a configuration in which the transistors Q40, Q41, Q42 are diode connected, wherein the clock terminal CK is connected to the node N12 through the capacitance C3 and the clock terminal CK is connected to the node N13 through the capacitance element C5, and the drain of the transistor Q42 is connected to the terminal S1 through the capacitance element C4. In the charge pump circuit shown in FIG. 38, if the voltage value of the power source VDD5 to be input to the terminal S8 is VDD, the voltage value of the voltage source VDD4 to be output becomes 3·VDD-3·Vth.

When adopting the charge pump circuit shown in FIG. 38 in the voltage source VDD4 shown in FIG. 37 and supplying the voltage of 3·VDD-3·Vth, since the voltage level of the node N7 is 3·VDD-4·Vth, the voltage level of the node N5 rises up to 3·VDD-5·Vth. Therefore, in the circuit diagram shown in FIG. 37, the dimension of the transistor Q19 (Q20) can be further reduced.

In the charge pump circuit shown in FIGS. 36 and 38, the diode connected transistors Q40, Q41, Q42 and the capacitance elements C3, C4, C5 are assumed to be simultaneously formed on the same substrate as the storage capacitance line drive circuit, but the present invention is not limited thereto, and the charge pump circuit shown in FIGS. 36 and 38 may be configured using discrete diode element and capacitance element, for example, on the outer side of the substrate.

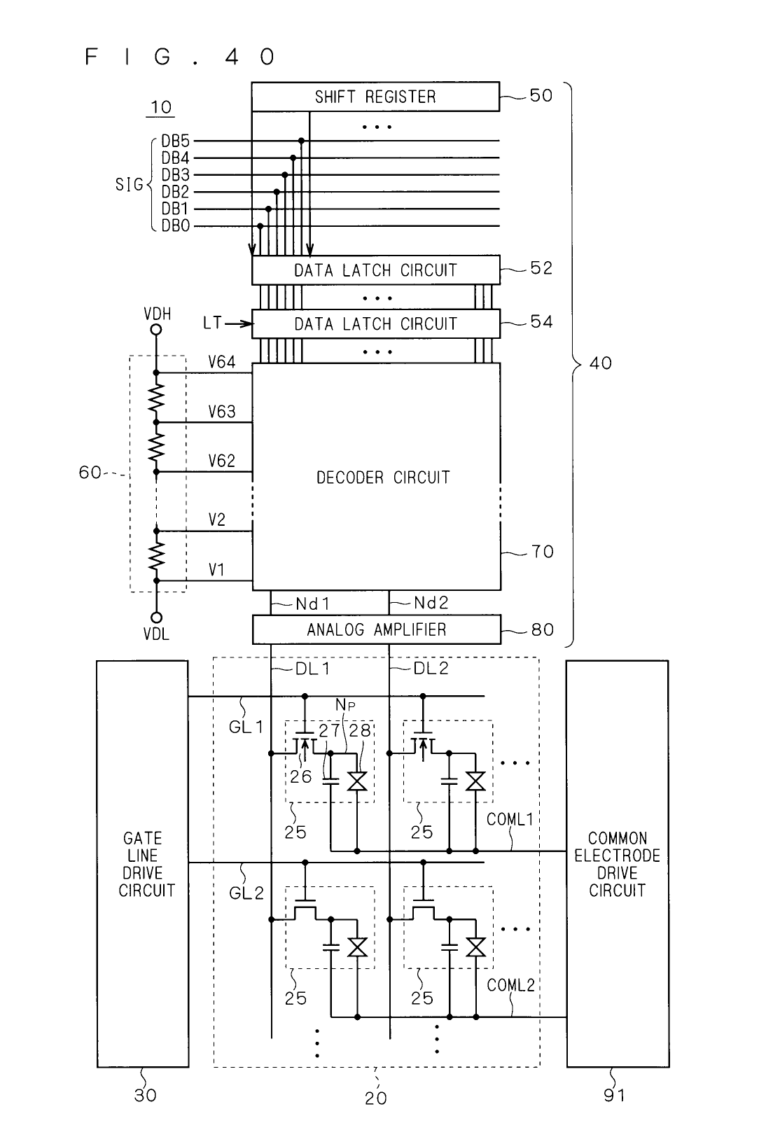

In the description from the first embodiment to the ninth embodiment, an example of capacitance coupling and driving two compensation signals to the pixel electrode alternately for every column with respect to all the pixels connected to the scanning line of one row has been described. However, the image display device according to the present invention is not limited thereto, and if the image quality of the display device is not given great weight, a configuration of capacitance coupling and driving one compensation signal without distinguishing for every column with respect to all the pixels connected to the scanning line of one row as in the image display device shown in FIG. 39 may be adopted.

In the image display device shown in FIG. 39, since the scanning line and the storage capacitance line do not intersect, the layout design of the pixels is facilitated. The configuration shown in FIG. 39 may be applied to the configuration of the image display device shown in FIGS. 1 to 3.

Furthermore, in the description from the first embodiment to the ninth embodiment, an example in which the output of the storage capacitance line drive circuit inverts between the odd row and the even row has been described, but the present invention is not limited thereto, and a configuration in which the output is inverted for every frame without inverting the output between the odd row and the even row may be adopted. In the configuration of inverting the output for every frame, the same storage capacitance line drive circuit is used for the odd row and for the even row.

### Tenth Embodiment

The image display device up to the ninth embodiment mainly includes common electrode common to the entire screen and a storage capacitance line CCL for every line, and the storage capacitance line drive circuit 90 performs capacitance coupling drive of driving the storage capacitance element 27 through the storage capacitance line CCL. The image display device according to the present invention, however, is not limited thereto, and may be an image display device including a common electrode independent for every line and adopting a line independent common drive manner in which a common electrode drive circuit drives the common electrode in place of the storage capacitance line drive circuit. The image display device adopting the line independent common drive manner will be described in the following embodiments.

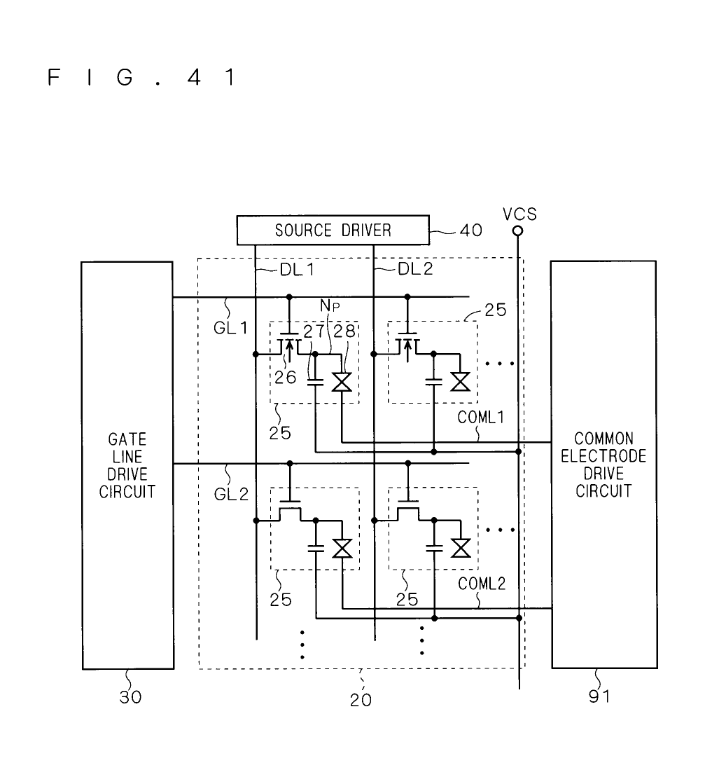

FIG. 40 shows a block diagram of the image display device according to a tenth embodiment. In the block diagram shown in FIG. 40, a configuration of the liquid crystal display device 10 is shown as a representative example of the image display device according to the present invention. The image display device according to the present invention is not limited to the liquid crystal display device 10 shown in FIG. 40.

First, the liquid crystal display device 10 shown in FIG. 40 includes the liquid crystal array section 20, the gate line drive circuit (scanning line drive circuit) 30, and the source driver 40. Furthermore, in the liquid crystal display device 10 shown in FIG. 40, a common electrode drive circuit 91 hereinafter described in detail is arranged. In the liquid crystal display device 10 shown in FIG. 40, the common electrode drive circuit 91 is arranged on the right side of the liquid crystal array section 20, but the present invention is not limited thereto, and the common electrode drive circuit 91 may be arranged on the left side of the liquid crystal array section 20 if the gate line drive circuit 30 is formed on a substrate of the liquid crystal array section 20. The common electrode drive circuit 91 may commonly use the power supply lines and the signal lines used in the gate line drive circuit 30 to be integrated with the gate line drive circuit 30. In the integrated configuration, the common electrode drive circuit 91 may be arranged on both sides of the liquid crystal array section 20 when the resolution of the image display device becomes higher, the region of the pixel 25 to be hereinafter described becomes smaller, and the pitch of the common electrode drive circuit 91 becomes larger than the pitch of the pixel 25. In this case, the pixels of odd rows may be driven by an integrated circuit on the left side, and the pixels of even rows may be driven by an integrated circuit on the right side.

The liquid crystal array section 20 includes a plurality of pixels 25 arranged in a matrix form. Gate lines GL1, GL2, . . . (collectively referred to as gate lines GL) are arranged for every row of pixels (hereinafter also referred to as pixel line) in the liquid crystal array section 20. Furthermore, data lines DL1, DL2, . . . (also collectively referred to as data lines DL) are arranged for every column of pixels (hereinafter also referred to as pixel column) in the liquid crystal array section 20. In FIG. 40, the pixels 25 arranged on the first column and the second column of the first row and the second row, the gate lines GL1, GL2 and the data lines DL1, DL2 arranged in correspondence thereto, and the common electrode lines COML1, COML2, . . . (also collectively referred to as common electrode line COML) corresponding to the gate lines GL1, GL2 are representatively illustrated.

Each pixel 25 includes a pixel switch element 26 between the corresponding data line DL and a pixel electrode Np, a storage capacitance element 27 between the pixel electrode Np and the storage capacitance line COML, and a liquid crystal display element 28 between the pixel electrode Np and the common electrode line COML. The liquid crystal display element 28 changes the orientation of the sandwiched liquid crystal and changes the display luminance depending on the potential difference created between the pixel electrode Np and the common electrode line COML. The luminance of each pixel 25 thus can be controlled by a display voltage transmitted to the pixel electrode Np through the data lines DL and the pixel switch element 26. In other words, each pixel 25 can obtain an intermediate luminance by applying an intermediate voltage difference between a voltage difference corresponding to a maximum luminance and a voltage difference corresponding to a minimum luminance between the pixel electrode Np and the common electrode line COML. Therefore, the liquid crystal display device 10 shown in FIG. 40 is able to display a tone luminance by setting the display voltage in a step wise manner. The liquid crystal display element 28 acts as the electrical capacitance element between the pixel electrode Np and the common electrode line COML.

The gate line drive circuit 30 selects and drives the gate lines GL in order based on a predetermined scanning period. Each gate line GL is connected to the gate of the corresponding pixel switch element 26. While the gate line drive circuit 30 is selecting a specific gate line GL, the pixel connected to the relevant gate line GL has the pixel switch element 26 in a conductive state, and the pixel electrode Np and the corresponding data line DL are connected. Thus, a display voltage corresponding to the display signal is supplied to the pixel electrode Np via the data lines DL.

In the pixel electrode Np, the level of the supplied display voltage is held by the storage capacitance element 27. The pixel switch element 26 is generally configured by a TFT (Thin Film Transistor) formed on an insulative substrate (glass substrate, resin substrate, and the like) which is the same as the liquid crystal display element 28.

The common electrode line COML is arranged along the gate line GL, and connected to the common electrode of the liquid crystal display element 28 of each pixel 25 connected to the corresponding gate line GL. The common electrode drive circuit 91 supplies the voltage corresponding to the polarity of the display voltage written to the pixel electrode Np.

The source driver 40 outputs the display voltage set in a step wise manner by a display signal SIG or a digital signal of N bits to the data lines DL. If the display signal SIG is a signal of six bits, for example, the display signal SIG is constituted by display signal bits DB0 to DB5. Each pixel 25 can perform tone display of 2⁶=64 levels based on the display signal SIG of six bits. Furthermore, if the pixel 25 configures one display unit with three colors of R (Red), G (Green), and B (Blue), a color display of about 260 thousand colors can be carried out.

The source driver 40 shown in FIG. 40 includes a shift register 50, data latch circuits 52, 54, a tone voltage generation circuit 60, a decoder circuit 70, and an analog amplifier 80. The display signal SIG is constituted by serially generating the display signal bits DB0 to DB5 corresponding to the display luminance of the respective pixels 25. In other words, the display signal bits DB0 to DB5 at each timing indicate the display luminance at one of the pixels 25 in the liquid crystal array section 20.

The shift register 50 instructs the data latch circuit 52 to retrieve the display signal bits DB0 to DB5 at a timing synchronized with the period of switching the setting of the display signal SIG. The data latch circuit 52 sequentially retrieves the display signal SIG constituted by the display signal bits DB0 to DB5 generated in series, and holds the display signal SIG for one pixel line.

A latch signal LT is input to the data latch circuit 54. The latch signal LT is activated at a timing that the display signal SIG for one pixel line is retrieved by the data latch circuit 52. That is, the data latch circuit 54 retrieves the display signal SIG for one pixel line held in the data latch circuit 52 in response to the timing that the latch signal LT is activated.

The tone voltage generation circuit 60 is configured by sixty-three voltage dividing resistors connected in series between high voltage VDH and low voltage VDL. The tone voltage generation circuit 60 generates tone voltages V1 to V64 of sixty-four levels by using the sixty-three voltage dividing resistors.

The decoder circuit 70 decodes the display signal SIG held in the data latch circuit 54. The decoder circuit 70 selects the voltages to be output to each decode output node Nd1, Nd2, . . . (collectively referred to as decode output nodes Nd) based on the decode result from the tone voltages V1 to V64 generated in the tone voltage generation circuit 60.

As a result, the display voltage (one of the voltages of tone voltages V1 to V64) corresponding to the display signal SIG for one pixel line held in the data latch circuit 54 is simultaneously (in parallel) output from the decode output node Nd. In FIG. 40, the decode output nodes Nd1, Nd2 corresponding to the data lines DL1, DL2 of the first column and the second column are typically illustrated.

The analog amplifier 80 then amplifies each display voltage output from the decoder circuit 70 to the decode output node Nd to the corresponding analog voltage, and outputs the same to the data lines DL.

As described above, in the liquid crystal display device 10 according to the present embodiment, the source driver 40 outputs the display voltages corresponding to a series of display signals SIG to the data lines DL by one pixel line based on a predetermined scanning period, and the gate line drive circuit 30 sequentially drives the gate lines GL in synchronization with the relevant scanning period, thereby causing the liquid crystal array section 20 to display an image based on the display signal SIG.

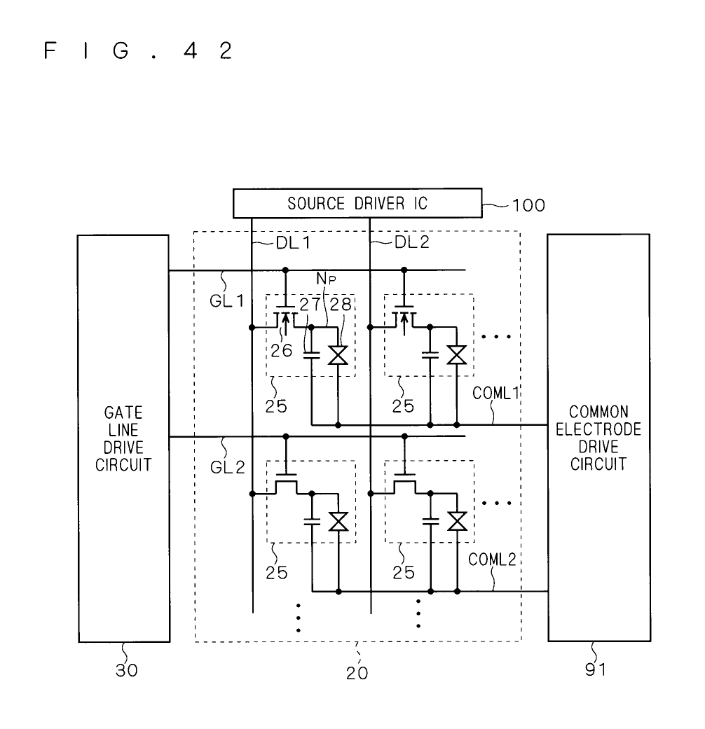

The configuration of the liquid crystal array section 20 is not limited to the configuration shown in FIG. 40, and a configuration of the liquid crystal array section 20 shown in FIG. 41 may be adopted. The liquid crystal array section 20 shown in FIG. 41 has a configuration of connecting one end of the storage capacitance element 27 to the power supply VCS having an arbitrary voltage level instead of the common electrode drive circuit 91. The power supply VCS merely needs to be a constant voltage source of low impedance as the storage capacitance element 27 merely needs to stabilize the potential at the pixel electrode Np in an alternating current manner. According to the configuration of the liquid crystal array section 20 shown in FIG. 41, the load of the common electrode drive circuit 91 can be reduced, the common electrode drive circuit 91 can be miniaturized, and the power consumption can be reduced.

In the liquid crystal display device 10 shown in FIG. 40, the common electrode drive circuit 91, the gate line drive circuit 30, and the source driver 40 are formed with the liquid crystal array section 20 integrated on the same insulator substrate. However, the present invention is not limited thereto, and the gate line drive circuit 30 and the source driver 40 may be arranged as external circuits of the liquid crystal array section 20.

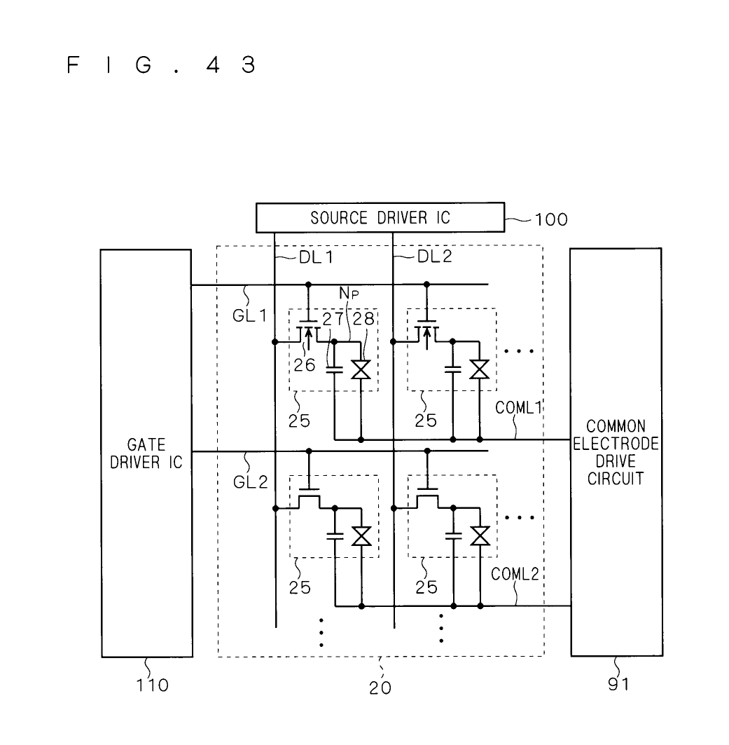

FIG. 42 shows a configuration of arranging a source driver IC 100 of a semiconductor integrated circuit formed on a single crystal silicon substrate as an external circuit in place of the source driver 40, and forming the gate line drive circuit 30, the common electrode drive circuit 91, and the liquid crystal array section 20 on the same insulator substrate 11.

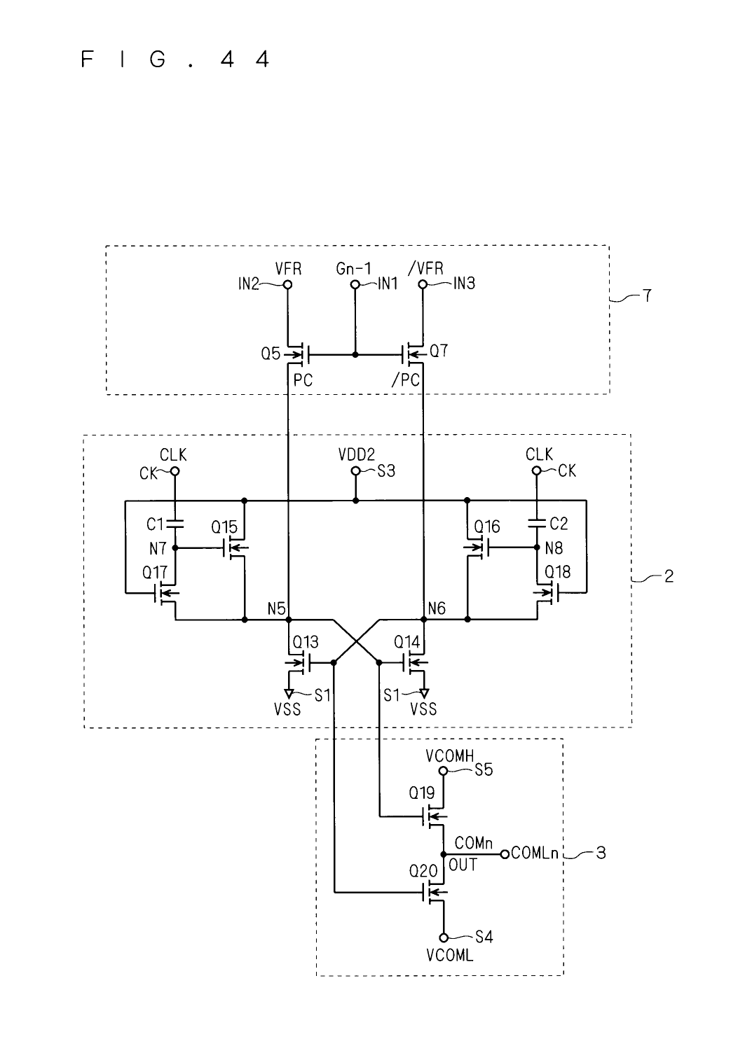

FIG. 43 shows a configuration of arranging the source driver IC 100 and a gate driver IC 110 of a semiconductor integrated circuit as external circuits in place of the source driver 40 and the gate line driver circuit 30, and forming the common electrode drive circuit 91 and the liquid crystal array section 20 on the same insulator substrate 11.

The method of scanning the gate lines generally includes a method of scanning in one direction of either from the top to the bottom or from the bottom to the top in FIG. 40, and a method of scanning by switching the directions depending on usage conditions. Both methods of scanning the gate lines can be applied to the image display device according to the present invention, but a case of using the method of scanning in a single direction will be described first in the image display device according to the present embodiment described below.

The description of the image display device according to the present embodiment will be made below, but as shown in Japanese Laid-Open Patent Publication No. 10-31464, gate line inversion drive and frame inversion drive can be carried out in the line independent common drive manner. Both drives can be applied on the image display device according to the present invention, but an image display device applied with the gate line inversion drive will be described for the sake of simplifying the explanation.

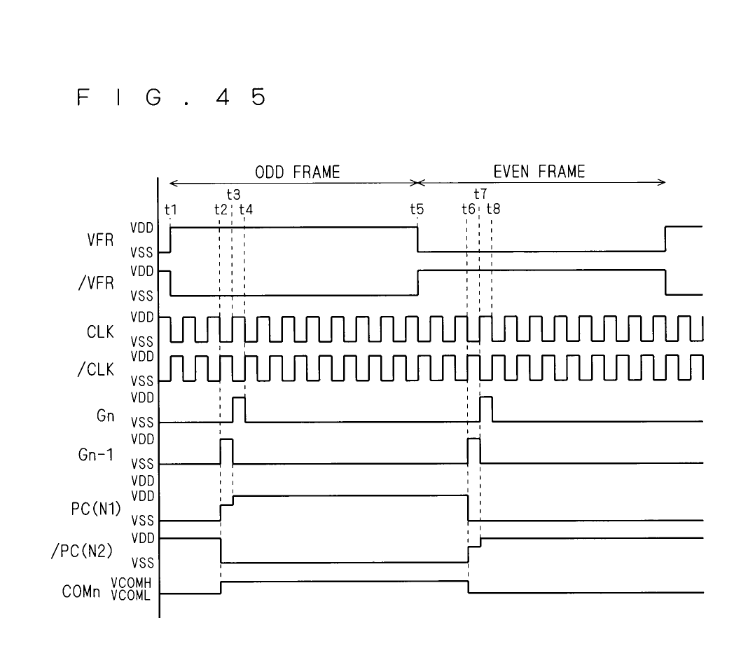

FIG. 44 shows a circuit diagram of the common electrode drive circuit 91 according to the present embodiment. The common electrode drive circuit shown in FIG. 44 is the common electrode drive circuit 91 corresponding to the gate line drive signal in odd rows of the pixel lines. The transistor used in the common electrode drive circuit 91 shown in FIG. 44 may be any one of polysilicon TFT, amorphous silicon TFT, or organic TFT.

It is assumed that the transistor used in the common electrode drive circuit 91 shown in FIG. 44 is an N-type and the threshold voltages Vth thereof are all equal. The N-type transistor is in the activated (ON) state when the gate becomes H (High) level with respect to the source, and is in the inactivated (OFF) state when the gate becomes L (Low) level with respect to the source. The transistor used in the common electrode drive circuit 91 shown in FIG. 44 is an N-type, but the transistor used in the common electrode drive circuit 91 of the present invention may be configured by a P-type transistor. The P-type transistor is activated (ON) state when the gate becomes L (Low) level with respect to the source, and is in the inactivated (OFF) state when the gate becomes H (High) level with respect to the source.

The reference potential of the image display device is generally set with the potential of the display signal written to the pixel as the reference, but the potential of the low potential power supply of the common electrode drive circuit 91 is conveniently set as the reference potential VSS for the sake of simplifying the explanation for the reference potential of the image display device according to the present embodiment. Similarly, the potentials of the high potential power supply VDD2 of the image display device according to the present embodiment are the same or VDD. Polarity control signals VFR signal and /VFR signal of the image display device according to the present embodiment have the H level as VDD and the L level as VSS. Furthermore, clock signals (CLK, /CLK) of the image display device according to the present embodiment also have the H level as VDD and the L level as VSS. VCOMH and VCOML shown in FIG. 44 are voltage sources that respectively supply H level and L level with respect to a common electrode drive signal COMn for driving the common electrode line COML.

The common electrode drive circuit 91 shown in FIG. 44 includes a polarity switching circuit 7, the output level holding circuit 2, and the output circuit 3. In the common electrode drive circuit 91 shown in FIG. 44, same reference numerals are denoted for components having the same functions as the components described in the above embodiments. This is the same for the following drawings.

First, the polarity switching circuit 7 determines the polarity of the output signal. The polarity switching circuit 7 shown in FIG. 44 includes a transistor Q5 having the terminal IN1 connected to the gate and the terminal IN2 connected to the source, and a transistor Q7 having the terminal IN1 connected to the gate and the terminal IN3 connected to the source. The gate line drive signal Gn−2, which is an input signal, is input to the terminal IN1, the polarity control signal VFR is input to the terminal IN2, and the polarity control signal /VFR is input to the terminal IN3. The polarity switching signal PC is output from the drain of the transistor Q5, and the polarity switching signal /PC is output from the drain of the transistor Q7.

The output level holding circuit 2 provides a driving ability to the output signals (PC, /PC) of the polarity switching circuit 7, and holds the output level thereof at low impedance for one frame. The output level holding circuit 2 shown in FIG. 44 includes a transistor Q15 and a transistor Q16 connected in series between the terminal S1 connected to the reference potential VSS and the terminal S3 connected to the high potential power supply VDD2, and a transistor Q17 and a transistor Q18 having the high potential power supply VDD2 connected to the respective gates. The polarity switching signal PC, which is the output of the polarity switching circuit 7, is input to the node N5, and the polarity switching signal /PC, which is the output of the polarity switching circuit 7, is input to the node N6.

A node N7, which is a common connection node between the gate of the transistor Q15 and the drain of the transistor Q17, is connected to a terminal CK to be input with the clock signal CLK through a capacitance element C1. A node N8, which is a common connection node between the gate of the transistor Q16 and the drain of the transistor Q18, is connected to the terminal CK to be input with the clock signal CLK through a capacitance element C2.

The output circuit 3 outputs the common electrode drive signal COMn having higher driving ability in response to the output of the output level holding circuit 2. The output circuit 3 shown in FIG. 44 includes transistors Q19, Q20 connected in series between a terminal S4 connected to the power supply VCOML and a terminal S5 connected to the power supply VCOMH. The polarity switching signal PC, which is the output of the node N5, is input to the gate of the transistor Q19, and the polarity switching signal /PC, which is the output of the node N6, is input to the gate of the transistor Q20. The common electrode drive signal COMn is output to the common electrode lines COMLn from the output node OUT which is a common connection node between the transistor Q19 and the transistor Q20.

FIG. 45 shows an operation waveform chart of the common electrode drive circuit 91 according to the present embodiment. In the operation waveform shown in FIG. 45, the polarity control signal VFR and the polarity control signal /VFR signal are signals which level is determined depending on the polarity of the data written to the pixel 25, and are signals complementary to each other, wherein the levels thereof alternate for every one frame in a blanking period of the image display device. In the operation waveform shown in FIG. 45, a period in which the polarity control signal VFR signal is H level is defined as an odd frame, and a period in which the polarity control signal VFR signal is L level is defined as an even frame.

In the operation waveform shown in FIG. 45, the clock signals CLK, /CLK are repeating signals that alternate at a constant cycle. A clock signal used to generate the gate line drive signal Gn in the gate line drive circuit 30 may be used for the clock signals CLK, /CLK. The clock signal used in the gate line drive circuit 30 is used for the clock signals CLK, /CLK shown in FIG. 45.

The input signal of the common electrode drive circuit 91 shown in FIG. 44 is the gate line drive signal Gn−1 before one row from the gate line drive signal Gn corresponding to the common electrode drive signal COMn. In the present embodiment, the gate line drive signal Gn−1 provided to the gate line GLn−1 that can be easily obtained is directly used as the input signal of the common electrode drive circuit 91, but the signal is not limited to the gate line drive signal Gn−1 as long as the signal has the same timing and a predetermined voltage level.

The operation of the common electrode drive circuit 91 shown in FIG. 44 will now be described with reference to the operation waveform of FIG. 45. First, at time t1, when the levels of the polarity control signals VFR, /VFR signal respectively change, the input terminal IN2 is set to the voltage level of the VDD and the input terminal IN3 is set to the voltage level of the VSS. The voltage levels of the nodes N5 to node N8 and the output node OUT are determined by the operation of the previous frame, and are assumed herein that the nodes N5, N7 and the output node OUT have voltage level of VSS (hereinafter also referred to as L level), and the nodes N6, N8 have voltage level of VDD (hereinafter also referred to as H level).

At time t2, when the gate line drive signal Gn−1 becomes H level (VDD), the transistors Q5, Q7 are turned ON. First, the polarity switching signal /PC becomes L level (VSS), thereby turning OFF the transistors Q13, Q20. At substantially the same time, the polarity switching signal PC becomes H level (VDD-Vth), thereby turning ON the transistors Q14, Q19. In response thereto, the node N8 becomes L level (VSS), and the node N7 becomes H level (VDD-Vth). Since the voltage at which the transistor Q19 operates in the unsaturated region is supplied to the gate of the transistor Q19, the output node OUT becomes the level of the power supply VOCMH.

At time t3, when the gate line drive signal Gn−1 becomes L level, the transistors Q5, Q7 are turned OFF, and the nodes N5, N6 and the input terminals IN2, IN3 are respectively electrically separated. In other words, the polarity controls signals VFR, /VFR input to the input terminals IN2, IN3 are latched to the nodes N5, N6, respectively, at time 3 when the gate line drive signal Gn−1 falls. Thus, the polarity control signals VFR, /VFR indicate that the state of H level or L level does not necessarily need to be maintained for one frame. That is, the polarity control signals VFR, /VFR merely need to be set to a predetermined level at the time when the gate line drive signal Gn−1 becomes L level. However, the power consumption increases as the voltage levels of the polarity control signals VFR, /VFR alternate.

The clock signal CLK becomes H level at time t3. The VDD or the voltage change amount of the clock signal CLK is coupled to the node N7 through the capacitance element C1. Since the node N7 has already been charged to the voltage level of VDD-Vth through the transistor Q17 from the node N5, the voltage level is further stepped up to substantially 2·VDD-Vth. When the node N7 is further stepped up, the transistor Q15 is turned ON in the unsaturated region, and the node N5 is charged up to the voltage level of the VDD by the high potential power supply VDD2.

In the circuit configured by the transistors Q16, Q18 and the capacitance element C2, on the other hand, the node N8 is L level since the node N6 is L level. When the clock signal /CLK rises, the voltage level of the node N8 coupled through the capacitance element C2 rises. However, since the transistor Q14 is turned ON, the voltage levels of the nodes N6, N8 instantaneously lower to L level after rising to a constant level. That is, a voltage of spike-form is generated at the nodes N6, N8. The spike voltage can be made small by appropriately setting the on-resistance value of the transistor Q14 and the transistor Q18 as well as the capacitance value of the capacitance element C2, and the OFF state of the transistor Q16 can be maintained. That is, the node N6 can be held at the L level, and at the same time, the pass-through current barely flows between the power supplies VDD2 and VSS through the transistor Q16 and the transistor Q14, and power is barely consumed.

Therefore, in the common electrode line drive circuit according to the present embodiment, a selective pull-up operation in which only the H level side is pulled up and the L level side is not pulled up is carried out on the output without barely consuming power.

When the clock signal CLK becomes L level at time t4, the voltage level of the node N7 again becomes VDD-Vth and the node N5 becomes VDD level of high impedance state.

Thereafter, the node N7 is stepped up to about 2·VDD-Vth every time when the clock signal CLK changes to H level, and accordingly, the transistor Q15 is turned ON and the node N5 is charged to the voltage level of VDD by the high potential power supply VDD2, thereby compensating for the lowering in the level of the node N5 by the leakage current. As a result, the output node OUT can maintain the H level of low impedance for one period. Furthermore, during this period, the pass-through current barely flows between the high potential power supply VDD2 and the low potential power supply VSS, and low power consumption state can also be maintained.

A case of using the clock signal used in the gate line drive circuit as the clock signal for holding the H level of the polarity switching signal PC (/PC) has been described, but a clock signal having lower frequency may be used to reduce power consumption as long as lowering in the voltage level by the leakage current can be compensated.

At time t5, the polarity control signals VFR, /VFR respectively change to L level and H level, but the voltage levels of the nodes N5, N6 and the output node OUT are maintained since the OFF state of the transistors Q5, Q7 is maintained.

When the gate line drive signal Gn−1 becomes H level at time t6, the transistors Q5, Q7 are turned ON, and the operation opposite to that at time t2 is performed in the polarity switching circuit 7. That is, the polarity switching signal PC becomes L level (VSS), the polarity switching signal /PC becomes H level, and according thereto, the output node OUT becomes the voltage level of the power supply VCCL.

At times t7, t8, operation same as when the voltage levels of the nodes N5, N6 and the output node OUT are inverted at times t3, t4 is performed. After time t8, the voltage level of VDD at the node N6 is held by the clock signal CLK, and according thereto, the node N5 and the output node OUT maintain the L level of low impedance for one frame.

In the image display device according to the present embodiment, the gate voltage of the transistor in the common electrode drive circuit 91 is supplied at low power consumption and at low impedance, and thus instability of the voltage level of the common electrode drive signal due to leakage current of the transistor can be prevented, and display abnormality can be prevented.

### Variant

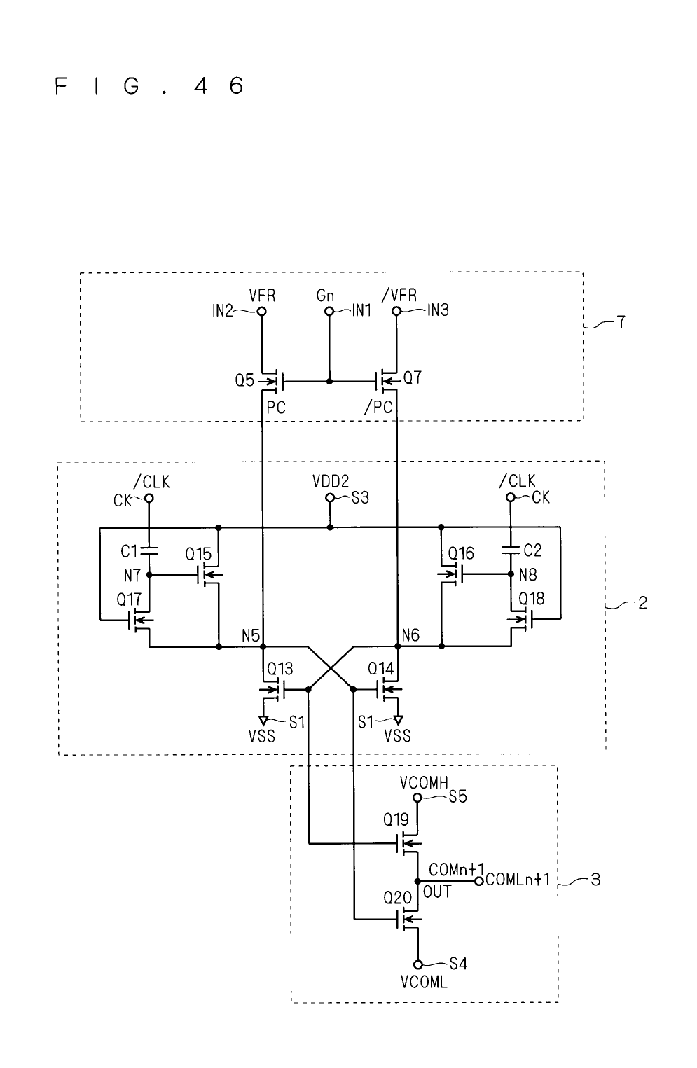

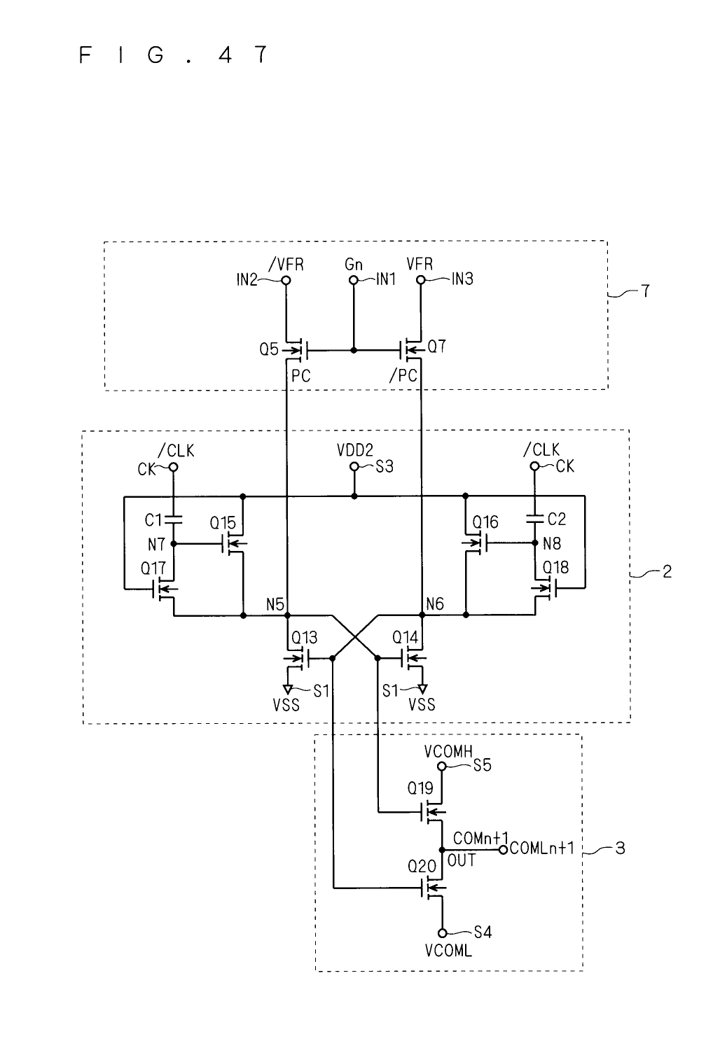

The common electrode drive circuit 91 shown in FIG. 44 described above relates to a circuit for generating the common electrode drive signal corresponding to odd rows. In the present variant, a circuit for generating the common electrode drive signal corresponding to the even row is shown in FIGS. 46 and 47. Similar to the circuit shown in FIG. 44 corresponding to the odd row, the gate line drive signal before one row from the corresponding gate line is input as the input signal in the circuit shown in FIGS. 46 and 47. Assuming the corresponding even row as GLn+1, the gate line drive signal Gn is input as an input of a circuit for generating the common electrode drive signal. A clock signal CLK which active period does not overlap with the gate line drive signal Gn is input to the clock terminal CK.

The circuit configuration shown in FIGS. 46 and 47 is basically the same as the circuit shown in FIG. 44 corresponding to the odd row, but in the circuit shown in FIG. 46, the input to the gates of the transistors Q19, Q20 of the output circuit 3 are interchanged with each other to obtain an inverted output with respect to the circuit shown in FIG. 44.

In the circuit shown in FIG. 47, the polarity controls signals VFR, /VFR input to the input terminals IN2, IN3 are interchanged with each other to obtain an inverted output with respect to the circuit shown in FIG. 44. In the circuit shown in FIGS. 46 and 47, the common electrode drive signal falls at the odd frame (when polarity control signal VFR signal is H level) and rises at the even frame (when polarity control signal VFR signal is L level), opposite to the case of the odd rows.

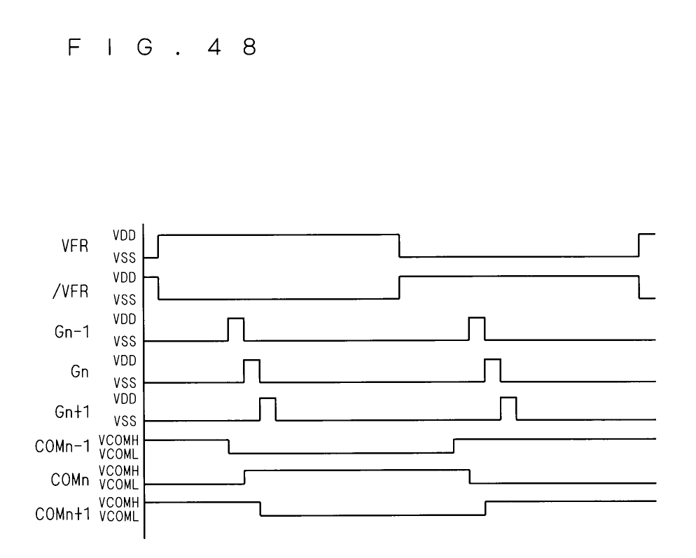

The waveform shown in FIG. 48 is an operation waveform of the image display device for both odd rows and even rows. In the waveform shown in FIG. 48, with respect to the gate line drive signals Gn−1, Gn, Gn+1, the polarity of the corresponding common electrode line drive signals COMn−1, COMn, COMn+1 is inverted one row before, and the polarity of the common electrode line drive signals COMn−1, COMn, COMn+1 is inverted for every one row.

A circuit corresponding to the odd row (FIG. 44 in the tenth embodiment) will be representatively described for the common electrode drive circuit 91 according to the embodiment described below to simplify the explanation. Even in this case, a storage capacitance line drive circuit corresponding to the even row is similarly obtained by applying changes used in the circuit configuration shown in FIGS. 46 and 47.

In the present embodiment, the common electrode drive circuit 91 for generating the common electrode drive signal COMn by using the gate line drive signal Gn of the previous stage so that the common electrode line COMLn is set at a predetermined level before write of data to the pixel electrode 25 is terminated has been described. The present invention, however, is not limited thereto, and the common electrode drive signal COMn may be generated using the gate line drive signal Gn of the same row as long as the common electrode line COMLn is set at a predetermined level before write of data to the pixel electrode 25 is terminated.

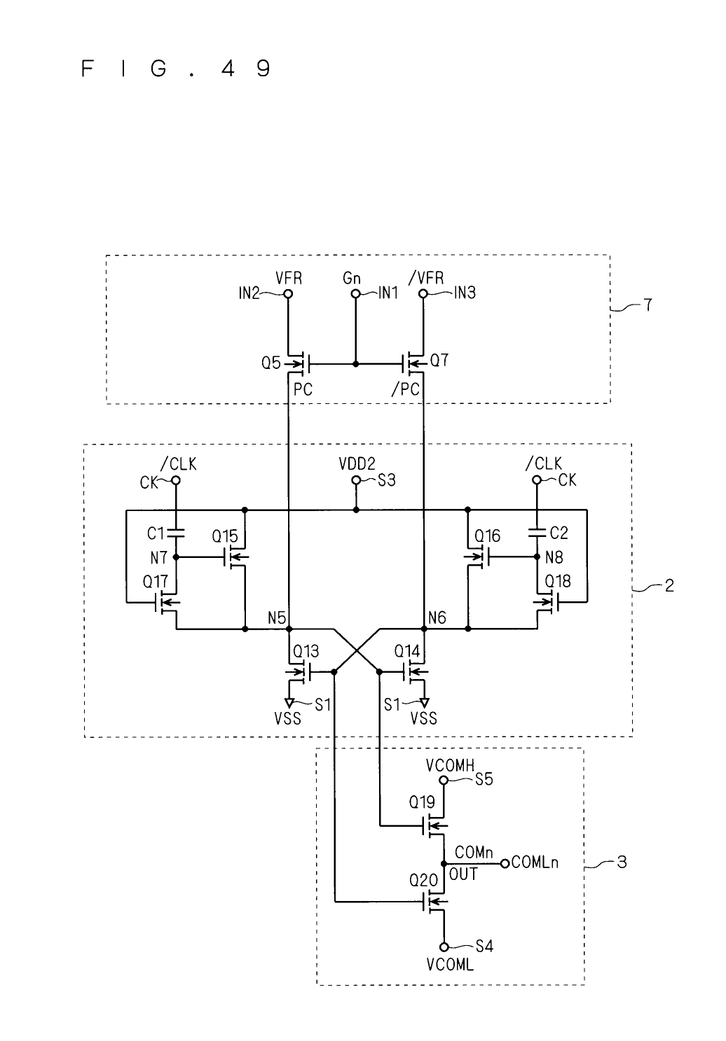

Specifically, the circuit diagram of the common electrode drive circuit 91 of odd rows, or a variant of the present embodiment, is shown in FIG. 49. The circuit shown in FIG. 49 differs from the circuit shown in FIG. 44, and the gate line drive signal Gn of the same row is input to the input terminal IN1, and the clock signal /CLK which active period does not overlap the gate line drive signal Gn is input to the clock terminal CK.

The circuit shown in FIG. 49 has an advantage in that the circuit configuration can be simplified when configuring the bidirectional scanning gate line drive circuit to be hereinafter described. Furthermore, the circuit shown in FIG. 49 can also be applied to the gate line inversion drive manner and the frame inversion drive manner.

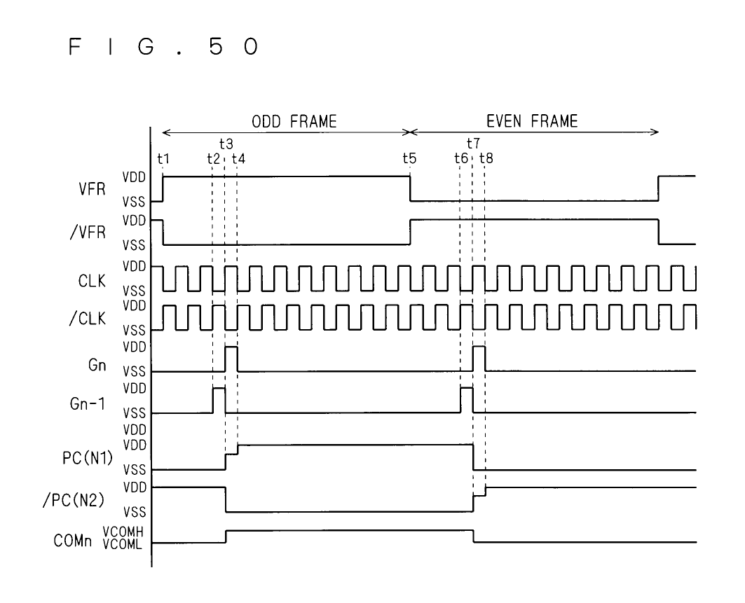

FIG. 50 shows n operation waveform of the circuit shown in FIG. 49. In the waveform shown in FIG. 50, the common electrode drive signal COMn reaches a predetermined level before the gate line drive signal Gn lowers (time t3). In order to obtain the operation waveform shown in FIG. 50, a transistor having a wider gate width than the circuit shown in FIG. 44 is adopted for the circuit shown in FIG. 49, and the speed of the circuit operation needs to be increased.

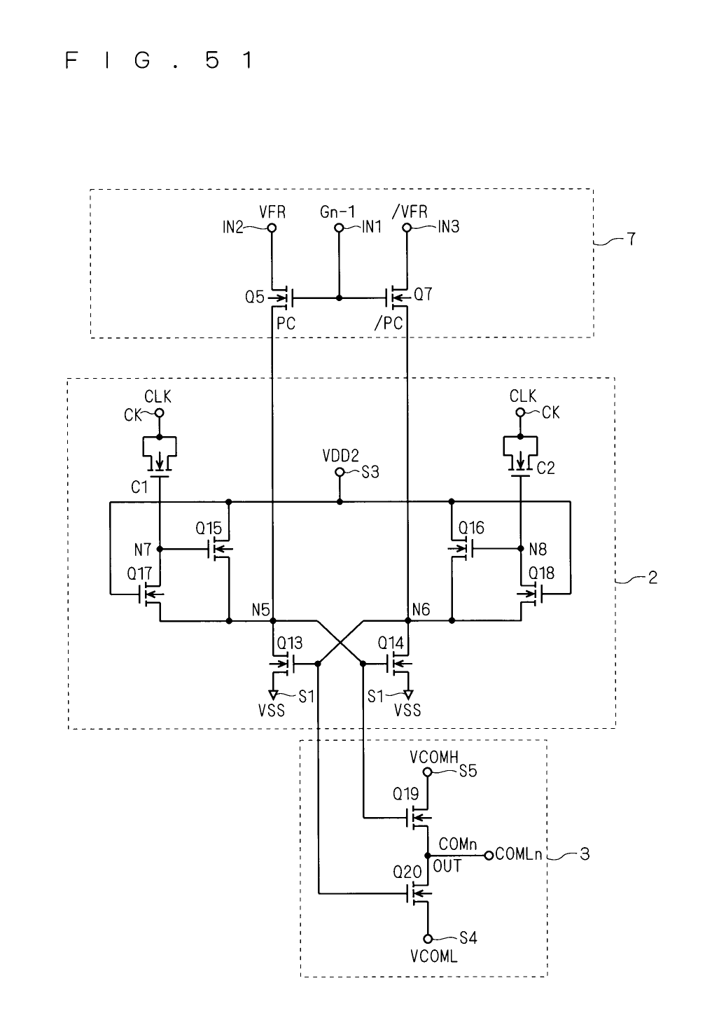

FIG. 51 shows another variant of the common electrode drive circuit 91 according to the present embodiment. The circuit shown in FIG. 51 differs from the circuit shown in FIG. 44 in that the MOS capacitance element is used for the step-up capacitance elements C1, C2 of the output level holding circuit 2. The MOS capacitance element is formed with a channel if the voltage between the gate and the source/drain is greater than or equal to the threshold voltage Vth, and is formed with capacitance.

In the circuit shown in FIG. 51, the gate terminal of the MOS capacitance is connected to the nodes N7, N8, and the source/drain terminal is connected to the clock terminal CK. Thus, when the voltage levels of the polarity switching signals PC, /PC are H level, the voltage between the gate and the source/drain becomes greater than or equal to Vth and the capacitance is formed, whereby the H level of the polarity switching signals PC, /PC is pulled up.

When the voltage levels of the polarity switching signals PC, /PC are L level, the voltage between the gate and the source/drain becomes lower than or equal to Vth and the capacitance is not formed, whereby the capacitance does not exist in appearance, and the spike voltage generated at the output node OUT in time of rise of the clock signal /CLK can be eliminated. In this case, the AC power by the clock signal consumed on the L level output side is reduced.

The capacitance elements C1, C2 can be similarly changed to MOS capacitance elements for the common electrode drive circuit 91 according to the embodiment described below.

### Eleventh Embodiment

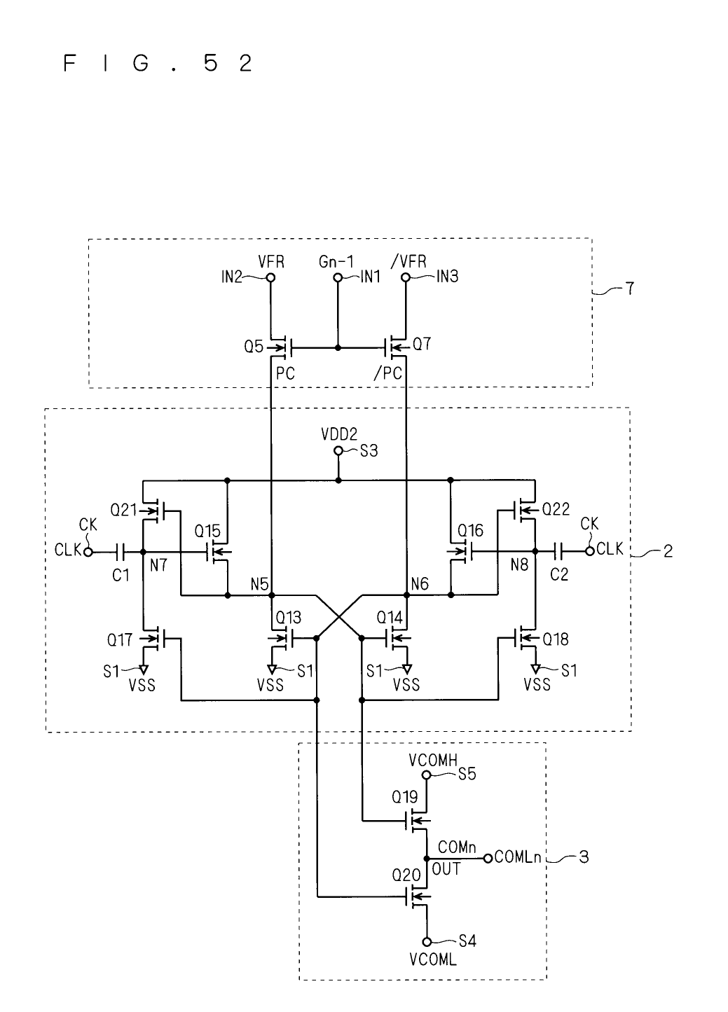

FIG. 52 is a circuit diagram of the common electrode drive circuit 91 according to the present embodiment. The circuit shown in FIG. 52 is a circuit in which the step-up capacitance elements C1, C2 and the nodes N5, N6 are not directly coupled so that rise of the output level by the clock signal is prevented at the time of refresh, unlike the circuit shown in FIG. 44. Specifically, the circuit shown in FIG. 52 differs from the circuit shown in FIG. 44 in that the output signal of the inverter including the transistors Q21, Q17 (Q22, Q18) is input to the gate of the transistor Q15 (Q16).

In the circuit shown in FIG. 52, when the node N5 becomes L level and the node N6 becomes H level, the clock signal CLK through the step-up capacitance element C1 is discharged to the terminal S1 by the transistor Q17 turned ON by the H level of the node N6, and does not directly influence the node N5. The node N8 is initially charged to VDD-2·Vth since the node N6 is at H level, but thereafter, stepped up to about 2·VDD-2·Vth by the clock signal CLK through the capacitance element C2. Accordingly, the transistor Q16 is in turned ON in the unsaturated region, and the voltage level of the node N6 is pulled up, and at the same time, voltage level of the node N6 rises to VDD.

After the voltage level of the node N6 becomes VDD level, the clock signal CLK becomes L level, and the voltage level of the node N8 again lowers towards the initial VDD-2·Vth. The voltage level of the node N8 is pulled up to the VDD-Vth level through the transistor Q22 by the voltage level (VDD) of the node N6.

Thereafter, the level of the node N8 lowers by the off leakage current of the transistor Q18, but when the clock signal CLK becomes L level and the voltage level of the node N8 becomes lower than or equal to VDD-Vth, the level refreshes to the VDD-Vth level through the transistor Q22.

### Variant

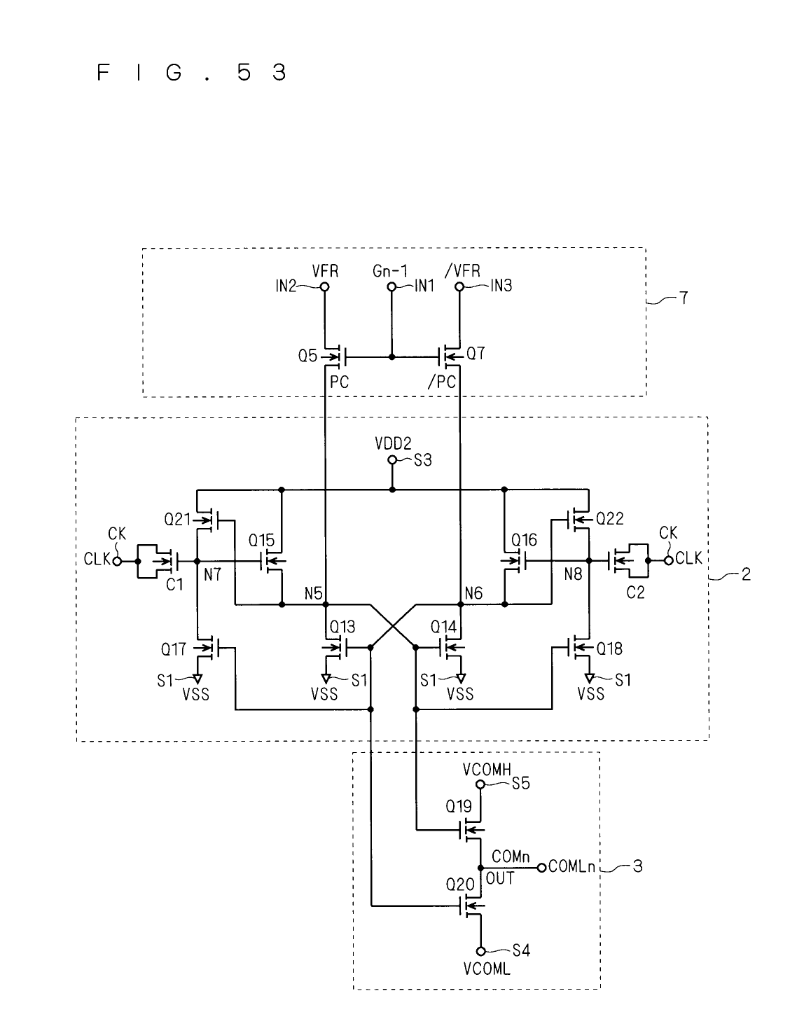

FIG. 53 shows a circuit diagram of the common electrode drive circuit 91 of a variant according to the present embodiment. The circuit shown in FIG. 53 has a configuration in which the MOS capacitance element is adopted for the step-up capacitance elements C1, C2 of the circuit shown in FIG. 52. The MOS capacitance element shown in FIG. 53 has the gate terminal connected to the nodes N7, N8 and the source/drain terminal connected to the clock terminal CK.

When the transistor Q15 or the transistor Q16 is turned OFF, the spike voltage is less likely to generate at the gate, and thus the pass-through current can be reduced and power consumption can be reduced. At the same time, invalid current by the clock signal CLK flowing through the transistor Q17 or the transistor Q18 can also be reduced.

### Twelfth Embodiment

In the present embodiment, a case in which an image display device adopting the common electrode drive circuit 91 shown in FIG. 44 includes a gate line drive circuit for scanning in two-ways will now be described.

When the gate line drive circuit is scanned in the reverse direction, the gate line drive signal Gn−1 to be input before one row in the forward direction of the gate line drive signal Gn becomes the gate line drive signal after one row in the reverse direction in the circuit shown in FIG. 44, and thus the circuit does not normally operate.

The technique of the bidirectional gate line drive circuit (shift register) using the transistor of a single channel is disclosed in Japanese Laid-Open Patent Publication No. 2001-350438, wherein the relevant circuit configuration switches the shift direction of the signal by switching the levels of the two types of voltage signals V1, V2. That is, in the relevant circuit configuration, the gate line is scanned in the forward direction when the voltage signal V1 is H level and the voltage signal V2 is L level, and the gate line is scanned in the reverse direction when the voltage signal V1 is L level and the voltage signal V2 is H level.

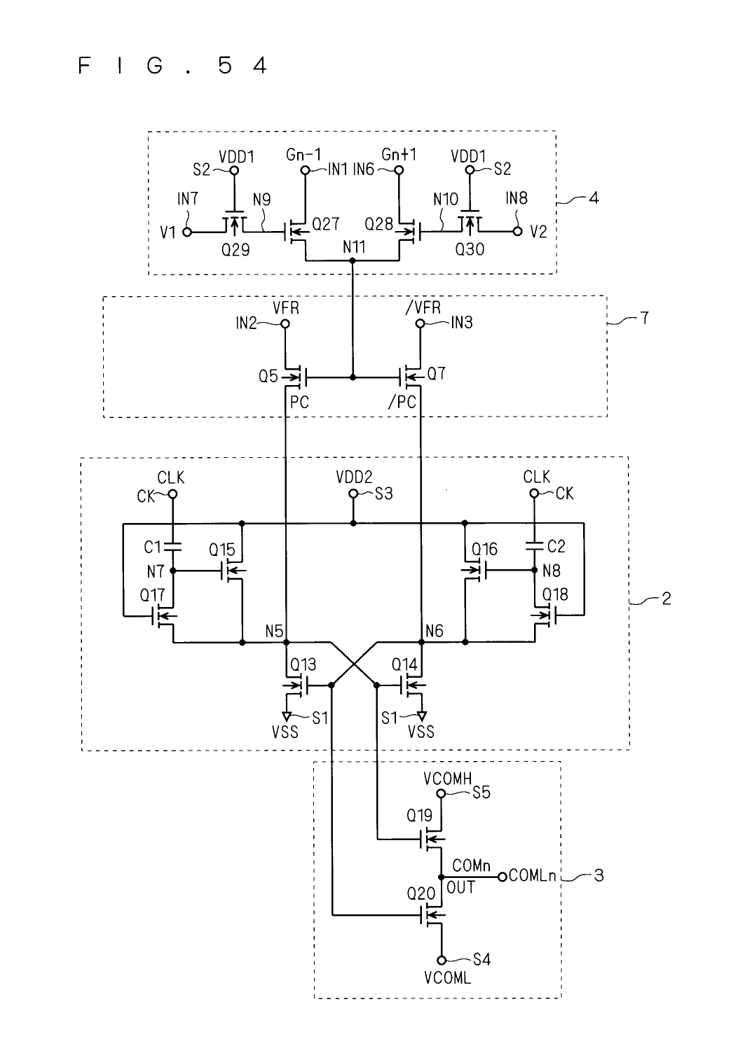

FIG. 54 shows a circuit diagram of the common electrode drive circuit 91 according to the present embodiment. In the circuit shown in FIG. 54, the scanning direction switching circuit 4 for responding to bidirectional scanning of the gate line drive circuit is arranged at the input part of the circuit shown in FIG. 44. That is, the circuit configured by the transistors Q27 to Q30 shown in FIG. 54 is the scanning direction switching circuit 4. The subscript of the gate line drive signals Gn+1 and Gn−1 takes forward scanning as a reference.

In the circuit shown in FIG. 54, if the voltage level of the high potential power supply VDD1 is VDD, the voltage signal V1 becomes H (VDD) level and charges the voltage level of the node N9 to VDD-Vth and thus the transistor Q27 is turned ON in the forward scanning. When the voltage signal V2 becomes L (VSS) level and the voltage level of the node N10 is discharged to VSS, the transistor Q28 is turned OFF. Thus, in the circuit shown in FIG. 54, the gate line drive signal Gn−1 is transmitted to the node N11 and the gate line drive signal Gn+1 is not transmitted in the above case.

When the gate line drive signal Gn−1 of L level changes to H level, the change in voltage level couples to the node N9 through the gate-channel capacitance of the transistor Q27, and the voltage level of the node N9 rises. As a result, the transistor Q27 operates in the unsaturated region, and the voltage level of the node N11 is output as the H level signal of VDD.

In the case of reveres scanning, the transistor Q28 is turned ON, and the gate line drive signal Gn+1 is input to the node N11, which acts the same as the gate line drive signal Gn−1 of the forward scanning. The configuration and the operation of other circuits are the same as the circuit shown in FIG. 44, and thus the detailed description thereof will be omitted. In the circuit shown in FIG. 54, the circuit configuration other than the scanning direction switching circuit 4 is the circuit shown in FIG. 44, but the present invention is not limited thereto, and the circuit shown in FIGS. 46, 47, 51, 52, and 53 may be adopted instead of the circuit shown in FIG. 44. Furthermore, the scanning direction switching circuit 4 is not necessary in the circuit shown in FIG. 49.

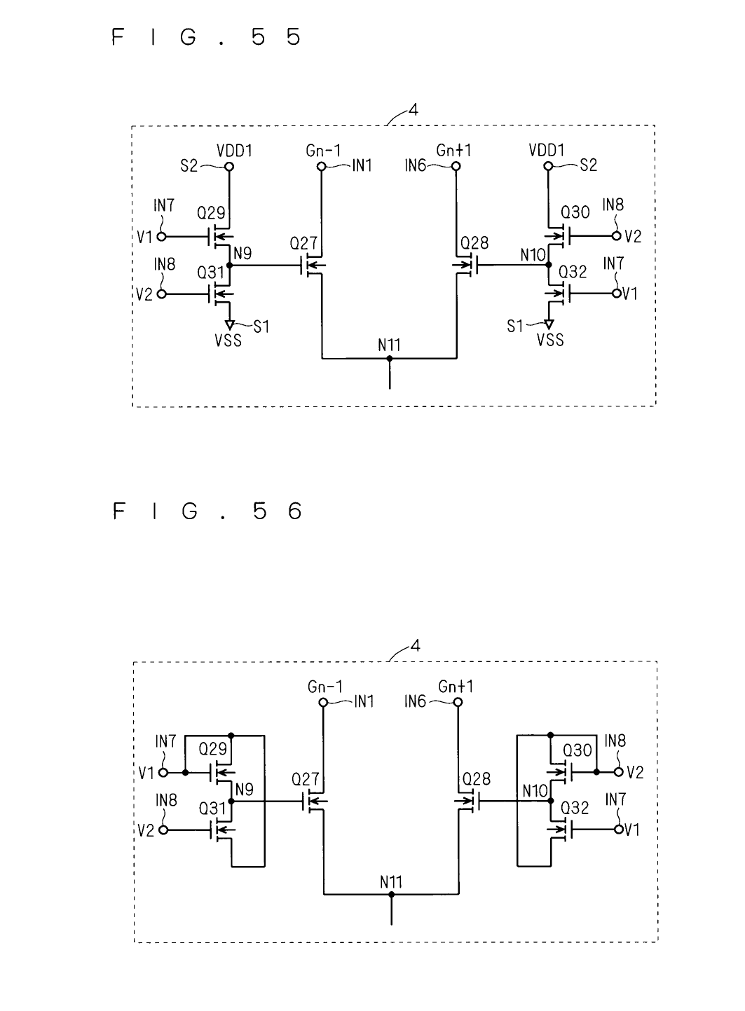

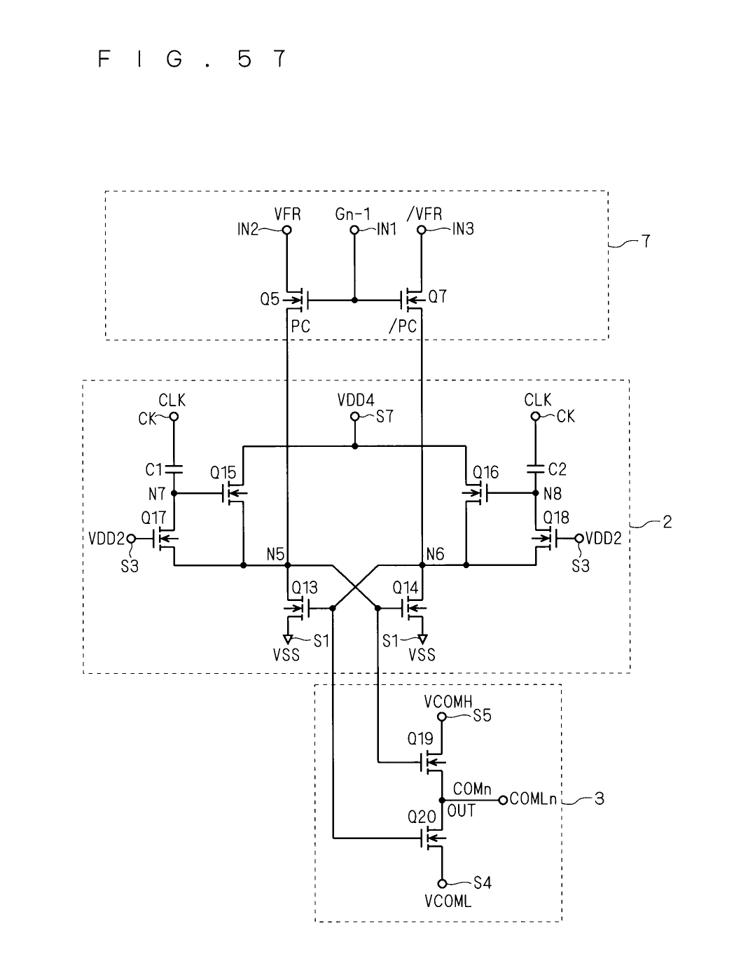

The scanning direction switching circuit 4 is not limited to the circuit configuration shown in FIG. 54, and the circuit configurations shown in FIGS. 55 and 56 may be used. The scanning direction switching circuit 4 shown in FIG. 55 further includes transistors Q31, Q32, wherein the voltage signal V1 is provided to the gates of the transistors Q29, Q32, and the voltage signal V2 is provided to the gates of the transistors Q30, Q31. In the scanning direction switching circuit 4 shown in FIG. 55, the drains of the transistors Q29, Q30 are connected to the high potential power supply VDD2, the sources of the transistors Q31, Q32 are connected to the VSS, the source of the transistor Q29 and the drain of the transistor Q31 are connected to the node N9, and the source of the transistor Q30 and the drain of the transistor Q32 are connected to the node N10.

The scanning direction circuit 4 shown in FIG. 56 has a circuit configuration in which the drain of the transistor Q29 and the source of the transistor Q31 are connected to the gate of the transistor Q29, and the drain of the transistor Q30 and the source of the transistor Q32 are connected to the gate of the transistor Q30, in the circuit configuration of the scanning direction switching circuit 4 shown in FIG. 55.

### Thirteenth Embodiment

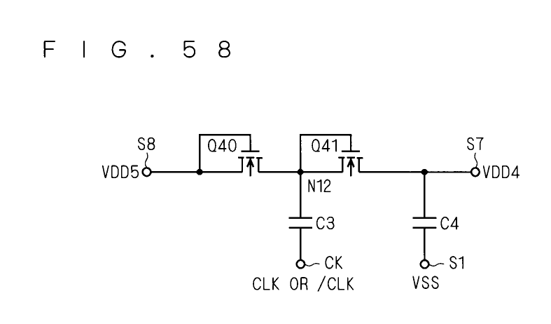

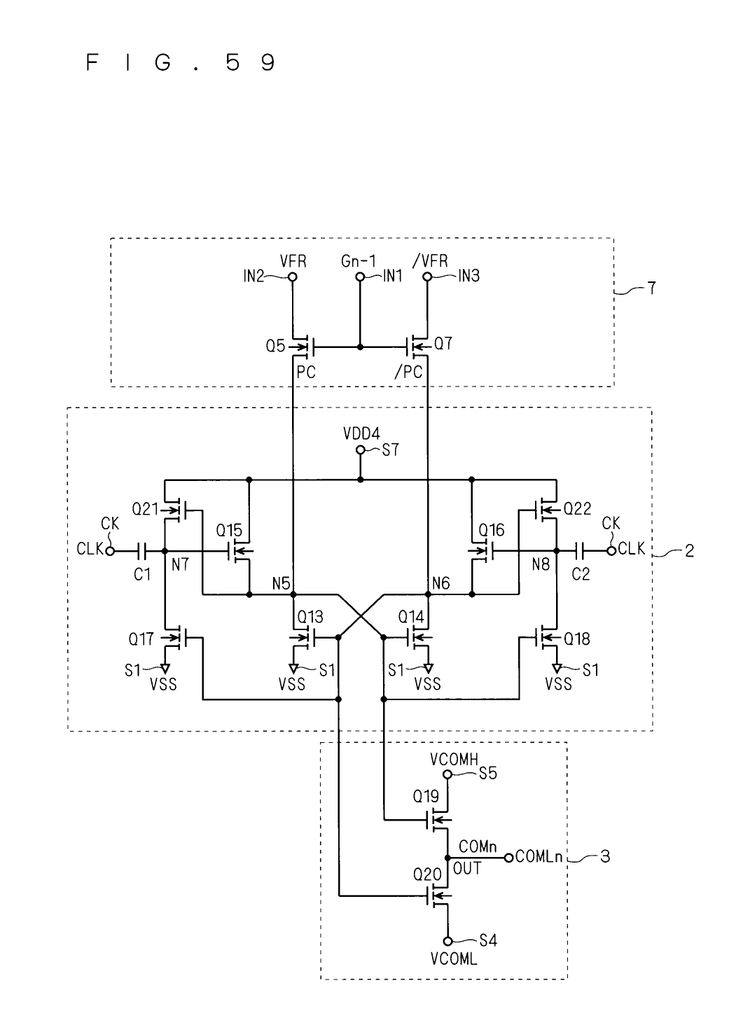

FIG. 57 shows a circuit diagram of the common electrode drive circuit 91 according to the present embodiment. In the circuit shown in FIG. 44, the voltage source VDD2 is supplied to the drain of the transistors Q15, Q16, but in the circuit shown in FIG. 57, the voltage source VDD4 is supplied in place of the voltage source VDD2. The voltage source VDD4 is a voltage source configured by a charge pump circuit as shown in FIG. 58, and has a voltage value of greater than or equal to VDD. The charge pump circuit shown in FIG. 58 has a configuration in which the transistors Q40, Q41 are diode connected, wherein the clock terminal CK is connected to the node N12 through the capacitance element C3, and the drain of the transistor Q41 is connected to the terminal S1 through the capacitance element C4. In the charge pump circuit shown in FIG. 58, if the voltage value of the voltage source VDD5 to be input to the terminal S8 is VDD, the voltage value of the voltage source VDD4 to be output becomes 2·VDD-2·Vth.

In the circuit shown in FIG. 57, when the node N7 is stepped up, the voltage level thereof ideally becomes 2 VDD-Vth, and thus the voltage level of the node N5 can be stepped up to 2·VDD-2·Vth. Therefore, in the circuit shown in FIG. 57, the H level of the node N5 can be made to 2·VDD-2·Vth by having the voltage level of the voltage source VDD4 as 2·VDD-2·Vth. This means that the gate voltage of the output transistor Q19 (Q20) is increased, whereby the on-resistance thereof can be lowered. That is, if set to the same resistance value, the dimension (gate width) thereof can be reduced, and the occupying area of the circuit can be reduced.

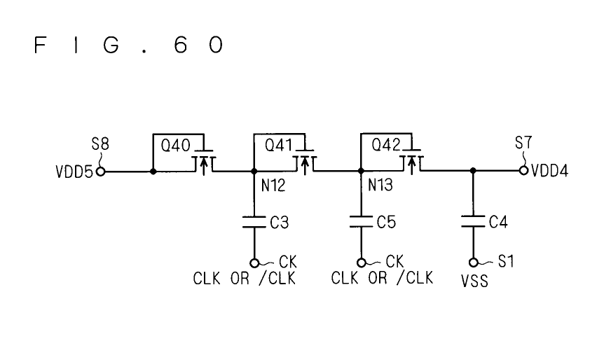

FIG. 59 shows another circuit diagram of the common electrode drive circuit 91 according to the present embodiment. In the circuit shown in FIG. 59, the voltage source VDD4 is supplied in place of the voltage source VDD2 in the circuit shown in FIG. 52. The voltage source VDD4 is a voltage source having a voltage value of 2·VDD-2·Vth generated in the charge pump circuit shown in FIG. 58.

In the circuit shown in FIG. 59, when the node N7 is stepped up, the voltage level of the node N7 rises from VDD-2·Vth to 2·VDD-2·Vth in the first step up. As a result, the voltage level of the node N5 becomes 2·VDD-3·Vth by the transistor Q15. When the clock signal CLK becomes L level, the voltage level of the node N7 becomes 2·VDD-4·Vth by the voltage level of the relevant clock signal CLK. When the clock signal CLK again becomes H (VDD) level, the node N7 is stepped up, and the voltage level thereof becomes 3·VDD-4·Vth. As a result, the transistor Q15 operates in the unsaturated region, the voltage level of the node N5 becomes 2·VDD-2·Vth same as the voltage source VDD4, and the dimension of the transistor Q19 (Q20) can be reduced similar to the circuit shown in FIG. 57.

### Variant

FIG. 60 shows a circuit diagram of a charge pump circuit of a variant according to the present embodiment. The circuit diagram shown in FIG. 60 is a charge pump circuit for generating voltage of 3·VDD-3·Vth. The charge pump circuit shown in FIG. 60 has a configuration in which the transistors Q40, Q41, Q42 are diode connected, wherein the clock terminal CK is connected to the node N12 through the capacitance C3 and the clock terminal CK is connected to the node N13 through the capacitance element C5, and the drain of the transistor Q42 is connected to the terminal S1 through the capacitance element C4. In the charge pump circuit shown in FIG. 60, if the voltage value of the power source VDD5 to be input to the terminal S8 is VDD, the voltage value of the voltage source VDD4 to be output becomes 3·VDD-3·Vth.

When adopting the charge pump circuit shown in FIG. 60 to the voltage source VDD4 shown in FIG. 59 and supplying the voltage of 3·VDD-3·Vth, since the voltage level of the node N7 is 3·VDD-4·Vth, the voltage level of the node N5 rises up to 3·VDD-5·Vth. Therefore, in the circuit diagram shown in FIG. 59, the dimension of the transistor Q19 (Q20) can be further reduced.

In the charge pump circuit shown in FIGS. 58 and 60, the diode connected transistors Q40, Q41, Q42 and the capacitance elements C3, C4, C5 are assumed to be simultaneously formed on the same substrate as the common electrode drive circuit 91, but the present invention is not limited thereto, and the charge pump circuit shown in FIGS. 58 and 60 may be configured using discrete diode element and capacitance element, for example, on the outer side of the substrate.

The transistor described from the first embodiment to the thirteenth embodiment is an element with at least three electrodes including a control electrode (gate), one current electrode (drain or source), and another current electrode (source or drain), wherein a channel is formed between the drain and the source by applying a predetermined voltage to the gate thereby functioning as a switching element. The drain and the source have basically the same structure, and the designation thereof changes depending on the applied voltage condition. For example, in the case of the N-type transistor, the electrode having a relatively high potential is designated as drain and the electrode having low potential is designated as source. This becomes the opposite for the case of the P-type transistor.

In the circuit configuration described from the first embodiment to the thirteenth embodiment, the connection between the elements, between the nodes, or between the element and the node is assumed as the same connection if substantially the same function is exhibited even if other elements, switches etc. are arranged.

The storage capacitance line drive circuit 90 described from the first embodiment to the ninth embodiment and the common electrode drive circuit 91 described from the tenth embodiment to the thirteenth embodiment have basically a common circuit configuration and the only difference is that the configuration of the target image display device differs. Specifically, the image display device from the first embodiment to the ninth embodiment controls the pixel through the storage capacitance element formed by the pixel electrode and the storage capacitance line, whereas the image display device from the tenth embodiment to the thirteenth embodiment controls the pixel by acting directly on the liquid crystal capacitance with the common electrode line. Thus, the storage capacitance line and the common electrode line are common as a line for providing a drive signal (compensation signal or common electrode signal) for controlling the pixel. The storage capacitance element and the liquid crystal capacitance are common as a capacitance for controlling the pixel. Therefore, the storage capacitance line drive circuit 90 and the common electrode drive circuit 91 are common as a drive circuit for driving the image display device in that the drive signal is provided to the storage capacitance line or the common electrode line, or the line.

While the invention has been shown and described in detail, the foregoing description is in all aspects illustrative and not restrictive. It is therefore understood that numerous modifications and variations can be devised without departing from the scope of the invention.

What is claimed is:

1. An image display device comprising:
a plurality of signal lines;
a plurality of scanning lines orthogonal to said signal line;
a plurality of lines arrayed along said scanning lines;
a transistor arranged near an intersection of said signal line and said scanning line, and having one current electrode connected to said signal line and a control electrode connected to said scanning line;
a capacitance connected to said line; and
a drive circuit connected to said line, for providing a drive signal to said capacitance; wherein
said drive circuit has configuring active elements of a same conductivity type and has said active elements simultaneously formed on a same substrate as said transistor; and includes,
an output level switching circuit for generating a first switching signal and a second switching signal for switching a voltage level of said drive signal based on a predetermined signal, and outputting the signals;
an output level holding circuit for holding the voltage levels of said first switching signal and said second switching signal for a predetermined period based on a repeating signal; and
an output circuit for generating said drive signal based on said first switching signal and said second switching signal, and outputting said drive signal to said line.

2. An image display device comprising:
a plurality of signal lines;
a plurality of scanning lines orthogonal to said signal line;
a plurality of storage capacitance lines arrayed along said scanning lines;
a transistor arranged near an intersection of said signal line and said scanning line, and having one current electrode connected to said signal line and a control electrode connected to said scanning line;
a pixel electrode connected to another current electrode of said transistor;
a storage capacitance element connected between said pixel electrode and said corresponding storage capacitance line; and
a storage capacitance line drive circuit connected to said storage capacitance line, for providing a compensation signal to said storage capacitance element; wherein
said storage capacitance line drive circuit has configuring active elements of a same conductivity type and has said active elements simultaneously formed on a same substrate as said transistor; and includes,
an output level switching circuit for generating a first switching signal and a second switching signal for switching a voltage level of said compensation signal based on a predetermined signal, and outputting the signals;
an output level holding circuit for holding the voltage levels of said first switching signal and said second switching signal for a predetermined period based on a repeating signal; and
an output circuit for generating said compensation signal based on said first switching signal and said second switching signal, and outputting said compensation signal to said storage capacitance line.

3. The image display device according to claim 2, wherein the output circuit includes,
a first voltage source,
a second voltage source having a voltage value different from said first voltage source, and
a first active element and a second active element, connected in series between said first voltage source and said second voltage source, and having a common connection node connected to said storage capacitance line.

4. The image display device according to claim 2, wherein said output level holding circuit includes,
a first output node for outputting said first switching signal to said output circuit, and
a second output node for outputting said second switching signal to said output circuit.

5. The image display device according to claim 2, wherein said output level switching circuit includes,
a first latch circuit for latching a first control signal to said first output node as the first switching signal when a voltage level of said predetermined signal changes from a first voltage level to a second voltage level, and
a second latch circuit for latching a second control signal to said second output node as the second switching signal when a voltage level of said predetermined signal changes from the second voltage level to the first voltage level.

6. The image display device according to claim 5, wherein said first control signal and said second control signal have a voltage level of either a third voltage level or a fourth voltage level, and become a voltage level different from said first control signal and said second control signal.

7. The image display device according to claim 2, wherein said output level holding circuit, instead of holding the voltage levels of said first switching signal and said second switching signal for a predetermined period, generates a first output signal and a second output signal complementary to each other that invert in a frame time based on said first switching signal and said second switching signal, and holds the voltage levels of said first output signal and said second output signal for a predetermined period.

8. The image display device according to claim 7, wherein said output level holding circuit includes,
a first output node for outputting said first output signal, and
a second output node for outputting said second output signal.

9. The image display device according to claim 4, wherein
said output level holding circuit has said first output node activated and said second output node inactivated based on said first switching signal, and has said second output node activated and said first output node inactivated based on said second switching signal.

10. The image display device according to claim 9, wherein
said output level holding circuit includes a first level holding circuit for holding the voltage level of said first output node, and a second level holding circuit for holding the voltage level of said second output node; and
the activated said first output node or said second output node is charged with said repeating signal having a predetermined cycle.

11. The image display device according to claim 10, wherein
said first output level holding circuit and said second output level holding circuit includes,
a third active element connected between a third voltage source and said first output node;
a fourth active element connected between said third voltage source and said second output node;
a first potential supply circuit for supplying voltage corresponding to the voltage level of said first output node to a control electrode of said third active element;
a second potential supply circuit for supplying voltage corresponding to the voltage level of said second output node to a control electrode of said fourth active element;
a first capacitance element having one end connected to the control electrode of said third active element;
a second capacitance element having one end connected to the control electrode of said fourth active element; and
a terminal connected to respective other ends of said first capacitance element and said second capacitance element, and input with said repeating signal having a predetermined cycle.

12. The image display device according to claim 11, wherein
said first potential supply circuit further includes a fifth active element connected between the control electrode of said third active element and said first output node; and
said second potential supply circuit further includes a sixth active element connected between the control electrode of said fourth active element and said second output node.

13. The image display device according to claim 11, wherein
said first potential supply circuit includes a first inverter having an output terminal connected to the control electrode of said third active element and an input terminal connected to said second output node; and
said second potential supply circuit includes a second inverter having an output terminal connected to the control electrode of said fourth active element and an input terminal connected to said first output node.

14. The image display device according to claim 11, wherein said first capacitance element and said second capacitance element are MOS capacitance elements.

15. The image display device according to claim 14, wherein said MOS capacitance element has a control electrode connected to the control electrode of said third active element or said fourth active element, and has said repeating signal input to a current electrode.

16. The image display device according to claim 11, wherein an absolute value of a difference between the voltage of said third voltage source and a reference voltage is larger than an absolute value of a difference between said third voltage level, which is the voltage level of said first control signal or said second control signal and said fourth voltage level.

17. The image display device according to claim 11, wherein
said first potential supply circuit has a circuit configuration in which the first capacitance element and said first output node are not directly coupled; and
said second potential supply circuit has a circuit configuration in which the second capacitance element and said second output node are not directly coupled.

18. The image display device according to claim 8, wherein
said output level holding circuit has said first output node activated and said second output node inactivated based on said first switching signal, and has said second output node activated and said first output node inactivated based on said second switching signal;
said output level holding circuit includes a first level holding circuit for holding the voltage level of said first output node, and a second level holding circuit for holding the voltage level of said second output node; the activated said first output node or the second output node being charged with said repeating signal having a predetermined cycle; and
said first level holding circuit and said second level holding circuit are configured by said active element having a constant voltage source connected to the control electrode.

19. The image display device according to claim 8, wherein
said output level holding circuit has said first output node activated and said second output node inactivated based on said first switching signal, and has said second output node activated and said first output node inactivated based on said second switching signal;
said output level holding circuit includes a first level holding circuit for holding the voltage level of said first output node, and a second level holding circuit for holding the voltage level of said second output node; the activated said first output node or the second output node being charged with said repeating signal having a predetermined cycle; and
said first level holding circuit and said second level holding circuit are configured by said active element controlled by a clock signal.

20. The image display device according to claim 8, wherein
said output level holding circuit has said first output node activated and said second output node inactivated based on said first switching signal, and has said second output node activated and said first output node inactivated based on said second switching signal; and includes
a seventh active element for holding the voltage level of said inactivated first output node, and
an eighth active element for holding the voltage level of said inactivated second output node.

21. The image display device according to claim 7, wherein
said output level switching circuit includes,
third and fourth output nodes,
an input terminal input with an input signal activated after a predetermined time has elapsed from when a scanning signal provided from said scanning line corresponding said storage capacitance line changes from a selected state to a non-selected state, and
a control input terminal input with a first control signal and a second control signal complementary to each other; wherein
said third output node or said fourth output node is activated at a timing that said input signal is activated depending on the voltage level of said first control signal and said control signal.

22. The image display device according to claim 21, wherein
said output level holding circuit includes,
a ninth active element connected between said input terminal and said third output node, and
a tenth active element connected between said input terminal and said fourth output node; and
said ninth active element or said tenth active element is activated before at least one horizontal period from said input signal is activated, and said ninth active element or said tenth active element is inactivated within at least one horizontal period after said input signal is inactivated.

23. The image display device according to any one of claims 2 to 22, wherein said storage capacitance line drive circuit further includes a scanning direction switching circuit for switching said predetermined signal to be input to said output level switching circuit depending on a scanning direction of a scanning line drive signal for driving said scanning line.

24. The image display device according to claim 23, wherein
said scanning direction switching circuit assumes,
a first gate line drive signal for scanning in a first direction as said predetermined signal when a first voltage signal is a fifth voltage level and a second voltage signal is a sixth voltage level; and
a second gate line drive signal for scanning in a second direction as said predetermined signal when the first voltage signal is the sixth voltage level and the second voltage signal is the fifth voltage level.

25. The image display device according to claim 7, wherein said storage capacitance line drive circuit further includes a scanning direction switching circuit for switching a signal to be input to said output level switching circuit depending on a scanning direction of said scanning line.

26. The image display device according to claim 7, further comprising a shift register for inputting a signal input at a timing corresponding to a scanning signal provided by said scanning line to said storage capacitance line drive circuit delayed by a predetermined time.

27. An image display device comprising:
a plurality of signal lines;
a plurality of scanning lines orthogonal to said signal lines;
a plurality of common electrode lines arrayed along said scanning lines;
a transistor arranged near an intersection of said signal line and said scanning line, and having one current electrode connected to said signal line and a control electrode connected to said scanning line;
a liquid crystal capacitance connected between the other current electrode of said transistor and said corresponding common electrode line; and
a common electrode drive circuit connected to said common electrode line, for providing a common electrode drive signal to said liquid crystal capacitance; wherein
said common electrode drive circuit has configuring active elements of a same conductivity type and has said active elements simultaneously formed on a same substrate as said transistor; and includes,
a polarity switching circuit for generating a first switching signal and a second switching signal for switching a voltage level of said common electrode drive signal based on a predetermined signal, and outputting the signals;
an output level holding circuit for holding the voltage levels of said first switching signal and said second switching signal for a predetermined period based on a repeating signal, and
an output circuit for generating said common electrode drive signal based on said first switching signal and said second switching signal, and outputting said common electrode drive signal to said common electrode line.

28. The image display device according to claim 27, wherein said output circuit includes,
a first voltage source,
a second voltage source having a voltage value different from said first voltage source, and
a first active element and a second active element, connected in series between said first voltage source and said second voltage source, and having a common connection node connected to said common electrode line.

29. The image display device according to claim 27, wherein said output level holding circuit includes,
a first output node for outputting said first switching signal to said output circuit, and
a second output node for outputting said second switching signal to said output circuit.

30. The image display device according to claim 27, wherein said polarity switching circuit includes,
a first latch circuit for latching a first polarity control signal to said first output node as the first switching signal when a voltage level of said predetermined signal changes from a first voltage level to a second voltage level, and
a second latch circuit for latching a second polarity control signal to said second output node as the second switching signal when a voltage level of said predetermined signal changes from the second voltage level to the first voltage level.

31. The image display device according to claim 30, wherein said first polarity control signal and said second polarity control signal have a voltage level of either a third voltage level or a fourth voltage level, and become a voltage level different from said first polarity control signal and said second polarity control signal.

32. The image display device according to claim 29, wherein
said output level holding circuit has said first output node activated and said second output node inactivated based on said first switching signal, and has said second output node activated and said first output node inactivated based on said second switching signal.

33. The image display device according to claim 32, wherein
said output level holding circuit includes a first level holding circuit for holding the voltage level of said first output node, and a second level holding circuit for holding the voltage level of said second output node; and
said activated first output node or said second output node is charged with said repeating signal having a predetermined cycle.

34. The image display device according to claim 33, wherein
said first output level holding circuit and said second output level holding circuit includes,
a third active element connected between a third voltage source and said first output node;
a fourth active element connected between said third voltage source and said second output node;
a first potential supply circuit for supplying voltage corresponding to the voltage level of said first output node to a control electrode of said third active element;
a second potential supply circuit for supplying voltage corresponding to the voltage level of said second output node to a control electrode of said fourth active element;
a first capacitance element having one end connected to the control electrode of said third active element;
a second capacitance element having one end connected to the control electrode of said fourth active element; and
a terminal connected to respective other ends of said first capacitance element and said second capacitance element, and input with said repeating signal having a predetermined cycle.

35. The image display device according to claim 34, wherein
said first potential supply circuit further includes a fifth active element connected between the control electrode of said third active element and said first output node; and
said second potential supply circuit further includes a sixth active element connected between the control electrode of said fourth active element and said second output node.

36. The image display device according to claim 34, wherein
said first potential supply circuit includes a first inverter having an output terminal connected to the control electrode of said third active element and an input terminal connected to said second output node; and
said second potential supply circuit includes a second inverter having an output terminal connected to the control electrode of said fourth active element and an input terminal connected to said first output node.

37. The image display device according to claim 34, wherein said first capacitance element and said second capacitance element are MOS capacitance elements.

38. The image display device according to claim 37, wherein said MOS capacitance element has a control electrode connected to the control electrode of said third active element or said fourth active element, and has said repeating signal input to a current electrode.

39. The image display device according to claim 34, wherein an absolute value of a difference between the voltage of said third voltage source and a reference voltage is larger than an absolute value of a difference between said third voltage level. which is the voltage level of said first polarity control signal or said second polarity control signal and said fourth voltage level.

40. The image display device according to claim 27, wherein said common electrode drive circuit further includes a scanning direction switching circuit for switching said predetermined signal to be input to said polarity switching circuit depending on a scanning direction of a scanning line drive signal for driving said scanning line.

41. The image display device according to claim 40, wherein said scanning direction switching circuit assumes,
a first gate line drive signal for scanning in a first direction as said predetermined signal when a first voltage signal is a fifth voltage level and a second voltage signal is a sixth voltage level; and
a second gate line drive signal for scanning in a second direction as said predetermined signal when the first voltage signal is the sixth voltage level and the second voltage signal is the fifth voltage level.

42. A drive circuit connected to a line of an image display device including a plurality of signal lines, a plurality of scanning lines orthogonal to said signal line, a plurality of lines arrayed along said scanning lines, a transistor arranged near an intersection of said signal line and said scanning line, and having one current electrode connected to said signal line and a control electrode connected to said scanning line, and a capacitance connected to said line; and providing a drive signal to said capacitance, wherein
said drive circuit has configuring active elements of a same conductivity type and has said active elements simultaneously formed on a same substrate as said transistor; and includes,
an output level switching circuit for generating a first switching signal and a second switching signal for switching a voltage level of said drive signal based on a predetermined signal, and outputting the signals;
an output level holding circuit for holding the voltage levels of said first switching signal and said second switching signal for a predetermined period based on a repeating signal; and
an output circuit for generating said drive signal based on said first switching signal and said second switching signal, and outputting said drive signal to said line.
